(19) United States
(12) Patent Application Publication
(10) Pub. No.: US 2026/0219957 A1
(43) Pub. Date: Jul. 30, 2026

(54) GENERAL AGENT ORCHESTRATION ACROSS HETEROGENEOUS COMPUTING ENVIRONMENTS

(71) Applicant: Perplexity AI, Inc., San Francisco, CA (US)

(72) Inventors: Balabhadra Alex GRAVELEY, Austin, TX (US); Alec Yi XIANG, San Francisco, CA (US); Dmitry PERVUKHIN, Mountain View, CA (US); William ZHANG, San Francisco, CA (US); Jack Tianao MA, West Lafayette, IN (US); Emily Louise Janet REDMOND, San Francisco, CA (US); Artem SHUVAEV, Belgrade (RS); Sergei CHUSOVSKOI, Lisboa (PT); Ali SHOBEIRI, San Francisco, CA (US); Roshan Calvin SHANKAR, San Francisco, CA (US); Marshall KIELY, Fresno, CA (US); Dzianis YARATS, Minneapolis, MN (US); Johnny HO, San Francisco, CA (US); Jerry Ziao MA, West Lafayette, IN (US)

(21) Appl. No.: 19/577,844

(22) Filed: Mar. 25, 2026

Related U.S. Application Data
(60) Provisional application No. 63/990,722, filed on Feb. 25, 2026.

(51) Int. Cl. G06F 9/50

(52) U.S. Cl. CPC G06F 9/5066; G06F 9/5072; G06F 9/5083; G06F 2209/5016

(57) ABSTRACT

Various embodiments of the present disclosure provide a multi-session agent workspace that improves the functionality of a computer in various aspects. The multi-session agent workspace comprises a shared workspace repository and a plurality of agent sessions configured in accordance with a hierarchical session structure. The plurality of agent sessions comprises a parent session storing parent context data for executing an agent task within the parent session, and a child session storing child context data separate from the parent session and for executing an agent subtask within the child session. At least a portion of the parent context data of the parent session is propagated to the child session upon creation of the child session. The agent task may be executed within the parent session, and the agent subtask may be executed within the child session.

### CROSS REFERENCE TO RELATED APPLICATIONS

This application claims priority to U.S. Provisional Application No. 63/990,722, entitled “Systems and Methods for General Agent Orchestration Across Heterogeneous Computing Environments”, filed Feb. 25, 2026, the entirety of which is incorporated by reference herein for all purposes.

### BACKGROUND

Various embodiments of the present disclosure address technical challenges related to orchestrating autonomous artificial intelligence agents across heterogeneous computing environments. In some implementations, artificial intelligence assistant systems may operate within a single-turn or short-context conversational paradigm in which a user submits a query, the system generates a response, and the interaction concludes. While effective for certain question-answering tasks, complex multi-step tasks may involve extended reasoning, multiple tool invocations, coordination across diverse execution environments, and persistence of execution state across sessions and interruptions.

Technical challenges may include context-window constraints that limit the information available during reasoning operations, model diversity and configuration constraints that affect coverage and output quality, fault-handling behavior that may interrupt in-progress tasks after system failures, and environment interaction limitations that reduce agent observability and controllability across heterogeneous computing surfaces. Additional challenges may include maintaining traceable source provenance when synthesizing outputs from multiple reasoning processes.

Additional technical limitations may arise in processing and management of agent-tool interactions, inference resource constraints, distributed execution environment reliability, cross-session context persistence, and multi-agent task scheduling. Traditional approaches may suffer from insufficient intermediate semantic safety evaluation of tool-returned content, uncoordinated recovery behavior for shared execution environments, uniform context and payload handling across heterogeneous modalities, and inconsistent citation continuity across sessions. Additional limitations may include queue contention between interactive and background workloads, homogeneous retry behavior, lifecycle-agnostic tool governance, and state incoherence during context compression, cancellation, and resource exhaustion conditions.

### BRIEF DESCRIPTION OF THE DRAWINGS

FIG. 1 is a block diagram of an example architecture in accordance with some embodiments of the present disclosure.

FIG. 2 is a block diagram of an example computing entity in accordance with some embodiments of the present disclosure.

FIG. 3 is a block diagram of an example client computing entity in accordance with some embodiments of the present disclosure.

FIG. 4 is a system diagram of an agent orchestration ecosystem in accordance with some embodiments of the present disclosure.

FIG. 5 is a dataflow diagram of a multi-session agent workspace in accordance with some embodiments of the present disclosure.

FIG. 6 is a dataflow diagram of an adaptive context management framework in accordance with some embodiments of the present disclosure.

FIG. 7 is a dataflow diagram of a multi-agent orchestration framework in accordance with some embodiments of the present disclosure.

FIG. 8 is a dataflow diagram of a data conflict resolution routine in accordance with some embodiments of the present disclosure.

FIG. 9 is a dataflow diagram of a cross-agent provenance tracking framework in accordance with some embodiments of the present disclosure.

FIG. 10 is a dataflow diagram of a fault recovery framework in accordance with some embodiments of the present disclosure.

FIG. 11 is an operational example of an agent interface in accordance with some embodiments of the present disclosure.

FIG. 12 is a flowchart diagram of an example multi-session orchestration process in accordance with some embodiments of the present disclosure.

FIG. 13 is a flowchart diagram of an example parallel multi-session orchestration process in accordance with some embodiments of the present disclosure.

FIG. 14 is a flowchart diagram of an example fault recovery process in accordance with some embodiments of the present disclosure.

FIG. 15 is a flowchart diagram of an example interaction process in accordance with some embodiments of the present disclosure.

FIG. 16 is a flowchart diagram of an example tool output security classification process in accordance with some embodiments of the present disclosure.

FIG. 17 is a block diagram of a multi-layer inference resource management framework in accordance with some embodiments of the present disclosure.

FIG. 18 is a flowchart diagram of an example pre-inference payload management process in accordance with some embodiments of the present disclosure.

FIG. 19 is a flowchart diagram of an example token checkpoint management process in accordance with some embodiments of the present disclosure.

FIG. 20 is a flowchart diagram of an example execution environment recovery process in accordance with some embodiments of the present disclosure.

### DETAILED DESCRIPTION

Various embodiments of the present disclosure provide systems and methods for orchestrating autonomous artificial intelligence agents across heterogeneous computing environments. Some embodiments of the present disclosure provide a multi-session agent workspace that enables long-horizon agent tasks to be decomposed into subtasks delegated to child agents while maintaining coordination and resource sharing through a shared workspace repository. In addition, or alternatively, some embodiments of the present disclosure may provide a fault recovery framework that detects processing failures through various mechanisms and automatically resumes failed tasks from a persisted state. In addition, or alternatively, some embodiments of the present disclosure may provide multi-agent orchestration frameworks that execute multiple agents in parallel, each operating independently with its own context and potentially using different underlying models, followed by synthesis of collective outputs into a unified result through evidence-based conflict resolution. In addition, or alternatively, some embodiments of the present disclosure may provide an agent interface that renders visual indicators of agent operations in an overlay layer separate from execution environment content, with selective event handling to prevent interference with underlying environment operations. Each of these embodiments, among the other embodiments of the present disclosure, improve computer technology by enabling fault-tolerant execution of long-horizon tasks that survive system failures without loss of progress, by producing synthesized outputs that leverage diverse model capabilities while maintaining defensible conclusions grounded in assessed evidence quality, by enabling verification of synthesized outputs through cross-agent provenance tracking that traces response segments to original sources, among other technical improvements described herein.

More particularly, the multi-session agent workspace of the present disclosure provides an inventive distribution of functionality that improves system performance in terms of fault tolerance, reliability, speed, and flexibility. For example, the multi-session agent workspace may comprise a hierarchical session structure that organizes agent sessions in a tree-structured session management system where each session has a limited number of parent and child sessions. In some examples, at least a subset of agent sessions within a hierarchical session structure may share access to a common workspace rooted at the tree's root session according to one or more workspace access policies. This distribution of functionality across hierarchically organized sessions enables a parent agent to create files that child agents may read, child agents to produce outputs that parent agents may access, and sibling agents to coordinate through shared workspace artifacts. The hierarchical session structure further operates as a distributed network architecture that functions in an unconventional manner to improve fault tolerance, speed, and processing efficiency with respect to machine learning inference operations. Rather than maintaining agent states within a single monolithic session, the distributed architecture propagates context information from parent sessions to child sessions upon creation, enabling specialized agents to execute subtasks with appropriate context and credentials while maintaining coordination through the shared workspace repository. In this manner, the multi-session agent workspace may reduce the computational burden on any single agent session, enable parallel execution of subtasks across multiple worker processes to enhance speed and accuracy or inference operations, and provide fault isolation such that failure of one session does not prevent successful completion of other sessions.

By way of example, each of the plurality of agent sessions may comprise one of a plurality of different isolated execution environments to isolate a fault within a first isolated execution environment of the plurality of different isolated execution environments without impacting a second isolated execution environment of the plurality of different isolated execution environments. By doing so, the multi-session agent workspace of the present disclosure may improve the fault tolerance of the workspace relative to traditional agentic systems. In some examples, a parent session may instantiate the child session based on a fault propensity associated with the agent subtask to improve the fault tolerance of the multi-session agent workspace. For example, using the techniques of the present disclosure, a multi-session agent workspace may proactively monitor an agent task for potential faults and isolate the potential fault within an agent subtask executed within a separate isolated execution environment. A fault propensity, for example, may be based on a domain data source (e.g., accessibility) associated with a portion of an agent task, a computational complexity associated with a portion of an agent task, and/or other attributes associated with the portion of an agent task. By predicting the fault propensity of individual portions of an agent task and isolating them as agent subtasks within an isolated environment, the multi-session agent workspace of the present disclosure may improve the speed, reliability, and overall processing efficiency of a computer with respect to long-horizon and other complex agentic tasks.

In addition, or alternatively, a parent session within a multi-session agent workspace of the present disclosure, may instantiate a child session to distribute a computational load of an agent task between the parent session and one or more child sessions. The parent session and/or the one or more child sessions, for example, may be associated with processing capacities that restrict the computer resources (e.g., processing time, memory space) available within a particular session. In order to avoid processing timeouts and other errors due to processor and memory limitations within an agent session, the multi-session agent workspace may dynamically spawn child sessions to distribute the computational load of an agent task across multiple isolated execution environments. For example, a parent session May instantiate a child session based on an optimized processing schedule configured to distribute the computational load of the agent task based on the respective processing capacities of the parent and child sessions. In this manner, a multi-session agent workspace may reduce processing timeouts, memory overloads, and other computer errors that traditionally cause faults during the processing of long-horizon and other complex agentic tasks. Moreover, in some examples, the parent and child sessions may execute in parallel to increase a resolution speed of the agent task.

In addition, or alternatively, the multi-agent orchestration framework of the present disclosure provides a specific method of restricting agent operations that improves the speed, reliability, and accuracy of collective outputs aggregated from a multi-worker ecosystem. For example, the multi-agent orchestration framework may provide an evidence-based conflict resolution methodology that assesses evidence quality to resolve disagreements among multiple agent sessions. By doing so, the multi-agent orchestration framework may produce synthesized outputs (e.g., collective responses) that are defensible based on underlying sources. The quality scores of the present disclosure, for example, may incorporate a weighted combination of component scores, including source authority metrics, recency metrics, methodological metrics, and source diversity metrics specifically designed to assess the accuracy of a response segment based on the sources underlying the segment. Using the quality scores, the multi-agent orchestration framework may selectively filter response segments from different agents within a multi-agent ecosystem to remove hallucinated or otherwise inaccurate content from a collective response. For example, the multi-agent orchestration framework may filter a prompt response from a collective response based on a reliability of a source list underlying the prompt response to improve the accuracy of the collective response. This specific method of restricting agent operations through evidence-based filtering improves the accuracy of synthesized outputs by ensuring that response segments supported by higher-quality sources prevail over response segments supported by lower-quality evidence, while explicitly acknowledging uncertainty when sources are balanced rather than forcing artificial resolution.

In some examples, the multi-agent orchestration framework may prevent tool execution conflicts within a multi-agent ecosystem with a shared tool repository. The multi-agent orchestration framework, for example, may define safety classifications, such as a concurrency-unsafe class and a concurrency-safe class, for tools within the shared tool repository. Tools associated with a concurrency-unsafe classes may be locked (e.g., using a locking flag) based on tool usage across agent sessions. For example, to eliminate and/or reduce tool execution conflicts, the multi-agent orchestration framework may reject a tool invocation for a locked tool. In this manner, the multi-agent orchestration framework may improve computer functionality by preventing concurrent tool executions that are susceptible to execution conflicts within a multi-agent ecosystem, ensuring safe coordination of tool access across multiple agent sessions sharing a common tool repository.

In addition, or alternatively, the fault recovery framework of the present disclosure provides an improved data structure, an execution queue, and a method that uses the improved data structure to improve fault recovery speeds and consistency within distributed agent ecosystems relative to traditional fault recovery approaches. The execution queue may comprise a unified task queue in which a plurality of agent tasks may be stored in association with a temporal task status indicating when an agent task is ready for processing. The temporal task status may be updated at time intervals in accordance with score semantics that enable multiple task states within a single data structure, including ready tasks with scores equal to or less than current time that are available for immediate processing, sleeping tasks with scores equal to a future wake time that become ready when the scheduled time arrives, and running tasks with scores set to current time plus a timeout threshold that appear ready if the worker fails to refresh. To maintain accurate temporal task status, workers executing agent tasks may periodically send heartbeat signals indicating continued operation with each heartbeat signal automatically extending the temporal task status for an agent task into the future. If a worker fails, heartbeats cease, and after the timeout period elapses without a heartbeat, the temporal task status becomes current, making the associated agent task appear ready for processing by another worker. In this manner, the fault recovery framework of the present disclosure may leverage an execution queue with dynamically updated temporal task statuses to automatically detect and gracefully handle faults as they occur; thereby, preventing system failures and improving processing speeds and efficiencies.

In some examples, the fault recovery framework may implement a pending operation recovery framework that registers pending operations by storing a task state within a registration record before initiation of long-running work. In this way, the fault recovery framework may persist recovery data sufficient to resume or retrieve results of pending operations. In some examples, the persisted data may be stored in association with the execution framework, such that a task state may be automatically forwarded to a new worker upon fault detection. By doing so, the fault recovery framework may provide a data structure (e.g., the execution queue) and method that enables tasks to recover from failures with minimal loss of progress by loading a persisted session state, identifying pending operations that were in progress at failure time, invoking recovery handlers to obtain results, and injecting recovered results into appropriate conversation positions.

In addition, or alternatively, the agent interface of the present disclosure may provide an improved user interface that modifies conventional overlay rendering protocols to dynamically produce a dual-source hybrid display combining transparent control regions with opaque control regions. The overlay architecture, for example, may comprise a transparent rendering layer positioned above execution environment content but separate from it, where the overlay may display visual elements without modifying the underlying environment. The overlay layer may implement selective event routing where pointer events in transparent overlay regions pass through to the underlying execution environment, enabling agents to continue interacting with the environment, while events on the opaque control region may be intercepted by the overlay rather than passing through. This differs from conventional overlay protocols that would either block all events from reaching the underlying environment or pass all events through without selective interception. This rendering independence ensures that overlay updates do not trigger environment reflows or repaints, and the system degrades gracefully when native overlay capabilities are unavailable by providing feedback through alternative channels including console logging, separate windows, or status bar updates.

### I. OVERVIEW OF EMBODIMENTS

As should be appreciated, various embodiments of the present disclosure may be implemented as methods (e.g., computer-implemented methods), apparatus, systems, computing devices, computing entities, computer program products, non-transitory computer-readable media, and/or the like. By way of example, the various embodiments of the present disclosure may be implemented as a computer-implemented method comprising various operations. As another example, the various embodiments of the present disclosure may be implemented as a system comprising one or more processors and one or more memories storing processor-executable instructions that, when executed by the one or more processors, cause the one or more processors to perform one or more of the various operations of the computer-implemented method. As yet another example, the various embodiments of the present disclosure may be implemented as one or more non-transitory computer-readable media storing processor-executable instructions that, when executed by one or more processors, cause the one or more processors to perform one or more of the various operations of the computer-implemented method. As such, embodiments of the present disclosure may take the form of a method, system, non-transitory computer-readable media, apparatus, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

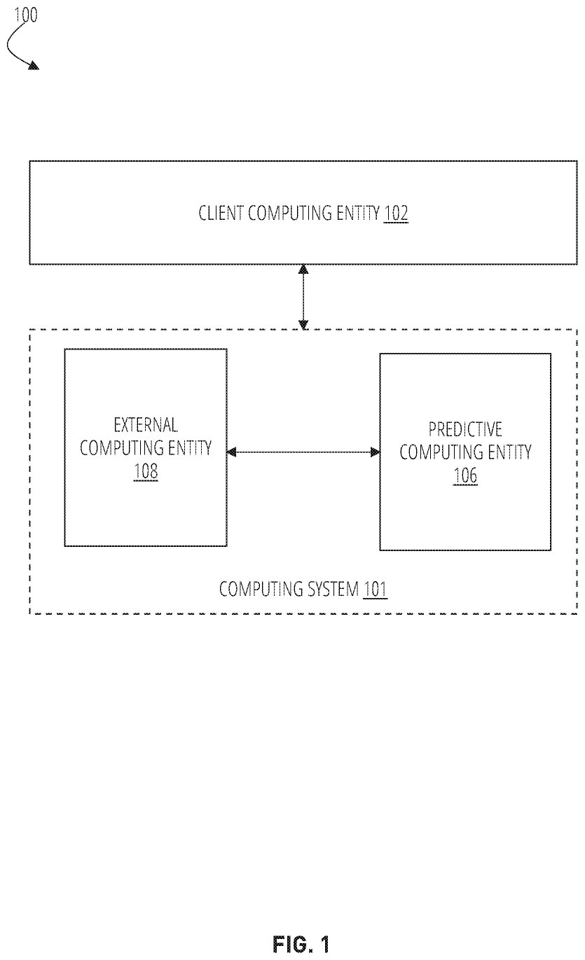

FIG. 1 is a block diagram of an example architecture 100 in accordance with some embodiments of the present disclosure. The architecture 100 comprises a computing system 101 configured to receive a request, such as a prompting request, and/or the like, from client computing entities 102, process the request, and provide the responses, such as a prompting response, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis, agent orchestration, inference, and/or training operations of the present disclosure. In addition, the storage subsystems may be configured to store model definition data used by the respective computing entities to perform various predictive data processing, agent orchestration, inference, and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different from the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., fault handling, agent orchestration, user interface rendering) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as data repository, tool repositories, model repositories, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

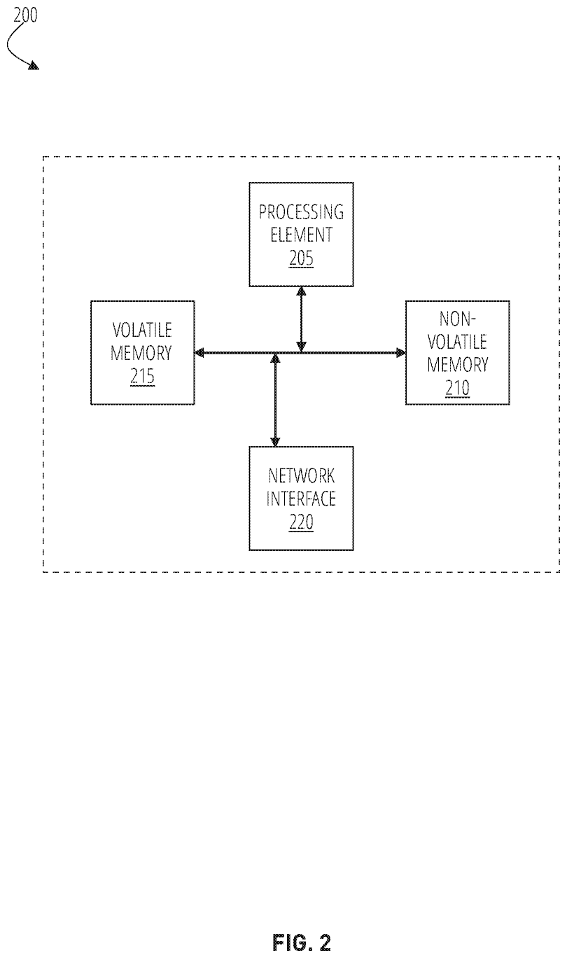

FIG. 2 is a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile memory 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi®), Wi-Fi Direct®, IEEE 802.16 (WiMAX), ultra-wideband (UWB), infrared (IR) protocols, near field communication (NFC) protocols, Wibree, Bluetooth® protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

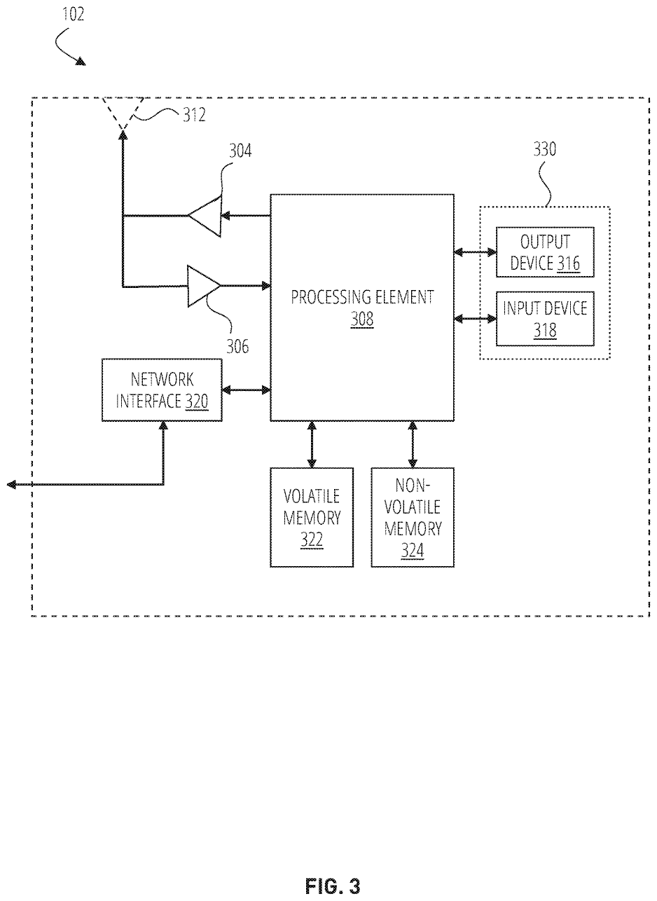

FIG. 3 is a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi® access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi® access points, cellular towers, nearby computing devices (e.g., smartphones, laptops), and/or the like. For instance, such technologies may comprise the iBeacons®, Gimbal proximity beacons, Bluetooth® Low Energy (BLE) transmitters, NFC transmitters, and/or the like. These indoor positioning aspects may be used in a variety of settings to determine the location of someone or something to within inches or centimeters.

The client computing entity 102 may also comprise a user interface 330 that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface 330 may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface 330 (GUI) (e.g., at least a portion of a user application, browser), command-line interface, touch and/or haptic user interface 330, gesture and/or image capture-based interface, voice/audio user interface 330, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. EXAMPLE SYSTEM OPERATIONS

As indicated, various embodiments of the present disclosure make important technical contributions to agent orchestration and distributed computing systems. In particular, systems and methods are disclosed herein that implement hierarchical session management, fault-tolerant task coordination, multi-agent synthesis with evidence-based conflict resolution, and adaptive context management techniques to improve agent execution, state persistence, and output reliability in heterogeneous computing environments. By doing so, the agent orchestration techniques of the present disclosure enable improved task decomposition, fault recovery, and multi-perspective reasoning processes that, when executed on a computer, improve computational resource allocation and system reliability. This, in turn, may improve the functionality of a computer with respect to various computing tasks, including distributed task processing, machine learning inference operations, context window management, cross-agent provenance tracking, and the like.

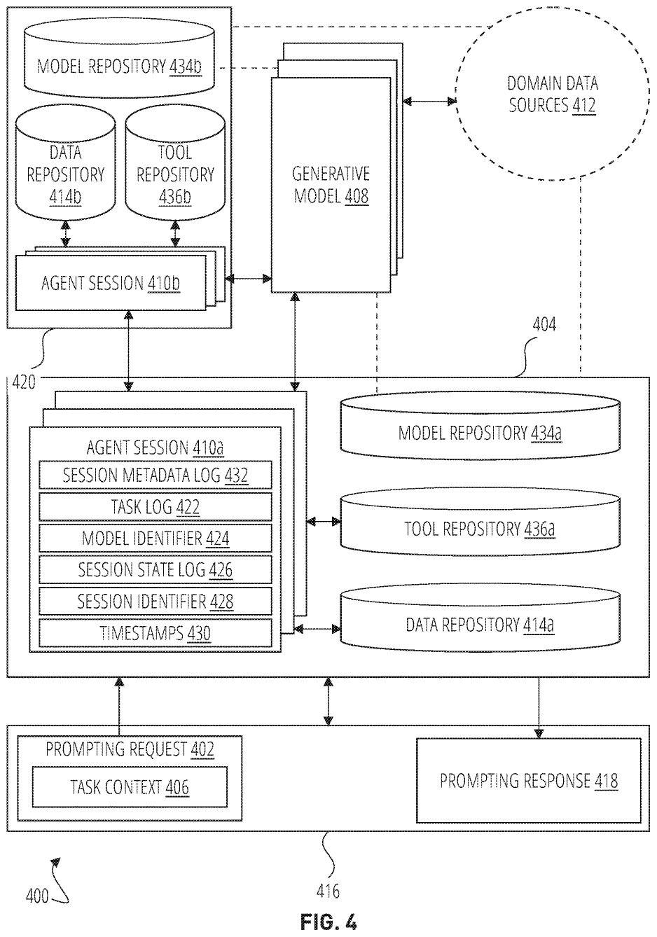

FIG. 4 is a system diagram of an agent orchestration ecosystem 400 in accordance with some embodiments of the present disclosure. The agent orchestration ecosystem 400 provides an improved computing ecosystem for addressing technical challenges, such as context window, model reasoning, fault tolerance, and source attribution constraints, among others, presented in the orchestration of machine learning agents. To do so, the agent orchestration ecosystem 400 may comprise a host platform 404 and/or one or more external platforms 420 that may individually and/or collectively execute one or more agent sessions 410a-b to process a prompting request 402. Up to each of the agent sessions 410a-b may comprise individualized components and/or constraints, including a session metadata log 432, a task log 422, a model identifier 424, a session state log 426, a session identifier 428, one or more timestamps 430, and/or the like, for completing at least a portion of a prompting request 402. Upon receiving a prompting request 402, the agent orchestration ecosystem 400 (e.g., host platform 404 and/or external platforms 420) may execute, in accordance with one or more embodiments of the present disclosure, one or more agent sessions 410a-b, each within their own isolated environments, to systematically generate a prompting response 418 through multiple, specialized agent instantiations and in a manner that improves the speed, accuracy, reliability, and fault tolerance of the end-to-end generative process.

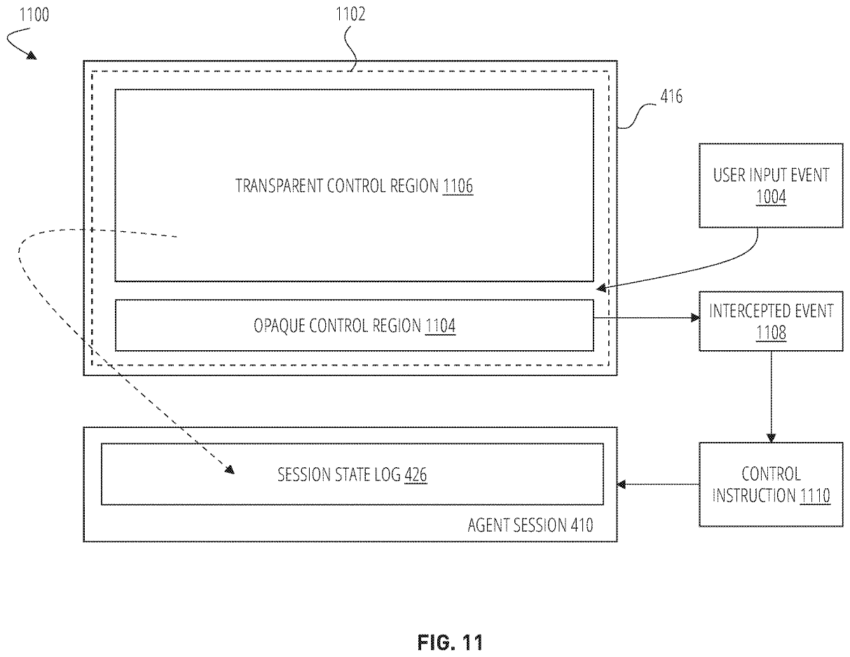

The agent orchestration ecosystem 400 may comprise a host platform 404 and/or one or more external platforms 420 (e.g., in a bring your own agent environment). The host platform 404 may comprise an agent interface 416, an example of which is provided with reference to FIG. 11. The host platform 404 may receive a prompting request 402 with task context 406 through the agent interface 416 and, based on the prompting request 402, the host platform 404 may instantiate one or more agent sessions 410a-b within the host platform 404 and/or within one or more external platforms 420. Up to each of the instantiated agent sessions 410a-b may execute at least a subtask for resolving the prompting request 402. Upon resolution of the prompting request 402, the host platform 404 may provide a prompting response 418 to the prompting request 402 through the agent interface 416.

The host platform 404 may comprise a primary computing platform comprising one or more processors, memory, and/or storage resources that operates an agent interface 416 and executes agent sessions 410a within a defined set of computing resources. The host platform 404, for example, may implement an orchestration layer containing session management, task coordination, and context management components that create and manage agent sessions 410a, coordinate task execution across available worker processes, and/or handle context as tasks progress. The host platform 404 may interface with execution environments, such as web browsers, sandboxed code execution containers, desktop applications, external service APIs, and/or the like, to enable machine learning agents to perform actions within isolated computing contexts.

In some examples, the host platform 404 may maintain a shared infrastructure comprising a tool repository 436a that catalogs available agent tools, a data repository 414a (e.g., persistence layer) for storing session state and recovery data, a distributed coordination layer implementing distributed queues, locks, and/or the like, and/or a model repository 434a for storing local machine learning models, such as one or more of the generative models 408. In some examples, the host platform 404 may interact with one or more external platform 420 that execute agent sessions within a separate set of computing resources, with the host platform 404 coordinating task delegation and result aggregation across platform boundaries.

The external platform 420 may comprise a secondary computing platform comprising one or more processors, memory, and storage resources that interact with a host platform 404 and executes agent sessions 410b within its own set of computing resources. The external platform 420 operates independently from the host platform 404 while maintaining communication channels for task delegation, session coordination, and result aggregation across platform boundaries. The external platform 420 may implement its own orchestration components, execution environments, and/or shared infrastructure to manage agent sessions 410b locally, while interfacing with the host platform 404 through defined APIs, messaging protocols, and/or other inter-platform communication mechanisms. In operation, the host platform 404 may delegate tasks or subtasks to the external platform 420, which may execute the delegated work within its isolated execution environment and return results to the host platform 404 for integration into the broader task workflow. The external platform 420 architecture enables distributed agent execution n across heterogeneous computing environments, allowing organizations to leverage specialized computing resources, proprietary models, and/or domain-specific tools while maintaining coordination with a central host platform 404. By way of example, an external platform 420 may comprise a data repository 414b independent from the data repository 414a, a model repository 434b independent from the model repository 434a, a tool repository 436b independent from the tool repository 436a, and/or the like.

The agent interface 416 may comprise a specialized user interface for interacting with an agent session 410a, providing input and output mechanisms through which users and/or external systems may submit tasks and/or receive results from agent execution. The agent interface 416 may be implemented as a user interface component for direct human interaction, a service interface for system-to-system communication, a programmatic interface, such as an API for automated task submission and result retrieval, and/or the like. In some examples, the agent interface 416 may connect to an orchestration layer that creates agent sessions 410a-b, coordinates task execution across available workers, manages context as tasks progress, handles any failures that occur, and/or the like. In some examples, the agent interface 416 may render an overlay layer to an execution environment representation for an agent, as described with reference to FIG. 11.

In some examples, one or more of the platforms (e.g., the host platform 404 and/or external platforms 420) of the agent orchestration ecosystem 400 may comprise a model repository 434a-b, a tool repository 436a-b, and/or a data repository 414a-b for facilitating the execution of agent sessions 410a-b.

The model repository 434a, for example, may comprise a platform-specific model registry that maintains references to a set of affiliated generative models (e.g., one or more of the generative models 408) available for agent execution. The model repository 434a may store model identifiers that uniquely identify an available generative model, along with associated configuration parameters, model weights or pointers to model weight storage locations, tokenizer specifications, and/or inference settings. In some examples, the model repository 434a may interface with agent sessions 410a and/or orchestration components of the host platform 404 to enable model selection and/or instantiation, where an agent configuration may specify a model identifier that the system resolves against the model repository 434a to obtain the corresponding model resources.

In some examples, the model repository 434a may maintain metadata for up to each of a set of registered models, including model architecture specifications, context window sizes, supported capabilities, resource requirements, access credentials for cloud-hosted inference endpoints, and/or the like. In multi-agent orchestration frameworks, the model repository 434a may enable parallel session prompts to be executed using different generative models 408 by providing the orchestration layer with access to multiple model configurations, allowing agent sessions 410a to be instantiated with diverse model selections based on task requirements, specialization needs, or load balancing considerations.

A generative model 408, generally, may comprise a machine learning model, such as an LLM, trained to understand and generate content. For instance, the generative model 408 may comprise a transformer architecture and/or may be trained on large content (e.g., text, images, structured data) corpora. The transformer architecture, for example, may comprise one or more layers of self-attention mechanisms and/or feed-forward neural networks that process input sequences in parallel, enabling the generative model 408 to capture long-range dependencies and contextual relationships within text and other content. The generative model 408 may store learned parameters, such as weight matrices and bias vectors, within computer memory or persistent storage, with model sizes ranging from millions to hundreds of billions of parameters depending on the architecture and training configuration.

The generative model 408 may comprise a domain-agnostic generative model (e.g., LLM) trained on large, multi-domain content. In addition, or alternatively, the generative model 408 may comprise a domain-specific model (e.g., a finetuned LLM) that is trained (and/or finetuned) on a domain-specific content (e.g., a clinical model that is finetuned on a clinical dataset to capture clinical language nuances, a coding model that is finetuned on code databases to capture coding language nuances). The generative model 408 may be trained via various training approaches, including active training approaches, preference fine tuning, and/or the like. By way of example, the generative model 408 may be trained using supervised fine-tuning (SFT) where the model is trained on labeled input-output pairs to learn specific task behaviors or response patterns, reinforcement learning from human feedback (RLHF) where the model is trained using reward signals derived from human preference judgments to align outputs with human values and expectations, direct preference optimization (DPO) where the model learns from pairwise preference data without requiring a separate reward model, and/or the like. In addition, or alternatively, the generative model 408 may be trained using instruction tuning where the model is trained on datasets of instructions paired with appropriate responses to improve instruction-following capabilities, constitutional AI (CAI) where the model is trained to self-critique and revise outputs according to a set of principles or guidelines, pre-training where the model learns general language representations from large unlabeled text corpora through next-token prediction or masked language modeling objectives, continued pre-training where a pre-trained model undergoes additional training on domain-specific corpora to enhance knowledge in particular subject areas, multi-task learning where the model is trained simultaneously on multiple tasks to develop generalized capabilities across diverse objectives, curriculum learning where training examples are presented in a structured order from simpler to more complex to facilitate learning progression, contrastive learning where the model learns to distinguish between similar and dissimilar examples to develop robust representations, knowledge distillation wherein a smaller student model is trained to replicate the behavior of a larger teacher model, low-rank adaptation (LoRA) where only a small number of additional parameters are trained while keeping the base model weights frozen, prompt tuning where learnable prompt embeddings are optimized while the model parameters remain fixed, adapter tuning where small trainable modules are inserted between model layers while the original parameters remain frozen, quantization-aware training where the model is trained with simulated quantization effects to maintain performance after deployment with reduced precision, and/or the like.

In some examples, the host platform 404 and/or external platform 420 may train the generative model 408. In addition, or alternatively, the generative model 408 may be trained, at least in part, by another computing platform.

In some examples, the generative model 408 may be at least partially stored within a model repository 434a of the host platform 404 and/or a model repository 434b of an external platform 420. In addition, or alternatively, the generative model 408 may be stored within one or more other computing platforms (not depicted) that may provide access to the generative model 408 as a service.

During inference, the generative model 408 may receive an input sequence of tokens and generate output tokens autoregressively, predicting each subsequent token based on the probability distribution computed over the vocabulary conditioned on the preceding tokens. The inference process may involve matrix multiplications across the model's weight matrices, attention score computations across the input sequence, softmax normalization to produce probability distributions over the vocabulary, and/or other operations depending on the model's architecture. In some examples, the generative model 408 may employ one or more different decoding strategies, such as greedy decoding, beam search, top-k sampling, top-p (nucleus) sampling, temperature-scaled sampling, and/or the like, to select output tokens from the computed probability distributions.

In some examples, a generative model 408 may interface with an agent session 410a-b to process agent prompts containing task context to generate generative responses. The generative model 408 may be deployed across one or more different computing configurations, such as single-GPU execution, multi-GPU parallelism using tensor parallelism or pipeline parallelism, distributed execution across multiple compute nodes, cloud-based inference endpoints accessed through API calls, and/or the like.

In multi-agent orchestration frameworks such as those described herein, multiple generative model instances may execute in parallel, each associated with a corresponding agent session 410a-b and potentially configured with different prompting strategies, system instructions, or tool configurations to enable diverse approaches to information gathering and synthesis. An agent session 410a-b, for example, may invoke tools through structured function calling mechanisms to supplement the operations of the generative model 408. Tool invocations within an agent session 410a-b, for example, may enable the generative model 408 to extend its capabilities beyond text generation to include web search, code execution, file operations, database queries, interactions with external services and APIs, and/or the like.

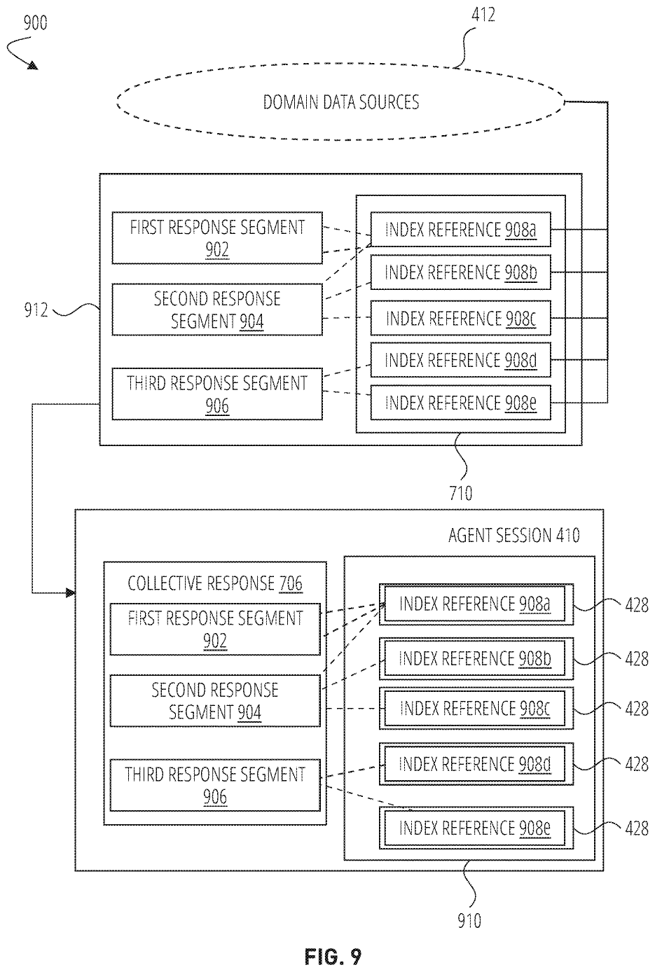

The domain data sources 412, for example, may comprise an information source that may be accessed to support the generation of outputs by a generative model 408, such as a website, data repository, file system, and/or other storage or retrieval mechanisms. The domain data sources 412, for example, may interface with agent sessions 410a-b and/or generative models 408 through retrieval tools that enable information gathering operations, such as web browsing, database querying, file reading, and API calls to external services. In some examples, the domain data sources 412 may provide content that agent sessions 410a-b (and/or generative model instances thereof) may incorporate into their context during task execution, with retrieved information contributing to prompting responses 418. The domain data sources 412 may be associated with source metadata, such as URLs, titles, publication dates, excerpts, and/or the like. As described herein with reference to FIG. 9, the source metadata may be indexed within source lists for attribution and provenance tracking purposes. In multi-agent orchestration frameworks, multiple agent sessions 410a-b may access shared domain data sources 412 concurrently, with up to each agent session 410a-b gathering information relevant to its assigned task or subtask and maintaining references to accessed sources for subsequent evidence quality assessment and conflict resolution during response synthesis.

The tool repository 436a-b may comprise a set of tools that may be accessed by one or more agent sessions 410a-b to perform an agent task and/or an agent subtask thereof. For example, the set of tools may comprise a retrieval tool, a messaging tool, a session instantiation tool, and/or the like.

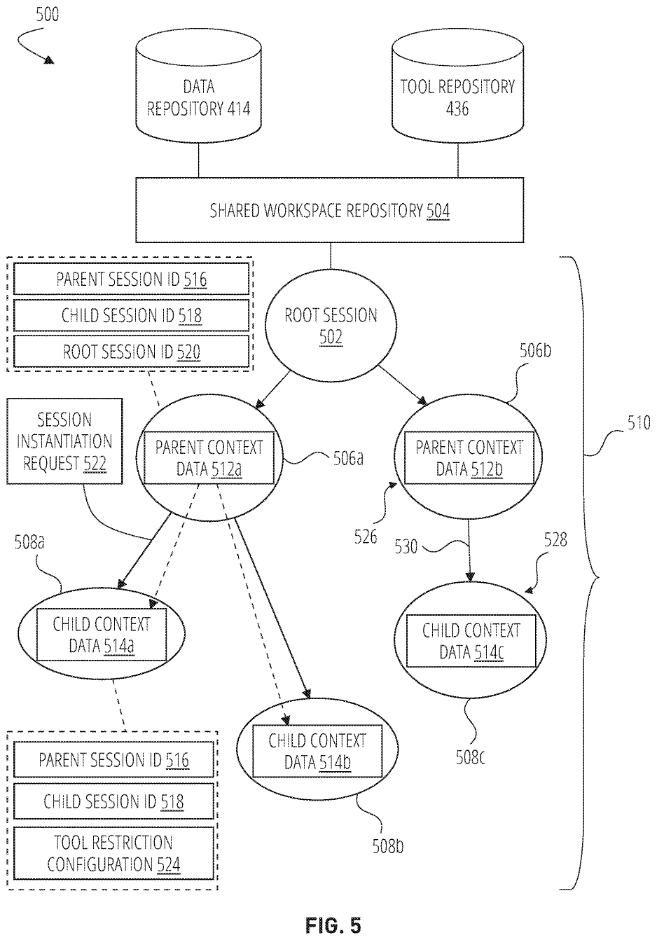

The tool repository 436a-b may comprise a storage system that maintains a set of tools available within a computing platform (e.g., host platform 404 or external platform 420) for invocation by agents during task execution. The tool repository 436a, for example, may catalog each of a set of different tools as a defined capability that an agent may invoke to perform specific actions, such as searching the web, executing code, reading files, interacting with external services, and/or the like. In some examples, the tool repository 436a may store tool definitions comprising tool identifiers, input parameter specifications, output formats, execution endpoints or handlers that implement the tool functionality, and/or the like. In some examples, the tool repository 436a may expose one or more of a set of tools to an agent session 410a based on session permissions, with tool restriction configurations defining which subsets of tools may be accessible to particular agent sessions 410a, as described herein with reference to FIG. 5. In this manner, the tool repository 436a may enable the host platform 404 to enforce access controls by excluding restricted tools from agent sessions 410a depending on the context.

In some examples, a tool may comprise a defined software capability that an agent may invoke to perform specific actions within an agent session 410a-b, such as searching the web, executing code, reading files, interacting with external services, and/or the like. A tool, for example, may comprise an interface specification defining input parameters and output formats, an execution handler that implements the tool functionality by interfacing with underlying system resources, APIs, or external services, and/or the like.

Generally, a tool may comprise a software construct, such as an API call that sends HTTP requests to external services and receive structured responses, system calls that interface with operating system kernels to perform file operations, process management, or network communication, remote procedure calls (RPCs) that execute functions on remote servers across network boundaries, database queries that execute SQL or NoSQL statements against database management systems to retrieve, insert, update, or delete data, shell commands that invoke command-line utilities or scripts within operating system environments, function pointers or callbacks that reference executable code segments for deferred or event-driven invocation, message queue operations that publish or consume messages through message broker systems, webhook handlers that receive and process HTTP callbacks from external systems, socket operations that establish connections and transmit data across network protocols, inter-process communication (IPC) mechanisms, such as pipes, shared memory segments, semaphores, and/or the like that enable data exchange between processes, plugin or extension interfaces that dynamically load and execute modular code components, event emitters and listeners that trigger and handle asynchronous events within event-driven architectures, library function calls that invoke compiled routines from linked software libraries, and/or the like.

In some examples, a retrieval tool may comprise one of a plurality of different types of tools that may be configured to retrieve or submit information within a restricted environment. The retrieval tool, for example, may comprise an interface specification defining input parameters, such as search queries, URLs, file paths, query statements, and/or the like, and an execution handler that interfaces with underlying retrieval mechanisms to make requests to specified endpoints. For example, the retrieval tool may be configured to retrieve or submit information within restricted environments, with access controls governing which domain data sources 412 the tool may access based on session permissions and/or security policies. During agent execution, the generative model 408 may invoke the retrieval tool by generating structured requests specifying retrieval parameters, and the tool execution handler may return retrieved content along with source metadata, such as URLs, titles, publication dates, and/or excerpts for attribution and provenance tracking. By way of example, the retrieval tool may populate source lists associated with agent responses, enabling evidence quality assessment and cross-agent source attribution in multi-agent orchestration frameworks.

In some examples, a messaging tool may comprise one of a plurality of different types of tools that may be configured to transfer a message between a first and second agent session 410a-b. The messaging tool, for example, may comprise a tool that enables information sharing between two sessions through APIs, messaging protocols, or other inter-process communication mechanisms. The messaging tool may comprise an interface specification defining input parameters, such as target session identifiers, message content, message metadata, and/or the like, and an execution handler that routes messages to specified recipient sessions through the underlying communication infrastructure. In some examples, the messaging tool may be implemented using message queue systems that publish messages to queues or topics for asynchronous consumption, direct API calls that transmit messages synchronously between session endpoints, event-driven architectures that emit and handle message events across session boundaries, shared memory structures that enable concurrent read and write access between sessions, and/or the like. As one example, the messaging tool may enable coordination between parent and child sessions within a hierarchical session structure, as described herein with reference to FIG. 5, allowing parent agents to send instructions or context to child agents and child agents to return results or status updates to parent agents.

In some examples, the session instantiation tool may comprise one of a plurality of different types of tools that may be configured to instantiate a hierarchical session for agent session 410a-b. The session instantiation tool may comprise a service for spawning agent sessions enabling task delegation from parent sessions to a newly created child session. The session instantiation tool may comprise an interface specification defining input parameters, such as subtask-specific context, execution mode selection, tool restriction configurations, metadata propagation instructions, and/or the like, and an execution handler that generates session containers populated with agent-specific information to establish child sessions, as described with reference to FIG. 5. The session instantiation tool, for example, may process session instantiation requests that define the scope of metadata propagation from parent to child sessions, including which portions of session state logs, session metadata logs, and task logs are inherited by the child session.

The data repository 414a-b may comprise a persistence layer of a computing platform (e.g., the host platform 404 or external platform 420) that provides persistent storage for the session state, recovery data, and/or artifacts generated during agent execution. The data repository 414a may be implemented using various storage mechanisms including local file storage, networked file systems, object storage services, distributed file systems, or databases, with the persistence layer employing strategies appropriate to the deployment environment to ensure durability and availability of stored data.

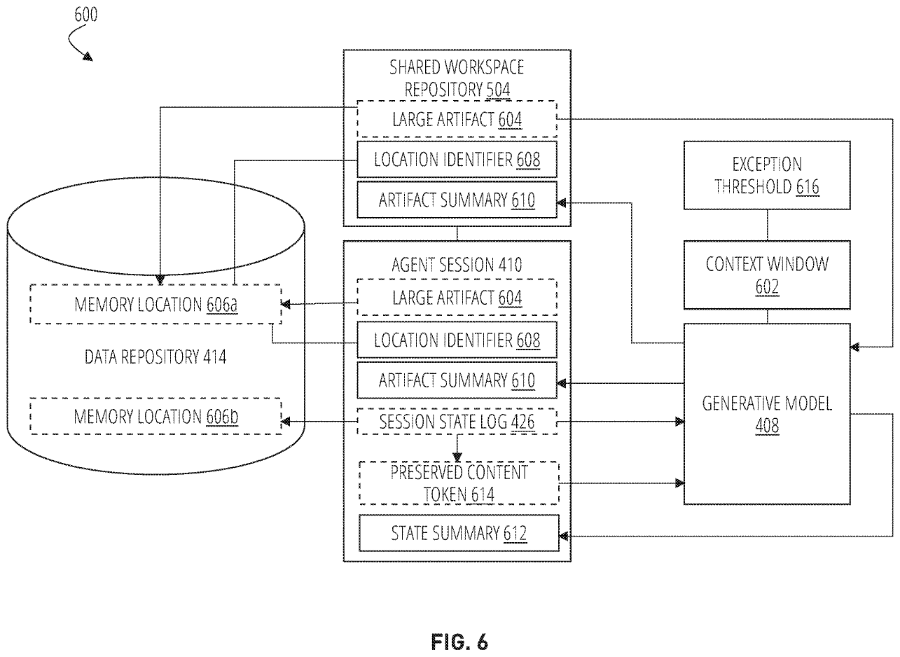

The data repository 414a, for example, may store session state logs containing conversation history and/or system instructions, session metadata logs containing user identity, credentials, and/or preferences, task logs containing pending operation records for crash recovery, and/or the like. In some examples, as described further herein with reference to FIG. 6, the data repository 414a may maintain memory locations that store session data (e.g., large artifacts, session state logs) offloaded from agent sessions 410a during context compression to reduce the context size of an agent session 410a. In addition, or alternatively, the data repository 414a may interface with a shared workspace repository to persist files and/or data created during agent execution, enabling workspace contents to survive system failures and/or be accessed by resumed tasks continuing from consistent checkpoints, among other functionalities described herein.

In some examples, an agent session 410a may comprise a processing instance that maintains session data, such as a session metadata log 432, task log 422, model identifier 424, session state log 426, session identifier, and/or one or more timestamps 430, throughout a lifecycle of an agent task or agent subtask. An agent session 410a may comprise an isolated agent execution environment instantiated for a particular agent task or subtask, with each agent session 410a associated with an execution environment that defines the computing context in which agents perform actions, including web browsers, sandboxed code execution containers, desktop applications, mobile applications, external service APIs, and/or the like. In some examples, the agent session 410a may comprise a workspace that may comprise a directory structure within a file system, with the workspace path derived from the session identifier 428, or implemented using object storage services, distributed file systems, or other storage mechanisms. The agent session 410a may interface with a generative model 408 identified by a model identifier 424, a tool repository 436a defining available tools subject to tool restriction configurations, and/or the like to execute the agent task or subtask.

In some examples, a session identifier 428 may comprise a unique identifier that distinguishes a particular agent session 410a from all other sessions within a multi-session agent workspace. The session identifier 428 may be implemented as a universally unique identifier (UUID), a hash-based identifier, a sequential numeric identifier, a composite string that encodes hierarchical relationships, and/or the like. In a hierarchical session structure for example, a child session identifier may be constructed to incorporate a parent session identifier as a prefix, enabling determination of session ancestry from the identifier alone and facilitating parent chain traversal to locate root sessions for workspace access, as described with reference to FIG. 5.

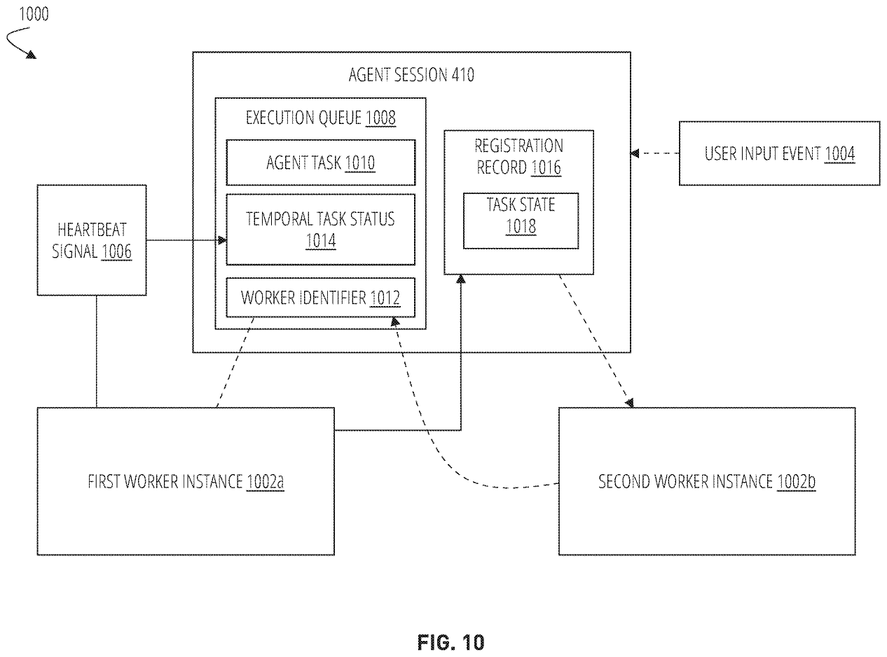

The agent session 410a, for example, may comprise a session state log 426 comprising message history and/or system instructions for the agent task or subtask. The session state log 426, for example, may comprise a data structure that stores a conversation state, including message history and system instructions for an agent session 410a. The session state log 426 may maintain a sequential record of messages exchanged during agent execution, including user inputs, agent responses, tool invocations, tool outputs, system-generated messages indicating execution status or recovery events, and/or the like. In some examples, the session state log 426 stores system instructions that configure agent behavior, define task objectives, establish operational constraints for the generative model during inference operations, and/or the like. In some examples, the session state log 426 may be persisted within a data repository 414a to enable crash recovery, where resumed tasks may load the persisted session state log 426 to continue execution from consistent checkpoints rather than restarting, as described with reference to FIG. 10.

In addition, or alternatively, the agent session 410a may comprise a session metadata log 432 comprising user identity attributes, authorization metadata, preferences, and/or the like for the agent task or subtask. The session metadata log 432, for example, may comprise a data structure that stores session metadata, such as user identity attributes, authorization metadata, and/or preferences for the agent session 410a. In some examples, the session metadata log 432 may maintain authorization context metadata used by the agent session 410a to access external services on behalf of a user, where the metadata may be represented as policy-scoped access artifacts and resolved through an authorization management service according to deployment policy. In addition, or alternatively, the computing system 101 may log session-metadata handling events using non-sensitive audit fields (e.g., event type, timestamp, and scope identifier), with detailed authentication artifacts omitted or redacted based on deployment policy. In addition, or alternatively, the session metadata log 432 may store user preferences that configure agent behavior, output formatting, interaction styles, or domain-specific settings that persist across the session lifecycle. In some examples, the session metadata log 432 may be persisted within a data repository 414a as part of a session record, enabling recovery of user context and authentication state when tasks are resumed after system failures. As described with reference to FIG. 5, the session metadata log 432 may form part of the parent context data that may be propagated from parent sessions to child sessions upon child session creation. In some examples, such propagation may include selective projection of metadata fields such that child sessions receive least-privilege, time-bounded, subtask-scoped authorization artifacts aligned with propagation policy. In some implementations, the propagated artifacts may include delegated authorization handles, encrypted credential references, or equivalent scoped access mediators. In this way, the session metadata log 432 may enable agents to maintain consistent user context across multi-session structures while maintaining revocable, scope-limited authorization boundaries defined by the propagation scope.

In addition, or alternatively, the agent session 410a may comprise a task log 422 comprising one or more pending operation records for crash recovery. The task log 422, for example, may comprise a data structure that stores pending operation records for crash recovery within an agent session 410a. For example, the task log 422 may maintain records of operations that are in progress at any given time, enabling the host platform 404 or external platform 420 to identify and recover incomplete operations when a worker process fails due to software errors, hardware failures, resource exhaustion, scheduled maintenance, and/or the like. In some examples, the task log 422 records operation identifiers, operation types, operation parameters, initiation timestamps, operation status indicators that track whether operations are pending, completed, or failed, and/or the like. The task log 422 may be persisted within a data repository 414a as part of the session record, with updates written durably before operations commence to ensure recoverability.

In addition, or alternatively, the agent session 410a may comprise one or more timestamps 430 for creation and last modification, and/or the like. For example, the timestamps 430 may comprise a creation timestamp or an activity timestamp.

The creation timestamp may comprise a data value recording the date and time when a session or record was initially created, stored as a numeric value representing elapsed time since a reference epoch (e.g., Unix timestamp) or as a structured datetime value, and generated at session instantiation by querying system clocks or time synchronization services to provide an immutable record of session origin. The activity timestamp may comprise a data value recording the date and time of the most recent modification or activity within a session or record, updated each time an event occurs within an agent session 410a, such as message additions to the session state log 426, tool invocations, state changes, user interactions, and/or the like, providing a current indicator of session liveness.

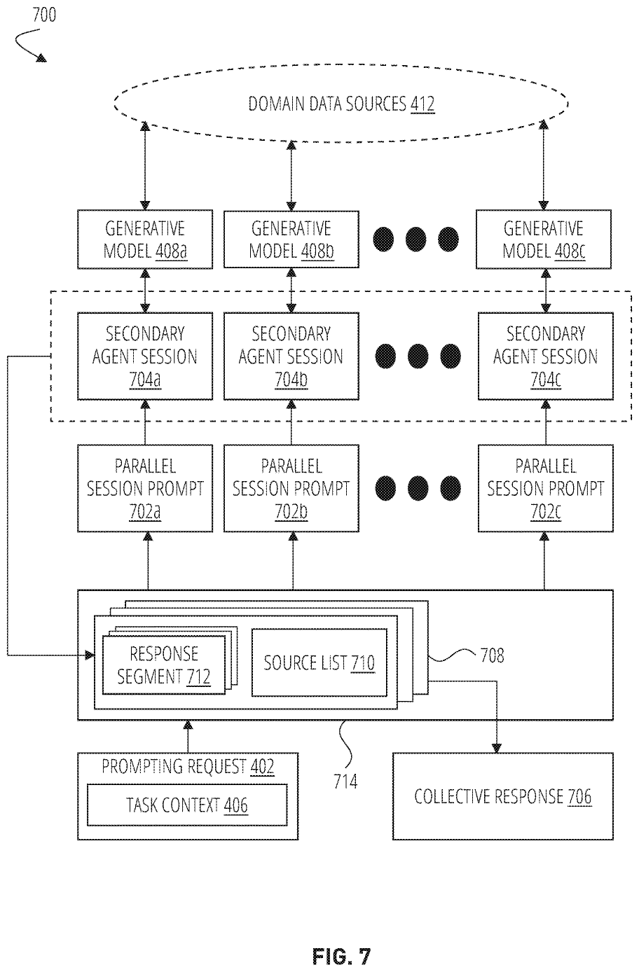

In some examples, the host platform 404 may receive one or more prompting requests 402 through an agent interface 416. A prompting request 402 may comprise a request for performing a task by a generative model 408. The prompting request 402, for example, may comprise input data that specifies the task to be executed and/or any associated context required for task completion. In some examples, the prompting request 402 may comprise task context 406 defining the scope and/or objectives of the requested operation, system instructions that configure model behavior, conversation history providing prior interaction context, references to tools or resources available for task execution, and/or the like. In some examples, the prompting request 402 may be received by an orchestration layer of the host platform 404 that may route the prompting request 402 to one or more agent sessions 410a-b for processing, with each agent session instantiating a generative model inference operation based on the request content. In multi-agent orchestration frameworks, a single prompting request 402 may be transformed into a set of parallel and/or hierarchical session prompts, as described with reference to FIGS. 5 and 7. In any framework, the prompting request 402 may initiate a processing pipeline that progresses through retrieval states where agents invoke tools to gather information, and synthesis states where agents generate textual outputs, ultimately producing a prompting response 418 that addresses the prompting request 402.

In this manner, the agent orchestration ecosystem 400 may provide the infrastructure for enabling various different multi-agent prompting across multiple, disparate agents, platforms, and/or models to provide prompting responses 418 to prompting requests 402 in a flexible manner that may adapt to any circumstance. The present disclosure provides multiple embodiments of multi-agent prompting frameworks. As one embodiment, the agent orchestration ecosystem 400 may provide access to a multi-session agent workspace which is depicted by FIG. 5.

FIG. 5 is a dataflow diagram of a multi-session agent workspace 500 in accordance with some embodiments of the present disclosure. A computing system, such as the computing system 101, may implement the multi-session agent workspace 500 to provide an improved agent orchestration approach, in terms of accuracy, speed, processing efficiency, and fault tolerance. To do so, the multi-session agent workspace 500 may comprise a data repository 414 and a tool repository 436 connected to a shared workspace repository 504, with a root session 502 at the apex of a hierarchical session structure 510 that branches through parent context data 512a, 512b to child context data 514a, 514b, 514c at different session nodes. In this regard, the hierarchical session structure 510 enables a plurality of individual sessions to share access to the shared workspace repository 504 while operating within their own isolated environments. In this way, the hierarchical session structure 510 may enable complex tasks to be decomposed into subtasks delegated to child agents in a hierarchical manner while maintaining coordination and resource sharing. By doing so, the multi-session agent workspace 500 may improve computer functionality through an improved distribution of functionality across multiple, hierarchical agent sessions, which enables agent coordination through shared workspace artifacts, while effectively preserving hierarchical relationships and enforcing access controls across the distributed computing environment.

In some embodiments, the multi-session agent workspace 500 comprises a shared workspace repository 504 and a plurality of agent sessions configured in accordance with a hierarchical session structure 510. The multi-session agent workspace 500, for example, may comprise a tree-structured session management system where agent sessions may be organized hierarchically within computer memory and persistent storage. The multi-session agent workspace 500 may comprise a shared workspace repository 504 and a plurality of agent sessions configured in accordance with a hierarchical session structure. In some examples, the hierarchical session structure may define a unidirectional acyclic graph that establishes session nodes and directed edges representing parent-child relationships between sessions. In some examples, each session within the multi-session agent workspace 500 may comprise at most one parent session 506a-b and may have zero or more child sessions 508a-c, with a root session 502 serving as the originating session at the apex of the hierarchy. By way of example, the multi-session agent workspace 500 may comprise a root session 502, a first parent session 506a with two child sessions 508a-b, and second parent session 506b with a single child session 508c.

When any agent session within the multi-session agent workspace 500 requires workspace access, the agent session may traverse the parent chain to locate the root session 502 and access the shared workspace repository 504 through the root session 502. In this manner, the multi-session agent workspace 500 may ensure that parent sessions 506a-b may create files that child sessions 508a-c may read, child sessions 508a-c may produce outputs that parent sessions 506a-b may access, and sibling agents may coordinate through artifacts within a shared workspace repository 504. In some examples, the multi-session agent workspace 500 and/or each of the agent sessions may interface with a data repository 414a for persistent storage, a tool repository 436a defining available agent capabilities, and/or a model repository (not depicted) for generative model access.

In some embodiments, the root session 502 comprises the originating session within a multi-session agent workspace 500 that serves as the apex of a hierarchical session structure 510 with no parent session. The root session 502 may be identified by a null or absent parent session identifier within its session record, distinguishing it from child sessions that maintain references to parent sessions. The root session 502 may correspond (e.g., own, control, include) to a shared workspace repository 504 that provides a common storage area for files and data accessible to at least a subset of sessions within the hierarchical session structure 510 according to a workspace access policy. In some examples, the root session 502 may serve as the coordination point for a prompting request completion across the hierarchical session structure 510, aggregating results from child sessions and managing the overall lifecycle of a prompting response.

In some examples, the shared workspace repository 504 may comprise a common workspace rooted at the root session 502 that provides a storage area for files and data accessible to at least a subset of agent sessions within a hierarchical session structure 510 according to session relationship and access policy. The shared workspace repository 504 may be implemented as a directory structure within a file system, with the workspace path derived from the root session identifier 520. In addition, or alternatively, the shared workspace repository 504 may be implemented using object storage services, distributed file systems, and/or any other storage mechanism, as described herein.

The hierarchical session structure 510 may comprise a tree structure that defines the organizational constraints governing relationships between agent sessions, including parent limits, depth limits, and/or the like. For example, the hierarchical session structure 510 may require a unidirectional acyclic graph that defines a set of session nodes and a set of directed edges, where each session node may correspond to an agent session and each directed edge may establish a parent-child relationship between two sessions by connecting a parent session node to a child session node. In some examples, the hierarchical session structure 510 may enforce a parent or child limit that constrains a number of parent or child nodes spawned from one or more session nodes to ensure a tree structure that remains acyclic and well-formed.

In some examples, the hierarchical session structure may designate a root session as an originating session with no parent, from which all other sessions descend through parent-child relationships. The hierarchical session structure 510 may impose depth limits that constrain the maximum number of hierarchical levels permitted, preventing excessively deep delegation chains that could impair coordination or performance. In addition, or alternatively, the hierarchical session structure 510 may govern context propagation from parent sessions to child sessions, tool restriction configurations that limit tool availability at different hierarchy levels, workspace access patterns, and/or the like.

In some examples, a session node within a hierarchical session structure 510 may comprise a session record that stores information for a particular session within a hierarchical session structure 510. The session node, for example, may be implemented as a data structure within computer memory or persistent storage that maintains session-specific information, including a session identifier uniquely identifying the session, an optional parent session identifier referencing the parent session node (null for root sessions), a session state log containing conversation history and system instructions, a session metadata log containing user identity attributes, authorization metadata, and preferences (with sensitive credential values stored as encrypted values and/or opaque references), references to child session nodes representing spawned child sessions, a task log containing pending operation records for crash recovery, and timestamps for creation and last modification. In addition, or alternatively, the session node may be implemented as a record within a relational database, a document within a document store, an object within an object-oriented data structure, a node within a graph database, and/or the like.

In some examples, a directed edge may comprise a pointer, reference, or other representation of a hierarchical relationship between two session records that establishes directionality from a parent session node to a child session node. The directed edge may be implemented as a foreign key reference within a relational database that stores the parent session identifier within the child session record, an embedded reference or object pointer within an object-oriented data structure, an explicit edge record within a graph database containing source and target node identifiers, a parent identifier field within a document store that references the parent document, and/or the like.

In some embodiments, the set of session nodes may comprise one or more root nodes, respectively corresponding to one or more root sessions 502, one or more parent nodes respectively corresponding to one or more parent sessions 506a-b, and/or one or more child nodes respectively corresponding to one or more child sessions 508a-c. In some examples, a first session node (e.g., an example parent node 526) may be connected to the second session node (e.g., an example child node 528) by a directed edge 530 of the set of directed edges to establish a parent-child relationship between a parent session 506b and a child session 508c. In some examples, each of the session nodes may store context data, as described herein, and/or session data, such as the session data described with reference to FIG. 4.

By way of example, a parent session node for the parent session 506a may comprise a parent session identifier 516 corresponding to the parent session 506a, a child session identifier 518 corresponding to the child session 508a, and/or a root session identifier 520 corresponding to the root session 502 of the multi-session agent workspace 500. In addition, or alternatively, the parent session node may comprise session data, such as the task log, session state log, session metadata log, creation timestamp, activity timestamp, and/or the like, as described herein with reference to FIG. 4.

As another example, a child session node for the child session 508a may comprise one or more of a first session identifier (e.g., parent session identifier 516) corresponding to the parent session 506a, a second session identifier (e.g., child session identifier 518) corresponding to the child session 508a, and/or one or more third session identifiers (e.g., descendant session identifiers—not depicted) respectively corresponding to one or more descendant sessions (not depicted) associated with the child session 508a. In addition, or alternatively, the child session node may comprise session data, such as the task log, session state log, session metadata log, creation timestamp, activity timestamp, and/or the like, as described herein with reference to FIG. 4. In some examples, the child session node and/or the child session 508a may store a tool restriction configuration 524, which is described further herein.

In some examples, at least a segment of the child session identifier 518 may comprise the parent session identifier 516 to represent a parent-child relationship between the parent session 506a and the child session 508a.

In some examples, the hierarchical session structure 510 defines one or more constraints for the organization of the multi-session agent workspace 500. For example, the one or more constraints may comprise a parent limit for a session node (and/or an agent session more generally) that constrains a number of parent sessions and/or parent session nodes connected to a session node to one.

By way of example, the parent limit may restrict each session to having at most a particular number (e.g., 1, 3, 5) of parent sessions, while permitting the same or different number of child sessions. In some examples, the parent limit may be set to one to preserve the tree structure integrity of the multi-session agent workspace 500 by ensuring the hierarchical session structure 510 remains a unidirectional acyclic graph. The parent limit may be enforced through database constraints (e.g., unique foreign key relationships), validation checks during session instantiation, data structure definitions, and/or the like.

In some examples, up to each of the parent sessions 506a-b may store parent context data 512a-b for executing an agent task within the parent session 506a-b. An agent task, for example, may be executed within the parent session 506a based on at least the portion of the parent context data 512a and the shared workspace repository 504.

In some examples, a parent session 506a may comprise a session within a hierarchical session structure 510 that creates and maintains a parent-child relationship with one or more child sessions 508a-b, sharing information and resources with those child sessions 508a-b. Conversely, a child session 508a may comprise a session created by a parent session 506a that maintains access to information inherited from that parent session 506a. Both “parent session” and “child session” are relative terms identified through directed edges within the hierarchical session structure 510; the same agent session may comprise both a parent session and a child session relative to different sessions within the hierarchy. In some examples, up to each parent session 506a-b may comprise parent context data 512a-b that may be propagated to child sessions 508a-c, and up to each child session 508a-c may comprise child context data 514a-c propagated from parent sessions 506a-b within the hierarchical session structure 510.

In some examples, a parent session 506a may be assigned an agent task for completing a prompting request. An agent task may comprise a long-horizon task comprising a sequence of operations that may require substantial time to complete, ranging from minutes to hours or longer. The agent task may be decomposed into agent subtasks that may be delegated to child sessions within the hierarchical session structure 510, with the generative model processing prompting requests, invoking tools, and generating responses that advance task completion. An agent subtask may be executed within a child session 508a-c based on at least the portion of the child context data 514a-c and the shared workspace repository 504. In addition, or alternatively, the child session 508a-c may have access to parent context data 512a, such that the agent subtask may be executed within the child session 508a-c based on at least one of the child context data 514a-c, the parent context data 512a, and/or the shared workspace repository 504.

In some examples, an agent subtask may comprise a subcomponent of a long-horizon task that is delegated from a parent session 506a to a child session 508a through a session instantiation request 522 that specifies subtask-specific context, including the scope of the delegated work, metadata propagation instructions, execution mode selection, and tool restriction configurations for the child session 508a, enabling the child session 508a to perform a focused portion of the overall task. The agent subtask may involve information retrieval through tool invocations, content generation through generative model inference, file operations within the shared workspace, or interactions with external services, with results produced by the child session 508a made accessible to the parent session 506a through the shared workspace repository 504 or returned directly upon subtask completion.

In some examples, at least a portion of the parent context data 512a of a parent session 506a may be propagated to a child session 508a upon creation of the child session 508a. For example, a parent session 506a may instantiate the child session 508a by providing a session instantiation request 522. For instance, the computing system 101 may receive a session instantiation request 522 within the parent session 506a that defines a subtask-specific context for the child session 508a. The computing system 101 may generate a session container based on the session instantiation request 522 and propagate, based on the subtask-specific context, at least a portion of a session metadata log associated with the parent session 506a to the session container to generate the child session 508a, where the propagated portion may exclude plaintext credential material and include encrypted credential references and/or delegated authorization artifacts scoped to the child subtask.

In some examples, the session instantiation request 522 may comprise a data structure comprising parameters that define the configuration for a new child session, including subtask-specific context that specifies the scope of the delegated work and the scope of metadata propagation from the parent session 506a to the child session 508a. The session instantiation request 522 may be processed by a hierarchical session instantiation tool, and may specify which portions of the parent's session state log, session metadata log, and task log are inherited by the child session, enabling fine-grained control over context inheritance across the hierarchical session structure 510. In some examples, the subtask-specific context may additionally define one or more authorization constraints for delegated artifacts, including allowed resource domains, permitted operation classes, maximum validity durations, and revocation behavior upon child-session completion.

In some examples, the session container may comprise an isolated execution environment populated with agent-specific information to establish an agent session, providing resource isolation through containerization technologies (e.g., process isolation through namespaces and resource constraints through control groups), virtual machine instances, sandboxed runtime environments, process-based isolation, and/or the like. By way of example, each of the plurality of agent sessions within the hierarchical session structure 510 may comprise one of a plurality of different isolated execution environments to isolate a fault within a first isolated execution environment of the plurality of different isolated execution environments without impacting a second isolated execution environment of the plurality of different isolated execution environments. By doing so, the multi-session agent workspace 500 improves the fault tolerance of the workspace relative to traditional computer systems.

In some examples, the fault tolerance of the multi-session agent workspace 500 may be improved by instantiating a child session 508a based on a fault propensity associated with an agent subtask. For example, an agent subtask may be associated with a fault propensity score, which may be based on a domain data source 412 associated with the agent subtask, computational complexity (e.g., expected time duration, processing requirements) of the agent subtask, and/or the like. In some examples, the fault propensity score may be generated by the generative model associated with a parent session 506a. In addition, or alternatively, the fault propensity score may be generated by a tool (e.g., a machine learned classifier) within the shared tool repository. By predicting the fault propensity of individual portions of an agent task and isolating them as agent subtasks within an isolated environment, the multi-session agent workspace 500 may improve the speed, reliability, and overall processing efficiency of a computer with respect to long-horizon and other complex agentic tasks.

In addition, or alternatively, a parent session 506a within the multi-session agent workspace 500 may instantiate a child session 508b to distribute a computational load of an agent task between the parent session 506a and the child session 508b. The parent session 506a and/or the child session 508b, for example, may be associated with processing capacities that restrict the computer resources (e.g., processing time, memory space) available within a particular session. In order to avoid processing timeouts and other errors due to processor and memory limitations within an agent session, the multi-session agent workspace 500 may dynamically spawn child sessions to distribute the computational load of an agent task across multiple isolated execution environments. For example, the parent session 506a may instantiate a child session 508b based on an optimized processing schedule (e.g., for scheduled task execution as described herein) configured to distribute the computational load of the agent task based on the respective processing capacities of the parent session 506a and child session 508b. In this manner, the multi-session agent workspace 500 may reduce processing timeouts, memory overloads, and other computer errors that traditionally cause faults during the processing of long-horizon and other complex agentic tasks. Moreover, in some examples, the parent session 506a and/or child session 508b may execute in parallel to increase the resolution speed of the agent task, as described herein.

In some examples, the session instantiation request 522 may define at least one execution mode for the child session 508a from a synchronous delegation execution mode configured to interrupt the parent session 506a until a response is received from the child session 508a, or an asynchronous background mode configured to independently execute the child session 508a with respect to the parent session 506a. In some examples, during an asynchronous background mode, the parent session 506a and the child session 508a may execute in parallel to increase a resolution speed of the agent task.

In some examples, the execution mode may comprise a configuration parameter governing synchronization behavior between parent and child sessions during subtask delegation. In the synchronous delegation execution mode, the parent agent waits for the child to complete before continuing, receives the child's result, and may incorporate it into the parent's ongoing work, making this mode suitable when the parent requires the child's output to proceed. In the asynchronous background mode, the parent agent receives an identifier for the child and continues with other work while the child agent executes independently, with the child's result delivered through a notification mechanism upon completion, making this mode suitable for long-running subtasks that should not block the parent. The execution mode may be implemented through threading or process management constructs, with synchronous modes simplifying result handling at the cost of potential idle time and asynchronous modes enabling parallel execution at the cost of additional coordination overhead.

In some examples, the session instantiation request 522 may comprise a tool restriction configuration 524 that defines a subset of a set of tools within the multi-session agent workspace 500 that is accessible by the child session 508a. The tool restriction configuration may comprise a data structure that manages tool availability for a particular session, specifying which tools are unavailable to child agents such that the child's tool registry excludes restricted tools based on this configuration. The tool restriction configuration may be implemented as a whitelist, a blacklist, a permission matrix, a capability token system, and/or the like, enabling parent sessions 506a-b to limit child session capabilities based on subtask requirements and/or security considerations. Attempts by a child session 508a-c to invoke restricted tools may result in errors indicating the tool is unavailable. Examples of tools that may be restricted include hierarchical session instantiation tools (to prevent unbounded recursion), tools for scheduling future task execution, tools for user communication that should be consolidated at the parent level, and tools with elevated security implications. In this manner, the tool restriction configuration may enable fine-grained permission management across hierarchical session structures, ensuring that certain high-privilege or coordination-sensitive operations remain exclusive to the root or primary agent while delegating appropriate capabilities to child sessions 508a-c for subtask execution.

In some embodiments, the tool restriction configuration comprises a domain-based permission for agent actions. For example, agent sessions operating in execution environments may require governance over which resources they may access. Without appropriate permission systems, agents may access sensitive resources, violate organizational policies, or perform undesired actions. Some embodiments of the present disclosure may provide a multi-tier permission governance system that controls agent access to domains, resources, and/or services based on configurable rules.

In some examples, the configurable rules may be evaluated across multiple tiers. At a first, organizational policy tier, organization-wide policies that apply to all users and agents within an organization may be defined. These policies may be configured by organizational administrators and/or enforced across all organizational deployments. At a second, administrator configuration tier, deployment-specific configurations that may further restrict (but not relax) organizational policies may be defined. These configurations may be set by deployment administrators. At a third, user preference tier, user-specific preferences that may further restrict (but not relax) administrator configurations may be defined. These preferences may allow individual users to impose additional constraints on agent behavior. In some examples, permission evaluation may proceed from most restrictive to least restrictive.

In some examples, the permission rules may be expressed in terms of domains (e.g., for web resources) or resource identifiers (e.g., for other resource types). Rule types, for example, may comprise one or more allow rules (e.g., explicitly permit access to specified domains/resources), block rules (e.g., explicitly deny access to specified domains/resources), default policy rules (e.g., the default behavior when no explicit rule matches), and/or the like. In some examples, a rule may be matched to a domain based on exact matching (e.g., domain must exactly equal the specified value), suffix matching (e.g., domain must end with the specified value, such as “.example.com” matches “www.example.com” and “api.example.com”), prefix matching (e.g., domain must begin with the specified value), and/or wildcard matching (e.g., pattern with wildcards matching multiple domains).

In addition, or alternatively, the permission rules may correspond to one or more time-based permissions (e.g., different rules for business hours versus after-hours), context-based permissions (e.g., research tasks may access more sources than transactional tasks), capability tokens (e.g., fine-grained capabilities may be represented as tokens granted for specific operations, enabling precise permission management, and/or permission requests (e.g., agents may request elevated permissions for specific operations, with user or administrator approval required).

In some examples, before an agent action that accesses a domain or resource is executed within an agent session, the target domain/resource may be identified from the action specification, organizational policies may be evaluated and, if blocked, the action is denied, then administrator configurations may be evaluated and, if blocked, the action is denied, then user preferences may be evaluated and, if blocked, the action is denied. If permitted at all tiers, the action may proceed.

In some examples, when an action is denied, the agent session may receive an informative error indicating the denial reason (without exposing sensitive policy details) and the denial may be logged for audit purposes. For example, permission decisions may be logged for audit and/or compliance purposes, by storing a timestamp and/or action specification, evaluation results at each tier, a final decision (permitted or denied), a denial reason if applicable, and/or actor identifiers (user, agent, session).

FIG. 6 is a dataflow diagram of an adaptive context management framework 600 in accordance with some embodiments of the present disclosure. A computing system, such as the computing system 101, may implement the adaptive context management framework 600 to provide improved context management for generative models. To do so, the adaptive context management framework 600 may monitor context utilization within an agent session 410 and/or shared workspace repository 504 against an exception threshold 616 tailored to a context window 602 of a generative model 408. In the event of a context exception, the context management framework 600 may apply a two-stage compression approach. At a first stage, the context management framework 600 may offload large artifacts 604 to persistent storage, such as the data repository 414, while replacing inline content with a location identifier 608 and artifact summary 610. At a second stage, the context management framework 600 may replace a session state log 426 with a state summary 612 of reduced size by applying semantic summarization to the session state log 426 while preserving preserved content tokens 614. By doing so, the adaptive context management framework 600 may improve computer functionality by optimizing memory utilization and preserving essential context information for continued agent execution.

In some implementations, session context may include long transcripts and dependency-critical instructions, tool outputs, and identifiers that are relevant across extended task execution. To manage token-limit conditions while preserving execution continuity, the adaptive context management framework 600 applies staged compression with model-specific threshold monitoring, artifact externalization with location identifiers 608 and artifact summaries 610, and selective state summarization with preserved content tokens 614, thereby reducing overflow-triggered failure conditions while maintaining execution continuity.

More particularly, in accordance with the adaptive context management framework 600, the computing system 101 detects a context exception for a generative model 408 associated with an agent session based on (i) a token count of at least the portion of the agent context data (e.g., a session state log 426, large artifacts 604, and/or any other information stored within the agent session 410) and/or the shared workspace repository 504 and (ii) an exception threshold 616 associated with a context window 602 of the generative model 408.

The context exception, for example, may comprise an exception triggered when current context utilization meets or exceeds the exception threshold 616 during agent session 410 execution. The computing system 101 may detect the context exception by monitoring context utilization through determining and/or estimating the token count of the current context of the agent session, which may comprise conversation history, system instructions, tool outputs, reference materials, and/or the like. The computing system 101 may detect the context exception by comparing the token count against the exception threshold 616 associated with the context window 602 of the generative model 408. In addition, or alternatively, the context exception may be detected based on feedback from the generative model 408 (e.g., an error message), a processing timeout (e.g., a processing time exceeding a processing time threshold), and/or the like.

Once detected, the context exception may trigger a response handler that initiates context management operations, such as the two-stage compression routine of the present disclosure, to reduce the token count of the agent session. To do so, the two-stage compression routine may generate a compressed representation of the context data to reduce token count while preserving critical information. The context exception may be implemented using standard exception handling mechanisms within programming languages, event-driven architectures that emit context threshold events, polling-based monitors that periodically evaluate context size and invoke compression routines when thresholds are exceeded, and/or the like. In this manner, the context exception may enable proactive context management that prevents inference failures due to context overflow while maintaining sufficient information for continued agent task execution.

In some examples, the token count comprises a numeric value representing the number of tokens within a text sequence, used to measure the context utilization of an agent session. The token count may be computed by processing input text through a tokenization algorithm that segments the text into discrete subword units according to a learned vocabulary, with each resulting unit counted as one token. In some examples, token estimation may employ exact tokenization using the generative model's tokenizer, which may apply a model-specific tokenization algorithm (e.g., byte-pair encoding, WordPiece, SentencePiece) used during model training to produce precise token counts. In addition, or alternatively, token estimation may employ character-based estimation that approximates token count based on character count (e.g., approximately one token per four characters for English text), providing faster computation at the cost of reduced accuracy. In some examples, token estimation may employ hybrid approaches that balance accuracy and computational cost, such as using exact tokenization for critical threshold decisions (e.g., based on a priority level assigned to an agent task or subtask) while using character-based estimation for routine monitoring (e.g., task agnostic monitoring performed at a defined time interval).

The token count may be computed for individual components of an agent session, such as session state logs 426, tool outputs, large artifacts 604, and/or the like, to generate component level token counts that allow for the identification of candidates for compression and/or offloading to persistent storage in accordance with the two-stage compression routine. In this manner, the token count, and/or the component-level token counts thereof, may enable the agent session 410 to manage context utilization proactively, ensuring that the combined size of conversation history, system instructions, tool outputs, reference materials, and/or the like, remains within the operational limits of an associated generative model 408 during inference operations.

In some examples, the context window 602 is a parameter that defines a maximum amount of information, typically measured in tokens, that a generative model 408 may consider during a single inference operation. The context window 602, for example, may represent a fixed-size buffer within the model's architecture that constrains the total length of input sequences, including system instructions, conversation history, user inputs, tool outputs, and/or any reference materials that may be processed together during inference. The context window 602 may be specific to a generative model 408 and may be determined based on the model's architecture, training configuration, and/or other operational constraints, with different models supporting different context windows 602 ranging from thousands to hundreds of thousands of tokens. During inference, all tokens within the context window 602 may be processed through the model's attention mechanisms, which compute relationships between tokens to generate output predictions, with computational and memory requirements scaling with the size of the context window 602. The context window 602 may impose a fundamental constraint on agent session execution, as the combined token count of session state logs 426, session metadata, tool outputs, and workspace artifacts must remain within the context window 602 for successful inference.

The exception threshold 616 may define a utilization level at which a context exception may be triggered during agent session 410 execution to avoid overloading a generative model 408 context window 602. The exception threshold 616 may be defined as a percentage of a maximum context window, such as 50%, 75%, 90%, and/or the like, establishing a buffer zone before the absolute context limit is reached to allow sufficient capacity for compression operations to complete before context overflow occurs. The exception threshold 616 may be implemented as a numeric value stored within system configuration, session configuration, or model configuration data structures. In some examples, the exception threshold 616 may be implemented as a fixed value applied uniformly across all sessions, a configurable parameter that varies based on model characteristics or task requirements, a dynamic value that adjusts based on compression routine performance or available system resource, and/or the like. In any implementation, the exception threshold 616 may enable proactive context management by providing advance warning before hard context window limits are reached, ensuring that compression routines have sufficient remaining capacity to operate effectively and preventing inference failures due to context overflow.

The computing system 101 may, in response to detecting the context exception, generate, using a two-stage compression routine, a compressed representation of at least the portion of the agent context data or the shared workspace repository 504. The two-stage compression routine may comprise a multi-stage context management technique that monitors context utilization, applies progressively aggressive compression strategies as needed, and preserves critical information through the compression process. In this manner, the two-stage compression routine may generate a compressed representation of context data that targets a reduced percentage (e.g., 30%, 50%) of the context window, enabling continued agent execution within context window constraints.

The compressed representation, for example, may comprise an output of a two-stage compression routine that reduces context data to a target percentage (e.g., 30%, 50%) of the context window 602 while preserving information for continued agent execution. The compressed representation may replace the original context data within the agent session 410, enabling the generative model 408 to continue inference operations within context window constraints without losing access to task information. In some examples, the compressed representation may comprise a combination of one or more location identifiers 608 that reference memory locations 606a-b within the data repository 414 and/or summaries (e.g., artifact summaries 610, state summaries 612) that provide condensed descriptions of the offloaded context data. In this manner, the compressed representation may maintain accessibility to full content through storage references, enabling retrieval of complete data when needed while minimizing inline context consumption. This, in turn, enables long-horizon tasks to continue execution beyond the point where accumulated context would otherwise exceed context window limits, supporting extended agent sessions 410 involving substantial conversation history, multiple tool invocations, large retrieved documents or generated outputs, and/or the like.

At a first stage of the two-stage compression routine, the computing system 101 may receive a large artifact 604 within at least the portion of the agent context data or the shared workspace repository 504 based on a size threshold.

A large artifact may comprise a data object within an agent session 410 that exceeds a configurable size threshold (e.g., 35,000 characters) and consumes substantial context window capacity without requiring full inline representation for continued task execution. Large artifacts 604, for example may comprise tool outputs returned from retrieval tools or external service invocations, generated files produced during agent execution, retrieved documents fetched from domain data sources, or other substantial data objects accumulated during task processing. The large artifact 604 may be stored within an agent session 410 or within a shared workspace repository 504 associated with the agent session 410.

The size threshold may comprise a configurable numeric value that defines the minimum size at which an artifact is classified as a large artifact 604 that may be offloaded during context compression. The size exception threshold 616 may be expressed in characters (e.g., 35,000 characters), bytes, tokens, or other size units appropriate to the measurement context. In some examples, the size threshold may be stored within system configuration, session configuration, or compression routine parameters, and may be implemented as a fixed value applied uniformly across all artifact types or as a variable value that differs based on artifact type, content structure, or available context capacity.

In some examples, first-stage candidate selection may comprise computing an offload priority score for each artifact candidate based on at least one of artifact size, recency of access, estimated regeneration cost, and reference frequency within active task instructions. Artifacts with priority scores above a configurable offload threshold may be selected first, while artifacts referenced by preserved content tokens 614 or active tool invocations may be deferred. The offload priority score may be evaluated in a single pass over candidate metadata and/or by maintaining an incremental priority index updated as artifacts are created, modified, or accessed.

At the first stage, the computing system 101 may store the large artifact 604 at a first memory location 606a within a data repository 414 and replace the large artifact 604 within at least the portion of the child context data or the shared workspace repository 504 with (i) a location identifier 608 corresponding to the first memory location 606a and/or (ii) an artifact summary 610 of the large artifact 604.

A memory location 606a-b may comprise a location within persistent storage, such as the data repository 414, where data may be stored for later retrieval, identified by a unique address or reference within the storage system. The memory location 606a-b, for example, may be implemented as a file path within a file system, an object key within an object storage service, a record identifier within a database, a block address within a block storage device, a unique resource identifier within a distributed storage system, and/or the like. The memory location enables retrieval of stored content through read operations that specify the location identifier 608, returning the complete data previously written to that location. In some examples, the memory location 606a-b may be associated with metadata, such as creation timestamps, access permissions, content type indicators, size information, and/or the like, which facilitate storage management and access control. In some examples, the memory location 606a-b may provide durable persistence that survives system restarts, worker failures, and session interruptions, enabling crash recovery by preserving artifacts and session state that may be retrieved when tasks resume from consistent checkpoints. The memory location abstraction enables the compression routine to offload large artifacts and session state logs to persistent storage while maintaining references within the compressed representation, preserving accessibility to full content through location identifiers 608 while reducing inline context consumption within the agent session 410.

The location identifier 608, for example, may comprise a reference indicating the memory location 606a-b of offloaded content from an agent session 410 within the data repository 414, enabling retrieval of the content from persistent storage. The location identifier 608 may be implemented as a file path specifying a directory structure and filename within a file system, an object key or URI within an object storage service, a primary key or record identifier within a database system, a content-addressable hash that uniquely identifies data based on its content, a uniform resource identifier (URI) that provides a standardized reference format across storage systems, and/or the like. In addition, or alternatively, the location identifier 608 may comprise components, such as storage system endpoints, access credentials, version identifiers, checksum values, and/or the like, which facilitate retrieval, verification, access control, and/or the like.

In some examples, the location identifier 608 may be generated or assigned when large artifacts 604 or session state logs 426 are stored at memory locations 606a-b within a data repository 414a during context compression, with the location identifier 608 returned to the calling process for inclusion in a compressed representation. The location identifier 608, for example, may be inserted into the agent session 410 alongside an artifact summary 610 when the large artifact 604 is offloaded during the first stage of a two-stage compression routine, replacing the full artifact content while maintaining a reference for subsequent retrieval. In this way, the location identifier 608 may enable the agent session 410 to access the complete stored content through retrieval operations that resolve the location identifier 608 to the corresponding memory location 606a-b and return the stored data. By doing so, the location identifier 608 may decouple the compressed context representation from the underlying storage implementation, enabling artifacts to be stored across various persistence mechanisms while maintaining consistent reference semantics within the agent session 410.

In some examples, the artifact summary 610 may comprise a truncated summary of a large artifact 604 that replaces the full artifact content within the agent session 410 after the large artifact 604 is offloaded to the data repository 414 during context compression. The artifact summary is generated during the first stage of a two-stage compression routine when a large artifact exceeding a size threshold is identified for offloading, providing a condensed representation that preserves information about the large artifact 604 while consuming fewer tokens than the original content. The artifact summary 610 may be generated through various techniques, such as truncation that retains initial or key sections of the large artifact 604, extraction of structural elements, such as headings, titles, or metadata, keyword or key phrase extraction that identifies salient terms, semantic summarization using the generative model 408 to produce a coherent condensed description of the artifact content, and/or the like.

In some examples, the artifact summary 610 may be inserted into the agent session 410 alongside a location identifier 608 that references the memory location 606a where the full artifact is stored within the data repository 414, enabling the agent session 410 to understand the artifact's content and purpose while maintaining the ability to retrieve complete data when needed. In this manner, the artifact summary 610 may provide sufficient context for the generative model 408 to reason about the artifact's relevance to the current task, make decisions about whether full retrieval is necessary, and reference the large artifact 604 in generated outputs without requiring the full content to be present in the context window 602.

In some embodiments, the two-stage compression routine may regenerate the token count after the first stage. If the token count meets or exceeds the exception threshold 616, the two-stage compression routine may proceed to the second stage. Otherwise, the two-stage compression routine may end prematurely.

In some examples, the two-stage compression routine may apply a tiered trigger policy comprising at least a warning threshold and the exception threshold 616. For example, when context utilization satisfies the warning threshold but not the exception threshold 616, the computing system 101 may pre-compute artifact rankings and extraction candidates without immediate replacement. When context utilization satisfies the exception threshold 616, the first stage may execute, followed by conditional execution of the second stage based on regenerated token count. In addition, or alternatively, in response to receiving a model-side context-limit error, the computing system 101 may execute first-stage and second-stage operations within the same compression cycle.

At a second stage of the two-stage compression routine, the computing system 101 may receive a session state log 426 from at least the portion of the agent context data and store the session state log 426 at a second memory location 606b within the data repository 414.

At the second stage, the computing system 101 may extract, based on a text-based extraction ruleset, a set of preserved content tokens 614 within the session state log 426. The text-based extraction ruleset, for example, may identify content for preservation during context compression, such as user instructions, active task descriptions, key decisions, designated identifiers, and/or the like. In some examples, the text-based extraction ruleset may comprise a set of rules, patterns, or criteria that may be applied to session state logs 426 to identify and/or extract preserved content tokens 614 for retention through the compression process to maintain task coherence and execution continuity. The text-based extraction ruleset may be implemented using regular expression patterns that match specific text structures, such as instruction markers, identifier formats, or decision indicators; keyword matching that identifies content containing predefined important terms or phrases; structural parsing that recognizes formatted elements, such as numbered lists, headers, or tagged sections; semantic classification using machine learning models that categorize content by importance or function; rule-based heuristics that evaluate content based on position, recency, or contextual markers, and/or the like.

The preserved content token 614, for example, may comprise content identified for preservation during context compression, such as user instructions, active task state, key identifiers, designated decisions, and/or the like. A preserved content token 614, for example, may be extracted from the session state log 426 during the second stage of a two-stage compression routine based on a text-based extraction ruleset that identifies content for continued task execution and coherence. The preserved content token 614 may comprise complete text segments, such as instruction blocks or decision statements, individual identifiers, such as session identifiers, resource references, or entity names, structured data elements, such as configuration parameters or state variables, marked content that has been explicitly tagged for preservation through formatting conventions or metadata annotations, and/or the like.

At the second stage, the computing system 101 may generate, using the generative model 408, a state summary 612 of the session state log 426 based on the session state log 426 and/or the set of preserved content tokens 614. The state summary 612, for example, may comprise a brief summary of the session state log 426 that replaces the full session state log 426 within the agent session 410 after the original log is stored to persistent storage (e.g., data repository 414) during context compression. The state summary 612 may be generated during the second stage of a two-stage compression routine, in some cases using the generative model 408, by processing the session state log 426 along with a set of preserved content tokens 614 extracted based on a text-based extraction ruleset to produce a condensed representation that maintains essential information while consuming substantially fewer tokens than the original conversation history.

By way of example, the preserved content tokens 614 may be extracted before the session state log 426 is summarized, ensuring that critical information is explicitly identified and retained rather than being subject to potential loss or dilution during the summarization process. For example, the preserved content tokens 614 may be provided to the generative model 408 along with the session state log 426 when generating a state summary 612, guiding the generative model 408 to incorporate the preserved content into the summary output and ensuring that the resulting compressed representation maintains the essential information needed for task continuation. In some examples, the preserved content tokens 614 may be inserted verbatim into the state summary 612, paraphrased while maintaining semantic fidelity, structured as a separate preserved section within the compressed representation, and/or the like, depending on the compression routine implementation. In this way, the state summary 612 may capture the semantic content of the session state log 426 including the progression of the conversation, key exchanges between user and agent, tool invocations and their outcomes, the current state of task execution, and/or the like, while omitting redundant, verbose, or low-importance content that does not contribute to continued task coherence.

In some examples, if state summary generation using the generative model 408 is unavailable, the computing system 101 may generate a fallback summary by combining preserved content tokens 614 with rule-based extraction of recent checkpoints, task decisions, and active identifiers. The fallback summary may include a location identifier 608 reference to the persisted session state log 426 to enable retrieval and on-demand reconstruction of full context.

At the second stage, the computing system 101 may replace the session state log 426 with the state summary 612 to further reduce the token count of the agent session 410. For example, the state summary 612 may be inserted into the agent session 410 to replace the full session state log 426, with the original log stored at a memory location 606b within the data repository 414. In this way, the state summary 612 may enable long-horizon tasks to continue execution beyond the point where accumulated conversation history would otherwise exceed context window limits, maintaining sufficient context for the generative model 408 to understand task objectives, prior actions, and/or current state while operating within context capacity constraints of the generative model 408.

FIG. 7 is a dataflow diagram of a multi-agent orchestration framework 700 in accordance with some embodiments of the present disclosure. A computing system, such as the computing system 101, may implement the multi-agent orchestration framework 700 to provide improved agent synchronization, in terms of accuracy, fault tolerance, and resolution speeds, in multi-agent prompting scenarios. To do so, the multi-agent orchestration framework 700 may break a prompting request 402 into a plurality of parallel session prompts 702a-c, provide the parallel session prompts 702a-c to a plurality of secondary agent sessions 704a-c, and execute a synchronization barrier that tracks completion status across the secondary agent sessions 704a-c and aggregates parallel prompt responses 708 into a collective response 706. By doing so, the multi-agent orchestration framework 700 may improve computer functionality by parallelizing task execution across multiple specialized agents, aggregating prompt responses based on associated source lists 710 to generate a synthesized collective response 706 that is defensible based on the underlying evidence and reducing overall response latency through concurrent processing while improving accuracy through multi-perspective analysis.

More particularly, the computing system 101, implementing the multi-agent orchestration framework 700, may receive a prompting request 402, such as the prompting request 402 described with reference to FIG. 4. As described herein, the prompting request 402 may comprise task context 406. In some examples, the task context 406 may comprise a request for parallel agent prompting.

A request for parallel agent prompting may comprise a request to perform a prompting request using multiple, different agents or generative models 408a-c concurrently within a multi-agent orchestration framework 700. In some examples, the request may comprise or reference model configuration instructions that define which models and/or agents to use in a parallel prompting framework, specifying agent identifiers, model identifiers, prompting strategies, tool configurations, or other parameters that differentiate the parallel execution paths.

In some examples, the request for parallel agent prompting may be processed by an orchestration layer of the computing system 101, and/or by a primary agent session 714 executed by the computing system 101. Responsive to a prompting request 402 with a request for parallel prompting, the computing system 101 may generate a set of parallel session prompts 702a-c from the original prompting request 402, where each parallel session prompt may comprise at least a portion of the prompting request 402 and identify a specific machine learning agent or generative model for execution in accordance with the model configuration instructions.

In this way, the request for parallel agent prompting may initiate concurrent execution across multiple secondary agent sessions 704a-c, with each secondary agent session 704a-c instantiated based on a different agent configuration that may define an isolated workspace, access credentials to tools, a model identifier for the generative model 408a-c, a prompting strategy for the generative model 408a-c, and/or the like. By doing so, the request for parallel agent prompting may enable diverse approaches to information gathering and synthesis by distributing the same task across multiple secondary agent sessions 704a-c with different capabilities, knowledge bases, reasoning approaches, or tool access, with results aggregated through synchronization mechanisms that detect completion across all parallel sessions 704a-c.

In some embodiments, the computing system 101 may generate a set of parallel session prompts 702a-c from the prompting request 402. For example, the prompting request 402 may be received by a primary agent session 714. The primary agent session 714 may comprise a root session, a parent session, and/or a child session, as described with reference to the hierarchical session structure of FIG. 5.

The computing system 101, and/or the primary agent session 714 thereof, may generate parallel session prompts 702 for up to each of a set of one or more secondary agent sessions 704a-c. The set of one or more secondary agent sessions 704a-c, for example, may be identified within the prompting request 402 and/or preconfigured within the multi-agent orchestration framework 700. By way of example, the computing system 101, and/or primary agent session 714 thereof, may generate a first parallel session prompt 702a for a first secondary agent session 704a, a second parallel session prompt 702b for a second secondary agent session 704b, a third parallel session prompt 702c for a third secondary agent session 704c, and/or the like.

In some examples, a parallel session prompt 702a of the set of parallel session prompts 702a-c may comprise at least a portion of the prompting request 402 and identify a machine learning agent (e.g., secondary agent session 704a) of a set of one or more machine learning agents (e.g., secondary agent sessions 704a-c) and/or a generative model 408a of a set of one or more generative models 408a-c.

By way of example, a parallel session prompt 702a may comprise a derivative of the prompting request 402 configured for execution using at least one of a different language model, different prompting strategy, or different tool configuration. The parallel session prompt 702a may comprise session-specific parameters, such as model identifiers, system instructions, tool restriction configurations, and/or context modifications. The parallel session prompt 702a may be dispatched to a corresponding secondary agent session 704a, which processes it through information gathering and synthesis phases, producing a parallel prompt response 708 comprising a session identifier, response segments 712, and/or a source list 710 for attribution.

In some examples, a parallel session prompt 702 may define a tool restriction configuration for a secondary agent session 704. For example, the first parallel session prompt 702a may comprise a first tool restriction configuration that defines a first subset of a set of tools available within the first secondary agent session 704a, the second parallel session prompt 702b may comprise a second tool restriction configuration that defines a second subset of the set of tools available within the second secondary agent session 704b, and/or the third parallel session prompt 702c may comprise a third tool restriction configuration that defines a third subset of the set of tools available within the third secondary agent session 704c.

In some embodiments, the computing system 101, and/or primary agent session 714 thereof, instantiates an execution of the first parallel session prompt 702a of the set of parallel session prompts 702a-c within the first secondary agent session 704a. In addition, or alternatively, the computing system 101 may instantiate an execution of the second parallel session prompt 702b of the set of parallel session prompts 702a-c within the second secondary agent session 704b. In addition, or alternatively, the computing system 101 may instantiate an execution of the third parallel session prompt 702c of the set of parallel session prompts 702a-c within the third secondary agent session 704c.

In some examples, the computing system 101, and/or primary agent session 714 thereof, may instantiate up to each of the secondary agent sessions 704a-c in accordance with one or more different agent configurations. An agent configuration, for example, may define an isolated workspace, an access credential to at least one of a set of tools, a model identifier for a generative model, a prompting strategy (e.g., system instructions, prompt formatting, and/or inference parameters) for the generative model, and/or one or more other operational parameters. In some examples, the first secondary agent session 704a may be instantiated in accordance with a first agent configuration, the second secondary agent session 704b may be instantiated in accordance with a second agent configuration that is different from the first agent configuration, and the third secondary agent session 704c may be instantiated in accordance with a third agent configuration that is at least partially different from at least one of the first or second agent configurations.

In some examples, the agent configuration may further comprise tool restriction configurations, execution mode settings, context propagation parameters, and/or the like, enabling differentiation between secondary agent sessions 704a-c within the multi-agent orchestration framework 700.

In some embodiments, the computing system 101, and/or primary agent session 714 thereof, receives parallel prompt responses 708 from one or more of the set of secondary agent sessions 704a-c. For example, the computing system 101 may receive, from the first secondary agent session 704a, a first parallel prompt response. In addition, or alternatively, the computing system 101 may receive, from the second secondary agent session 704b, a second parallel prompt response. In addition, or alternatively, the computing system 101 may receive, from the third secondary agent session 704c, a third parallel prompt response. Each parallel prompt response 708 may comprise session identifier, one or more response segments 712, and/or a source list 710 corresponding to the one or more response segments 712. By way of example, the first parallel prompt response may comprise a first session identifier corresponding to the first secondary agent session 704a, a first prompt segment, and/or a first source list associated with the first prompt segment, the second parallel prompt response may comprise a second session identifier corresponding to the second secondary agent session 704b, a second prompt segment, and/or a second source list associated with the second prompt segment, and the third parallel prompt response may comprise a third session identifier corresponding to the third secondary agent session 704c, a third prompt segment, and/or a third source list associated with the third prompt segment.

In some examples, each parallel prompt response 708 may comprise response segments 712 representing individual conclusions, assertions, or content units, with each response segment 712 associated with one or more index references within the source list 710 that attribute the response segment 712 to specific domain data sources 412. The response segments 712 may be independently attributed to supporting sources, evaluated for evidence quality, and compared against response segments from other agent sessions for consensus and disagreement identification.

In some examples, the source list 710 may comprise a session-specific source index cataloging domain data sources 412 accessed during information gathering. The source list 710 may comprise an ordered collection of source records with source metadata (e.g., URLs, titles, publication dates, excerpts), populated during the retrieval state as the agent invokes retrieval tools. The source list 710 may enable within-agent attribution through index references embedded in response segments 712 (e.g., “[1]” referring to the first source in the list).

In some embodiments, the computing system 101, and/or the primary agent session 714 thereof, provides a collective response 706 to the prompting request 402 by aggregating one or more of the response segments 712 within the parallel prompt responses 708 in accordance with their corresponding source lists 710. By way of example, the computing system 101 may aggregate at least one of a first prompt segment and/or the second prompt segment based on at least one of a first source list corresponding to the first prompt segment or the second source list corresponding to the second prompt segment.

In some examples, a collective response 706 is a synthesized output that aggregates results from multiple secondary agent sessions 704a-c executing in parallel, producing a unified response that is defensible based on the underlying evidence from all contributing agents. The collective response 706 may be generated by an orchestration layer of the computing system 101, and/or the primary agent session 714, that receives parallel prompt responses 708 from multiple secondary agent sessions 704a-c, each comprising a session identifier, generated content with response segments 712, a source list 710 associating claims with supporting sources, and/or the like.

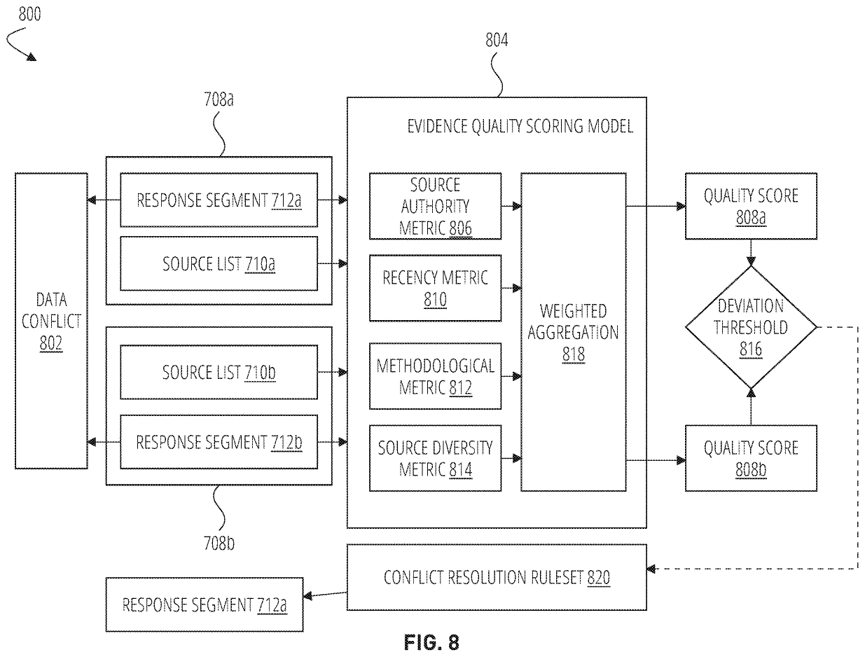

The collective response 706, for example, may be produced through synthesis processes that identify areas of consensus where multiple agents agree, identify areas of disagreement where agents conflict, and apply conflict resolution to resolve disagreements based on evidence quality assessment, as described herein with reference to FIG. 8.

In some embodiments, the computing system 101 receives one or more task status updates from the secondary agent sessions 704a-c. For instance, the computing system 101 may receive a task status update from at least one of the first secondary agent session 704a, the second secondary agent session 704b, and/or the third secondary agent session 704c.

In some examples, a task status update may comprise a message or detection of a phase transition within an agent session, distinguishing between a retrieval state where the agent invokes tools to gather information and a synthesis state where the agent generates textual outputs. The task status update may be generated by monitoring agent outputs for phase transition indicators and may be implemented as an explicit message or as an implicit detection through analysis of agent output streams.

In some embodiments, the computing system 101 detects a synchronization trigger based on at least one of the task status updates and/or a response time. For example, the computing system 101 may detect that at least one of the status updates identify a synthesis state. In addition, or alternatively, the computing system 101 may detect an expiration of a response timer associated with the prompting request. By way of example, the task status update may be used by synchronization mechanisms of the computing system 101 and/or primary agent session 714 to coordinate completion across multiple parallel agent sessions, with synchronization triggers detected when task status updates from multiple agents indicate that all agents have reached the synthesis state or when a response timer associated with the prompting request expires.

The synchronization trigger may be implemented using barrier synchronization primitives, countdown latches, event aggregation mechanisms, polling-based monitors, and/or the like.

In some examples, the computing system 101 may generate the collective response 706 based on at least one of the parallel prompt responses 708 in response to detecting the synchronization trigger, accommodating variable execution times through timeout mechanisms that prevent indefinite waiting for slow or failed agents and initiating a synthesis phase where parallel prompt responses 708 are aggregated, evidence quality assessment is performed, and conflict resolution is applied to produce the collective response 706.

In some examples, the collective response 706 may be generated in accordance with a data conflict resolution routine, which is described in further detail with reference to FIG. 8.

FIG. 8 is a dataflow diagram of a data conflict resolution routine 800 in accordance with some embodiments of the present disclosure. A computing system, such as the computing system 101, may implement the data conflict resolution routine 800 to provide improved data synchronization, in terms of accuracy, in multi-agent prompting frameworks. To do so, the data conflict resolution routine 800 may execute an evidence quality scoring model 804 in response to a detection of a data conflict 802 between one or more response segments 708a-b with corresponding source lists 710a-b. The evidence quality scoring model 804 may generate a plurality of metrics, such as a source authority metric 806, a recency metric 810, a methodological metric 812, and/or a source diversity metric 814, for up to each of the one or more response segments 708a-b based on their corresponding source lists 710a-b and, through a weighted aggregation 818, generate quality scores 808a-b for the response segments 708a-b. By doing so, the data conflict resolution routine 800 may improve data synchronization by assessing the underlying sources of the response segments 708a-b, rather than the segments in isolation. This, in turn, may improve computer functionality by producing synthesized outputs that are defensible based on the underlying evidence, maintaining transparency regarding conflict resolution by noting where agents disagreed, explaining the basis for resolution, citing specific sources supporting the resolved conclusion, and acknowledging residual uncertainty where appropriate.

In some implementations, outputs from multiple agent sessions may diverge on one or more response segments. The data conflict resolution routine 800 grounds resolution in evidence quality scoring model 804 outputs derived from source authority, recency, methodological rigor, and source diversity, and may apply deterministic deviation thresholds and conflict resolution rulesets to produce reproducible, source-attributed collective responses.

More particularly, the computing system 101 may detect a data conflict 802 between a first response segment 712a of a first parallel prompt response 708a and a second response segment 712b of a second parallel prompt response 708b. A data conflict 802, for example, may comprise a disagreement between outputs (e.g., parallel prompt responses 708a-b) from multiple agent sessions that produce conflicting conclusions, assertions, or factual claims in response to the same prompting request within a multi-agent orchestration framework. The data conflict 802 may be identified during synthesis processes that analyze parallel prompt responses 708a-b from multiple agents, comparing response segments 712a-b to detect semantic contradictions or inconsistent information where agents have reached different conclusions based on their respective information gathering and reasoning. In some examples, the data conflict 802 may be identified through semantic analysis using language models instructed to analyze agent outputs for agreement and disagreement, structured comparison of key claims extracted from each agent's output, computation of semantic similarity scores between response segments using text embedding models, pattern matching that detects contradictory assertions based on linguistic markers, and/or the like.

In some embodiments, the computing system 101 generates, using the evidence quality scoring model 804, a first quality score 808a for a first parallel prompt response 708a (e.g., a response segment 712a thereof) based on a first source list 710a corresponding to the parallel prompt response 708a and/or a response segment 712a thereof. In addition, or alternatively, the computing system 101 may generate, using the evidence quality scoring model 804, a second quality score 808b for the second parallel prompt response 708b (e.g., a response segment 712b thereof) based on a second source list 710b corresponding to the parallel prompt response 708b and/or the response segment 712b. By way of example, each quality score 808 may correspond to a particular response segment 712a-b of a parallel prompt response 708a-b.

The evidence quality scoring model 804, for example, may comprise an algorithm that assigns numerical quality scores to response segments 712a-b associated with a data conflict 802, enabling deterministic conflict resolution when multiple agent sessions produce conflicting response segments 712a-b within a multi-agent orchestration framework. The evidence quality scoring model 804, for example, may compute a composite evidence quality score Q for each source as a weighted combination of component scores according to the formula: Q_{source}=Wₜᵢₑᵣ×T_{source}+W_{recency}×R_{source}+W_{rigor}×M_{source}+W_{independence}×I_{source}, where T_{source} comprises a source authority metric 806, R_{source} comprises a recency metric 810, M_{source} comprises a methodological metric 812, I_{source} comprises a source diversity metric 814, and/or the like. In some examples, Wₜᵢₑᵣ, W_{recency}, W_{rigor}, and/or W_{independence} may comprise configurable weights.

In some examples, the resulting quality scores 808a-b for each response segment 712a-b may comprise a numerical value generated by the evidence quality scoring model 804 that quantifies the reliability and/or authoritativeness of a source for the response segments 712a-b, which may be used for a conflict resolution technique that is grounded in the sources of a response segment 712 rather than the content of the response segment 712. The quality scores 808a-b, for example, may be computed as a weighted aggregation 818 of component scores, combining a source authority metric 806 based on source tier classification, a recency metric 810 based on publication date relative to a decay window, a methodological metric 812 based on the presence of quality indicators such as methodology descriptions, quantitative data, citations, and peer review, and/or a source diversity metric 814 based on the count of independent sources supporting a response segment 712, as described in further detail herein.

In some examples, the quality scores 808a-b may be computed for individual sources within a source list 710, producing per-source scores that may be aggregated to generate a quality score for an entire response segment 712a-b, with aggregation methods including maximum score selection, weighted averaging, summation with bonuses for additional supporting sources, and/or the like. In some examples, the quality scores 808a-b may be normalized to a standard range (e.g., 0 to 1) to enable consistent comparison across different sources, agents, and/or evaluation contexts. In this manner, the quality scores 808a-b may enable deterministic conflict resolution by providing an objective, quantifiable basis for preferring one agent's conclusion over another when disagreements are identified, replacing subjective judgment or simple voting mechanisms with evidence-based assessment grounded in source characteristics.

In some examples, a quality score 808 for a response segment 712a-b may be computed from per-source scores using an aggregation function such as: Q_{segment}=(Bₘₐₓ*max(Q_{source}))+(Bₘₑₐₙ*mean(Q_{source}))+Bₛᵤₚₚₒᵣₜ+I_{conclusion}, where Bₘₐₓ, Bₘₑₐₙ, and Bₛᵤₚₚₒᵣₜ may comprise configurable coefficients that sum to one. In some examples, if one or more component metrics are unavailable for a source, the evidence quality scoring model 804 may apply a default value and/or renormalize remaining coefficients to preserve deterministic scoring behavior across response segments.

In some examples, the evidence quality scoring model 804 may generate a quality score 808 based on a weighted aggregation 818 of at least one of the source authority metric 806, the recency metric 810, the methodological metric 812, and/or the source diversity metric 814.

The source authority metric 806 may comprise a component of the evidence quality scoring model 804 that evaluates the authoritativeness of a source based on its classification within a hierarchical source taxonomy. The source authority metric 806, for example, may assign a source tier score T_{source} based on the source's position within a tiered classification system that orders sources by authoritativeness level in descending order, reflecting the principle that sources closer to original, authoritative information may be more reliable for conflict resolution than sources further removed from such information.

By way of example, the tiered classification system may classify sources into tiers, such as primary sources (highest tier) including peer-reviewed academic publications, official government publications, regulatory documents, primary documentation from authoritative bodies, direct statements from principals, court opinions, and original research data; secondary sources (intermediate tier) including reputable journalism from established news organizations, encyclopedia entries from curated sources, technical documentation from established publishers, expert analysis, and industry reports; and/or tertiary sources (lowest tier) including user-generated content, anonymous or pseudonymous publications, sources lacking clear authorship or institutional backing, content without editorial review, and self-published material without peer review. The tiered classification system may assign a numerical score to each tier that preserves the hierarchical ordering (e.g., T=1.0 for primary sources, T=0.7 for secondary sources, T=0.4 for tertiary sources), with specific values configurable based on application requirements. The source authority metric 806 for a response segment 712a may comprise the numerical score corresponding to the tier associated with a corresponding source within the source list 710. In this manner, the source authority metric 806 may enable evidence-based conflict resolution by providing an objective basis for preferring conclusions supported by more authoritative sources.

In some examples, the recency metric 810 may comprise a component of the evidence quality scoring model 804 that evaluates the timeliness of a source based on its publication date relative to the current date. The recency metric 810, for example, may comprise a recency score R_{source} that may be generated using a time-decay function that weights more recent sources higher than older sources, reflecting the principle that more recently published information may be more accurate or relevant for time-sensitive topics.

By way of example, the recency metric 810 may be computed using a linear decay function:

$${R}_{source} = max ( 0 , 1 - \frac{current\_date - publication\_date}{decay\_window} ) ,$$

where decay_window may comprise a configurable parameter that determines the time period over which source relevance decays. In some examples, the decay_window may be configured based on topic characteristics, with shorter windows (e.g., 30 days) suitable for time-sensitive topics, such as current events or rapidly evolving technical fields, longer windows (e.g., 365 days) suitable for general queries, and/or extended or disabled recency weighting for historical or stable topics where publication date is less relevant.

In some examples, the recency metric 810 may comprise a score ranging from a maximum value (e.g., 1.0 for sources published on the current date) to a minimum value (e.g., 0.0 for sources published at or beyond the decay window). In addition, or alternatively, alternative decay functions may be employed, such as exponential decay that applies steeper penalties to older sources, step functions that assign discrete scores based on age brackets, logarithmic decay that moderates the penalty for moderately old sources, and/or the like. In any implementation, the recency metric 810 may enable evidence-based conflict resolution by providing an objective basis for preferring conclusions supported by more recently published sources when timeliness is relevant to the query domain.

In some examples, the methodological metric 812 may comprise a component of the evidence quality scoring model 804 that evaluates the rigor and/or verifiability of a source based on the presence of quality indicators within the source content. The methodological metric 812, for example, may comprise a methodological rigor score M_{source} computed as a weighted sum of binary indicator variables that reflect whether specific quality characteristics are present or absent in the source.

By way of example, the methodological metric 812 may be computed using the formula: M_{source}=(has_methodology×w1)+(has_data×w2)+ (has_citations×w3)+(has_peer_review×w4), where each indicator is binary (1 if present, 0 if absent): has_methodology indicates whether the source describes its methodology or data collection approach, has_data indicates whether the source provides quantitative data or evidence, has_citations indicates whether the source cites other sources to support claims, and has_peer_review indicates whether the source underwent peer review or editorial review. The weights w1, w2, w3, and w4 may be configurable and/or may be selected to reflect the relative importance of each indicator, with example configurations assigning greater weight to methodology and data indicators (e.g., 0.3 each) than to citation and peer review indicators (e.g., 0.2 each).

In some examples, the methodological metric 812 may employ additional or alternative quality indicators based on application requirements, such as sample size disclosure, statistical significance reporting, conflict of interest statements, replication information, and/or the like. In any implementation, the methodological metric 812 may enable evidence-based conflict resolution by providing an objective basis for preferring conclusions supported by sources that demonstrate greater rigor and verifiability in their methodology and evidence presentation.

In some examples, the source diversity metric 814 may comprise a component of the evidence quality scoring model 804 that evaluates the strength of evidence supporting a response segment 712a-b based on the number of independent sources corroborating that response segment 712a-b. The source diversity metric 814, for example, may comprise an independence score I_{source} or I_{conclusion} that rewards response segments 712a-b supported by multiple independent sources, reflecting the principle that convergent evidence from diverse, unrelated sources provides stronger support than multiple citations of the same underlying source.

The source diversity metric 814 may be computed using the formula

$${I}_{conclusion} = min ( max\_score , \frac{unique\_source \_count}{independence\_threshold} ) ,$$

where unique_source_count may comprise the number of independent sources supporting the conclusion after deduplication to remove sources citing the same underlying source, independence_threshold may comprise a configurable parameter representing the number of independent sources needed to achieve a maximum independence score (e.g., 3 sources), and max_score (e.g., 1.0) may cap the independence score to prevent unbounded contribution from highly-sourced conclusions.

In some examples, the source diversity metric 814 may be generated by applying deduplication logic that identifies when multiple sources reference or derive from the same underlying primary source, preventing artificial inflation of independence scores through citation of derivative sources. The deduplication logic may be implemented through source relationship analysis that traces citation chains, content similarity detection that identifies substantially similar source material, domain-based grouping that recognizes sources from the same organization or publication as potentially non-independent, and/or the like. In any implementation, the source diversity metric 814 may enable evidence-based conflict resolution by providing an objective basis for preferring response segment 712a-b that are corroborated by multiple independent sources over response segment 712a-b supported by a single source or multiple dependent sources.

In some examples, the evidence quality scoring model 804 may generate the collective response 706 by selecting one of the first response segment 712a and/or second response segment 712b based on the quality scores 808a-b, a deviation threshold 816, and/or a conflict resolution ruleset 820.

The deviation threshold 816 comprises a resolution threshold that defines a minimum distance between quality scores 808a-b of two response segments 712a-b for selecting one response segment 712a over another response segment 712b during conflict resolution within a multi-agent orchestration framework. The deviation threshold 816 may comprise a configurable numeric value (e.g., 0.15) that establishes the margin by which one response segment's 712a aggregate quality score may exceed another response segment's 712b aggregate quality score for deterministic resolution.

The deviation threshold 816, for example, may define a margin requirement for deterministically filtering the first prompt segment 712a or the second prompt segment 712b from the collective response 706 to remove a data conflict from the collective response 706. For example, the computing system 101 may implement an evidence-based filtering mechanism by filtering the first prompt segment 712a from the collective response 706 based on a reliability (e.g., as determined by a first quality score 808a and the deviation threshold 816) of the first source list 710a or the second prompt segment 712b from the collective response 706 based on a reliability (e.g., as determined by a second quality score 808b and the deviation threshold 816) of the second source list 710b.

In some examples, the deviation threshold 816 may comprise a configurable numeric value that is tunable based on an accuracy criterion and/or a speed criterion associated with a prompting request or an agent task or subtask thereof. For example, the configurable numeric value may be increased to improve an accuracy of the collective response 706 (e.g., by enforcing a larger margin between the quality scores 808a-b) and/or decreased to improve a resolution speed (e.g., by reducing the margin to enable faster resolutions) of the collective response 706. In this manner, the data conflict resolution routine 800 of the present disclosure may provide an adaptable threshold capable of selectively improving the accuracy or the speed of a computer with respect the multi-agent task resolution.

In some examples, the deviation threshold 816 may be compared against the absolute difference between aggregate quality scores 808a-b computed for conflicting conclusions, with the comparison determining the resolution path. For example, if the score difference exceeds the deviation threshold 816, the response segment 712a with the higher quality score 808a may be selected. Otherwise, if the score difference is within the deviation threshold 816, the response segments 712a-b may be passed to the conflict resolution ruleset 820.

In some examples, the conflict resolution ruleset 820 may be evaluated in strict priority order, and rule evaluation may terminate when a rule yields a winner. If all rules are exhausted without selecting one response segment 712a-b, the computing system 101 may generate an uncertainty-marked collective response that includes both response segments 712a-b and corresponding source references.

In some examples, the conflict resolution ruleset 820 may comprise a set of tie-breaking rules applied when aggregate quality scores 808a-b for conflicting response segments 712a-b are within a deviation threshold 816, providing a deterministic procedure for resolving conflicts that cannot be resolved based on quality score differences alone. The conflict resolution ruleset 820 may comprise an ordered sequence of rules that may be evaluated in a defined priority order until one rule produces a resolution or all rules have been exhausted.

By way of example, the conflict resolution ruleset 820 may comprise rules, such as (1) higher maximum tier rule, which prefers the response segment 712a-b supported by the higher-tier maximum source (primary over secondary over tertiary) based on source authority classification of the source authority metric 806; more recent source rule, which prefers the response segment 712a-b supported by the more recently published source based on publication timestamps; greater source count rule, which prefers the response segment 712a-b supported by more independent sources based on unique source enumeration; and/or uncertainty acknowledgment rule, which marks the response segment 712a-b as uncertain and presents both response segment 712a-b when preceding rules do not resolve the conflict.

In some examples, the conflict resolution ruleset 820 may be implemented as an ordered collection of rule functions and/or conditional logic blocks that evaluate specific criteria and return either a resolution decision or a continuation signal to proceed to the next rule. The conflict resolution ruleset 820 may be configured with different rule orderings or rule selections based on application domain, query type, user preferences, and/or the like, enabling customization of tie-breaking behavior for different contexts. The conflict resolution ruleset 820 may provide deterministic conflict resolution by using a decision procedure configured to handle a broad range of conflict cases, either selecting one response segment 712a based on a distinguishing criterion or explicitly acknowledging uncertainty when no criterion distinguishes the conflicting response segment 712a-b. In this manner, the conflict resolution ruleset 820 may maintain transparency by documenting which rule produced the resolution, enabling explanation of why one response segment 712a was preferred over another response segment 712b in the synthesized output.

In some embodiments, the computing system 101 may provide tool execution safety and coordination across multiple agent sessions. For example, as described herein, agent sessions, and/or worker instances thereof may invoke one or more tools during task execution. Some tools may be safely executed concurrently, while others require sequential execution to prevent conflicts, race conditions, inconsistent state, and/or the like. To handle such scenarios, the computing system 101 may classify up to each tool within a tool repository as concurrency-safe tools (e.g., tools that may be safely executed concurrently with other concurrency-safe tools due to no shared state, independent results, etc.) or concurrency-unsafe tools (e.g., tools that require sequential execution due to shared state, ordering guarantees, etc.).

In some examples, when an agent session 410 (or a worker instance thereof) requests a tool invocation, a set of requested tools may be identified, each tool's safety classification may be retrieved, and if all tools are concurrency-safe, parallel execution may proceed. Otherwise, if any tool is concurrency-unsafe, sequential execution may be used. In some examples, the aggregation of the set of request tools may occur before any tool begins execution.

In some examples, when parallel execution is approved, the tool invocations may be dispatched concurrently, each invocation may execute in an isolated context, preventing cross-invocation interference, results may be collected as invocations complete, and then the results may be processed together. In this way, parallel execution may reduce overall latency when multiple independent operations are requested.

In some examples, when sequential execution is approved, the tool invocations may be dispatched one at a time, in a defined order, and each invocation may complete before the next begins. In this way, sequential execution may ensure state changes from earlier invocations may be visible to later invocations. While slower, sequential execution may ensure correctness for tools with dependencies or shared state.

In some examples, mixed execution strategies may be employed. For example, the agent session 410, and/or the computing system 101, may implement dependency graphs, where tools may specify dependencies on other tools such that the agent session 410, and/or the computing system 101 may execute tools in topological order respecting dependencies. As another example, the agent session 410, and/or the computing system 101 may implement resource-based grouping mechanisms, wherein tools may be grouped by the resources they access and tools accessing disjoint resources may execute concurrently even if not globally concurrency-safe. In some examples, the agent session 410, and/or the computing system 101, may implement a speculative execution scheme, where tools may execute speculatively in parallel, with results discarded if conflicts are detected.

In some examples, the computing system 101 may lock tools to prevent tool execution conflicts within a multi-agent orchestration framework with a shared tool repository. For example, up to each tool, of the set of tools, may be associated with a locking flag that may be toggled based on an execution state of the tool. In some examples, a tool may be associated with a locking flag based on its safety classification. For example, up to each tool associated with a concurrency-unsafe safety classification may be associated with a locking flag to prevent tool execution conflicts due to concurrent tool executions within one or more different agent sessions of a multi-agent orchestration framework.

By way of example, the computing system 101 may toggle the locking flag for a tool to disable or enable a tool invocation based on the tool's use across one or more agent sessions of the multi-agent orchestration framework. For instance, the locking flag may be set to a locked state in response to detecting a tool invocation of the tool within at least one agent session of the multi-agent orchestration framework. In addition, or alternatively, locking flag may be set to an unlocked state in response to detecting a completion of an execution of the tool within at least one agent session of the multi-agent orchestration framework. In some examples, in response to receiving a tool invocation for the tool, the computing system 101 may provide a rejection message based on the locking flag or the safety classification to prevent an execution conflict. For example, the computing system 101 may provide the rejection message if the locking flag is set to a locked state to prevent an execution conflict within a multi-agent ecosystem. Otherwise, if the locking flag is set to an unlocked state, the computing system 101 may provide an access granted message.

FIG. 9 is a dataflow diagram of a cross-agent provenance tracking framework 900 in accordance with some embodiments of the present disclosure. A computing system, such as the computing system 101, may implement the cross-agent provenance tracking framework 900 to provide improved provenance tracking, in terms of accuracy, in multi-agent prompting frameworks. To do so, the cross-agent provenance tracking framework 900 may provide an index mapping scheme that wraps index references 908a-e from a session-specific source list 710 with a session identifier 428 and stores the wrapped references within a composite source index 910 to preserve the index references 908a-e for cross-agent attribution. In this regard, when multiple reasoning agents gather information and a synthesizer combines their outputs, maintaining traceability from synthesized claims to original sources may involve cross-agent mapping across session-specific indices. The cross-agent provenance tracking framework 900 addresses this technical problem by implementing a multi-level attribution system that maintains provenance through a multi-agent pipeline, enabling synthesized outputs to be traced to specific sources found by specific agents. By doing so, the cross-agent provenance tracking framework 900 may improve computer functionality by preserving provenance metadata through a synthesis pipeline.

More particularly, in some embodiments, up to each prompt response 912 (e.g., a parallel prompt response 708 of FIG. 7, a child prompt response of FIG. 5) received by an agent session 410 comprises a set of response segments 902, 904, and 906. In some examples, each response segment of the set of response segments 902, 904, and 906 may correspond to one or more index references 908a-e within a session-specific source list 710 that record one or more evidences from one or more of the domain data sources 412 that support the respective response segment. By way of example, a first response segment 902 may correspond to a first and second index reference 908a-b, a second response segment 904 may correspond to a first, second, and third index references 908a-c, a third response segment 906 may correspond to a fourth and fifth index reference 908d-e, and/or the like.

In some examples, an index reference 908a is a within-agent attribution mechanism that attributes an individual agent response segment 902 to one or more domain data sources 412 discovered during information gathering. The index reference 908a may be represented as an index into the agent's source list 710. The index reference 908a, for example, may comprise a textual marker embedded within a response segment 902 that points to a specific position within the source list 710. For example, the index reference 908a may be formatted as a bracketed number (e.g., “[1]” referring to the agent's first source, “[2]” referring to the second source). The index reference 908a may establish a link between a response segment 902 within the prompt response 912 and the source record at the corresponding index position in the source list 710, enabling traceability from response content to supporting evidence.

In some embodiments, the index reference 908a is implemented as an inline text annotation inserted by the generative model during response generation, a structured data element within a response object that associates text spans with source indices, a markup tag that wraps attributed content with source reference metadata, and/or the like. In some examples, the index reference may be parsed during synthesis processes to resolve attributions, with the index value used to retrieve the corresponding source record from the source list 710 to access source metadata, such as URLs, titles, publication dates, excerpts, and/or the like. In this manner, the index reference 908a may enable evidence quality assessment by identifying which sources support each first response segment 902, allowing quality scores to be computed based on the characteristics of the referenced sources, as described herein with reference to FIG. 8.

In some examples, the computing system 101 may generate a composite source index 910 for a collective response 706 based on the source lists 710 within one or more received prompt responses 912. The composite source index 910, for example, may comprise one or more source lists segmented by session identifiers respectively identifying the origin (e.g., the transmitting agent session) of the source lists. By way of example, the computing system 101 may generate a composite source reference for a first response segment 902 based on the index reference 908a and a session identifier corresponding to the agent session 410. In some examples, the computing system 101 may insert the first response segment 902 with the composite source index reference 908a within the collective response 706.

In some examples, the composite source index 910 comprises a unified data structure that indexes sources across all agents within a multi-agent orchestration framework, enabling cross-agent attribution and provenance tracking for synthesized outputs. The composite source index 910, for example, may aggregate source lists 710 from multiple prompt responses 912 into a single indexed structure, with sources segmented by session identifier 428 to maintain association between sources and their originating agent sessions. For example, the composite source index 910 may comprise source records that comprise session identifiers 428 and/or a display name identifying the agent session that discovered the source, tool invocation identifiers enabling traceability to specific research operations that retrieved the source, source index within the agent's results corresponding to the original index reference position, source metadata, such as URL, title, publication date, and/or excerpt, a global index for efficient lookup across all sources from all agents, and/or the like.

In some examples, the composite source index 910 may be generated during collective response synthesis by iterating through prompt responses 912 from all contributing agent sessions, extracting source lists 710 from each prompt response 912, and inserting source records into the composite source index 910 with appropriate agent identification and/or indexing. In this way, the composite source index 910 may enable resolution of composite source references embedded in synthesized outputs, where a reference, such as “[Agent A:1]” is resolved by locating the source record matching the specified session identifier 428 and index reference 908a within the composite structure. By doing so, the composite source index 910 may support provenance metadata preservation through the synthesis pipeline, maintaining information about how and when sources were found, and enabling users to trace synthesized response segments 902, 904, 906, within a collective response 706 to original sources and/or click through to source content. This, in turn, provides the foundation for cross-agent attribution that maintains traceability from collective response 706 content to specific sources found by specific agents, supporting verification, audit trail generation, and/or transparency in multi-agent synthesized outputs.

By way of example, the composite source index 910 may comprise a set of composite source references, which may comprise a cross-agent attribution mechanism in which a synthesizer attributes response segments 902 to sources from any agent within a multi-agent orchestration framework. Each composite source reference, for example, may comprise an index reference 908a wrapped by a session identifier 428 corresponding to the prompt response 912 that contributed the response segment 902 to enable unambiguous source identification.

In some examples, the composite source reference may comprise a textual marker embedded within a collective response 706 that combines the session identifier 428 with an index reference 908a to uniquely identify a source across agent boundaries, typically formatted as a bracketed combination (e.g., “[Agent A:1]” referring to Agent A's first source). In this manner, the composite source reference may maintain transparency in multi-agent synthesis by preserving the provenance chain from synthesized output through the contributing agent to the original source, enabling audit trail generation and compliance with requirements for explainable AI.

FIG. 10 is a dataflow diagram of a fault recovery framework 1000 in accordance with some embodiments of the present disclosure. A computing system, such as the computing system 101, may implement the fault recovery framework 1000 to provide improved fault detection and recovery, in terms of speed, processor expense, and reliability, in distributed processing ecosystems. To do so, the fault recovery framework 1000 may leverage an execution queue 1008 that prioritizes agent tasks 1010 according to temporal task status 1014 that may be automatically monitored and updated to account for activity within the distributed processing ecosystem. In this regard, the execution queue 1008 may be implemented as a unified task queue that simplifies coordination and enables efficient queries and distribution of agent tasks 1010 across a distributed processing ecosystem. By doing so, the fault recovery framework 1000 may improve computer functionality by enabling tasks to recover from failures with minimal loss of progress through a persisted task state 1018, allowing resumed tasks to continue from consistent checkpoints rather than restarting from the beginning, thereby preventing waste of computational resources and user time that would otherwise result from failed tasks requiring complete restart.

In some distributed computing implementations, scheduling, liveness, and recovery signals may be coordinated through a unified control path. The fault recovery framework 1000 coordinates temporal task status 1014, worker identifier 1012 lifecycle management, heartbeat signals 1006, and persisted task state 1018 within a unified execution queue 1008-based control path, enabling deterministic reassignment and state-aware continuation after worker failure.

More particularly, in some embodiments, an agent session 410 maintains an execution queue 1008 comprising a set of agent tasks 1010 and corresponding temporal task status 1014 and/or worker identifiers 1012.

The execution queue, for example, may comprise a priority queue and/or other data structure designed to record a set of agent tasks 1010. The execution queue 1008, for example, may comprise a unified task queue that maintains a set of tasks awaiting or undergoing processing within a multi-worker execution environment. The execution queue 1008 may be implemented as a sorted data structure where an agent task 1010 may be associated with a temporal task status 1014 indicating when the agent task 1010 is ready for processing. For example, the execution queue 1008 may store task records comprising task identifiers, session identifiers, task scheduling timestamps, and/or task state information that determines task eligibility for assignment to worker instances 1002a-b. For instance, the execution queue 1008 may organize agent tasks 1010 based on temporal task statuses 1014 derived from a relative temporal indicator (e.g., a task scheduling timestamp), as described herein.

In some examples, the execution queue may be implemented using sorted set data structures in key-value stores that support efficient range queries by score, priority queue data structures that order elements by timestamp, database tables with indexed timestamp columns that enable efficient selection of ready tasks, distributed queue systems that provide ordering guarantees across multiple nodes, and/or the like. In some examples, the execution queue 1008 may interface with worker instances 1002a-b that poll or subscribe to the execution queue 1008 to receive task assignments, with task selection based on temporal task status 1014 ordering to ensure fair scheduling and timely processing. As described herein, the execution queue 1008 may support fault tolerance by automatically making tasks available for reassignment when worker instances 1002a-b fail to refresh task scores through heartbeat signals 1006 or other refreshing mechanisms, enabling detection of worker failures and recovery through task reassignment to healthy workers without requiring explicit failure notifications.

In some examples, a temporal task status 1014 may comprise a relative temporal indicator corresponding to one of a set of defined operational states. The set of defined operational states, for example, may comprise a ready state, a sleeping state, and/or a running state. In some examples, an agent task 1010 may be positioned within the execution queue 1008 based on the relative temporal indicator of the temporal task status 1014. By way of examples, the relative temporal indicator may comprise a timestamp and the agent tasks 1010 may be positioned in increasing order of their timestamp values, with the agent task 1010 associated with a most recent or historical relative temporal indicator positioned first and the agent task 1010 associated with the relative temporal indicator at the furthest future timestamp positioned last.

In some examples, the relative temporal indicator of the temporal task status 1014 may comprise a current timestamp and/or a preceding timestamp preceding the current timestamp for a ready state. In addition, or alternatively, the relative temporal indicator of the temporal task status may comprise a subsequent timestamp subsequent to the current timestamp for a sleeping state. In some examples, the relative temporal indicator of the temporal task status may comprise a heartbeat offset timestamp that is subsequent to the current timestamp by a heartbeat timeout for a running state.

In some examples, temporal task status transitions may follow deterministic state-transition conditions comprising: (i) ready-to-running in response to successful task acquisition and storage of worker identifier 1012, (ii) running-to-running in response to heartbeat refresh that sets the relative temporal indicator to current timestamp plus heartbeat timeout, (iii) sleeping-to-ready when current timestamp reaches or exceeds the scheduled timestamp, and (iv) running-to-ready for reassignment when current timestamp reaches or exceeds the relative temporal indicator and associated lock ownership expires.

By way of example, the temporal task status 1014 may comprise a timestamp score indicating when a task is ready for processing within an execution queue, determining task eligibility for assignment to worker instances 1002a-b based on the relationship between the score and the current time. The temporal task status 1014 may categorize tasks into distinct states based on their timestamp scores. For example, ready tasks (e.g., associated with a ready state) may comprise scores (e.g., relative temporal indicator) equal to or less than the current time and may be available for immediate processing by worker instances 1002a-b. As another example, sleeping tasks (e.g., associated with a sleeping state) may comprise scores (e.g., relative temporal indicator) equal to a future wake time and become ready when the scheduled time arrives, enabling deferred execution for agent tasks 1010 that should not be processed until a specified time. As another example, running tasks (e.g., associated with a running state) may comprise scores (e.g., relative temporal indicators) set to the current time plus a heartbeat timeout and appear ready only if the first worker instance 1002a fails to refresh the score (e.g., relative temporal indicator), enabling automatic detection of worker failures through score expiration.

In some examples, the relative temporal indicator of the temporal task status 1014 may be updated throughout the agent task 1010 lifecycle. For example, when an agent task 1010 is created, the relative temporal indicator may be set to the current time or a future scheduled time. Thereafter, when a first worker instance 1002a acquires the agent task 1010, the relative temporal indicator may be set to the current time plus a heartbeat timeout to mark the agent task 1010 as running. In addition, or alternatively, when the first worker instance 1002a sends a heartbeat signal 1006 during execution, the relative temporal indicator may be extended into the future to indicate continued processing. In some examples, when the agent task 1010 is completed, the agent task 1010 may be removed from the execution queue 1008 or marked with a completion status and the relative temporal indicator may be removed or set to a null value.

In some embodiments, the computing system 101 assigns an agent task 1010 from the execution queue to a first worker instance 1002a within a multi-worker execution environment based on the temporal task status 1014. A worker instance 1002a-b, for example, may comprise a process responsible for executing agent tasks 1010 within a multi-worker execution environment, operating concurrently with other worker instances 1002a-b to distribute task processing across available computing resources. In some examples, the worker instances 1002a-b may poll or subscribe to an execution queue 1008 to receive task assignments, selecting agent tasks 1010 based on temporal task status 1014 and/or relative temporal indicators that indicate task readiness for processing.

In some examples, the worker instances 1002a-b may be implemented as an operating system process, a thread within a multi-threaded application, a container instance within a container orchestration platform, a serverless function invocation, a virtual machine instance, and/or the like, depending on the deployment architecture. In some examples, a worker instance 1002a-b may be identified by a unique worker identifier 1012 that enables tracking of task assignments, heartbeat signals 1006, and/or lock ownership across the distributed system. In this way, the first worker instances 1002a-b may enable fault-tolerant distributed task execution by maintaining heartbeat signals 1006 that allow detection of worker failures through absence of signals beyond a heartbeat timeout, with failed workers' tasks automatically becoming available for reassignment to healthy worker instances.

In some examples, upon assigning the agent task 1010 to the first worker instance 1002a, the computing system 101 may store a worker identifier 1012 of the first worker instance 1002a within the execution queue 1008 in association with the agent task 1010. In some examples, the worker identifier 1012 may be associated with a time-to-live interval. The computing system 101 may remove the worker identifier 1012 from the execution queue 1008 in response to detecting an expiration of the time-to-live interval. In addition, or alternatively, the computing system 101 may replace the worker identifier 1012 within the execution queue 1008 with a refreshed worker identifier in response to receiving a heartbeat signal 1006 from the first worker instance 1002a. The refreshed worker identifier may comprise a refreshed time-to-live interval.

By way of example, the first worker instance 1002a may acquire a distributed lock associated with the task's session identifier before processing an agent task 1010. Lock acquisition, for example, may be performed atomically to ensure that only one worker instance 1002 processes a given agent task 1010 at a time, and lock acquisition failure may indicate that another worker instance 1002 is processing the agent task 1010 and prompting selection of a different agent task 1010.

In some examples, a time-to-live interval for the distributed lock may comprise a configurable duration that specifies how long the lock remains valid before automatic expiration, ensuring that resources held by failed worker instances 1002a-b are eventually released without requiring explicit release operations. The time-to-live interval may be aligned with the heartbeat timeout, such that a failed worker's lock expires at approximately the same time the associated agent task 1010 becomes ready for reprocessing, coordinating lock release with task reassignment. The time-to-live interval may be extended each time a worker instance 1002a-b sends a heartbeat signal 1006, maintaining lock validity as long as the worker instance continues to signal active processing. The time-to-live interval may be implemented using expiration timestamps in distributed coordination systems, time-based key expiration features in key-value stores, lease mechanisms, timeout parameters in database lock implementations, and/or the like.

In some embodiments, the computing system 101 receives, at a defined time interval, a task state associated with the agent task 1010 from the first worker instance 1002a. In some examples, the task state 1018 may comprise at least one of a task log, a session metadata log, a session state log, a task status indicator, and/or the like. In some examples, the computing system 101 may store the task state 1018 within a registration record 1016 corresponding to the agent task 1010.

In some examples, the task state 1018 may comprise persisted data that enables resumed tasks to continue from consistent checkpoints rather than restarting, comprising the session state log, the task log with pending operation records, the session metadata log, artifacts, and progress indicators. The task state 1018 may be updated at consistent checkpoints during task execution, with updates written durably to persistent storage before proceeding to ensure recoverability, thereby enabling fault-tolerant task execution that minimizes loss of progress and avoids redundant computation.

In some examples, the task state 1018 may be persisted as a structured checkpoint record comprising at least one of a task identifier, a session identifier, a checkpoint sequence number, a last-completed operation identifier, a pending-operations list, and an integrity value. During recovery, the computing system 101 and/or the second worker instance 1002b may validate checkpoint ordering and integrity before applying recovered state, reducing replay of stale checkpoint data and partial-write artifacts.

By way of example, the task state 1018 may be provided by and/or received from a worker instance 1002a-b at a defined time interval that may be the same or different from a heartbeat time interval. The defined time interval may comprise a configurable duration (e.g., 5 seconds, 2 minutes) specifying the frequency at which consistent checkpoints are created during task execution. The defined time interval may be expressed in seconds, milliseconds, or other time units, and may be adjusted dynamically based on task characteristics, system load, or storage performance. The defined time interval may be implemented using timer-based scheduling, event-driven mechanisms, and/or hybrid approaches that combine time-based intervals with event-triggered checkpoints. The defined time interval may coordinate with heartbeat intervals and time-to-live intervals to ensure that checkpoint frequency aligns with failure detection and recovery mechanisms.

At end of each defined time interval, the agent session 410, and/or the computing system 101, may store the task state 1018 within a persistent registration record 1016. The registration record 1016, for example, may comprise a data structure that stores recovery data for an agent task 1010. The registration record 1016, for example, may be created when an operation is initiated by a worker instance 1002a-b and persisted to a data repository before the operation proceeds, ensuring that recovery information is available if the worker instance 1002a-b fails while the operation is in progress.

In some examples, the registration record 1016 may comprise one or more operation-specific fields determined by the operation type, with each operation type specifying required recovery fields such as external API operation identifiers for polling completion status of asynchronous external service calls, file paths for locating generated content that may have been produced before failure, checkpoint state for resumable operations that may continue from intermediate progress points, timeout parameters for deadline-aware recovery that respects operation time constraints, and/or the like. In some examples, a registration record 1016 may be created for each agent task 1010 and then removed or marked as completed when associated operations for the agent task 1010 complete successfully, preventing redundant recovery attempts for operations that finished before failure. In this way, the registration record 1016 may enable tasks to recover from failures with minimal loss of progress by preserving the information for continuing or retrieving results from operations that were in progress at failure time.

In some embodiments, the computing system 101 receives a heartbeat signal 1006 from the first worker instance 1002a at a defined heartbeat interval. In response to receiving the heartbeat signal 1006, the computing system 101 may update, based on the heartbeat signal 1006 and the first worker instance 1002a, the relative temporal indicator of the temporal task status 1014 by incrementing the current timestamp by the heartbeat timeout.

A heartbeat signal 1006, for example, may comprise a periodic signal sent by a worker instance 1002a-b to indicate continued operation, transmitted at a configurable heartbeat interval (e.g., 5 seconds, 10 seconds, 1 minute) during task execution. Each heartbeat signal 1006 may extend the relative temporal indicator of an associated temporal task status 1014 within the execution queue 1008 into the future, preventing the agent task 1010 from appearing ready for reassignment, and may extend any associated distributed locks to maintain exclusive access to the agent task 1010. The heartbeat signal 1006 may be implemented as a message transmitted to a coordination service, an update operation on a distributed data store, a keep-alive packet, a write operation that updates a relative temporal indicator, and/or the like.

In some examples, the heartbeat interval may be configured to be substantially shorter than the heartbeat timeout, ensuring that multiple heartbeat signals 1006 may be expected within the timeout window and providing tolerance for occasional signal delays without triggering false failure detection. The heartbeat interval may be implemented using timer-based scheduling, loop-based delays within worker execution threads, event-driven mechanisms that schedule periodic callbacks, and/or the like. The heartbeat timeout may comprise a configurable parameter (e.g., 30 seconds) specifying a maximum duration that may elapse without receiving a heartbeat signal 1006 before the worker instance 1002a-b is considered to have failed. The heartbeat timeout may be configured to be a multiple of the heartbeat interval and may be aligned with the time-to-live interval on distributed locks, coordinating lock release with task reassignment eligibility. The heartbeat timeout may be implemented through timestamp comparison, expiration timers that trigger failure handlers when not reset by incoming heartbeats, polling mechanisms that periodically check heartbeat timestamps against the timeout threshold, and/or the like. Absence of heartbeat signals 1006 beyond the heartbeat timeout enables fault detection without requiring explicit failure notifications from failed workers.

In some embodiments, the computing system 101 detects an execution failure based on at least one of (i) a heartbeat timeout and the temporal task status 1014, (ii) an error message from the first worker instance 1002a, and/or (iii) a user input event 1004. An execution failure, for example, may comprise a worker failure that occurs when a worker instance 1002a-b crashes, loses network connectivity, or otherwise becomes unresponsive during task execution. The execution failure may result from software errors such as unhandled exceptions, segmentation faults, or memory corruption; hardware failures such as processor malfunctions, memory errors, or storage device failures; resource exhaustion such as out-of-memory conditions, disk space depletion, or file descriptor limits; network failures such as connection timeouts, routing failures, or network partition; scheduled maintenance such as system restarts, updates, or infrastructure changes, and/or the like. The execution failure is handled through fault-tolerant mechanisms that enable task resumption from a persisted state within the registration record 1016, where the reassigned worker instance 1002b loads the task state 1018 to continue execution from consistent checkpoints rather than restarting. The execution failure recovery process may invoke recovery handlers for pending operations using registration records 1016, thereby minimizing loss of progress and preventing duplicate resource consumption.

In some examples, the execution failure may be detected based on the heartbeat timeout and the temporal task status 1014 when the current timestamp meets or exceeds the relative temporal indicator, indicating that a heartbeat signal 1006 has not been received for at least a heartbeat timeout.

In some examples, timestamp comparisons used for failure detection may be performed using a monotonic clock source to reduce false detections due to wall-clock adjustments.

As another example, the error message and/or user input event may comprise at least one of a message, a system event, and/or a control signal from the agent session 410a, first worker instance 1002a, and/or a user.

An error message, for example, may comprise a response from the first worker instance 1002a communicating information about an error condition, comprising a human-readable description, an error code, contextual information (e.g., timestamps, session identifiers), and/or diagnostic details. The error message may be implemented as a structured object containing error metadata, an exception object propagated through exception handling frameworks, a response payload returned from API calls with error status codes, a log entry written to logging and audit components, and/or the like. The error message may be persisted within task logs or session state logs to provide audit trails, support post-failure analysis, and enable recovery handlers to determine appropriate error handling during task resumption.

In some examples, a user input event 1004 may comprise an event generated by user interaction with an agent interface, processed based on its type and the context in which it occurs, and categorized as user messages that may interrupt current operations, system events (e.g., child agent completion signals) that provide information without interruption, and/or control signals (e.g., pause, resume, stop) that have defined effects independent of current operations.

In some embodiments, the computing system 101, in response to detecting the execution failure, reassign the agent task 1010 from the execution queue 1008 to a second worker instance 1002b within the multi-worker execution environment. In some examples, in response to reassigning the agent task 1010, the computing system 101 may store another worker identifier 1012, corresponding to the second worker instance 1002b, within the execution queue 1008. In some embodiments, the computing system 101 provides the task state 1018 to the second worker instance 1002b to enable the second worker instance 1002b to build from the progress of the first worker instance 1002a rather than causing a task restart.

FIG. 11 is an operational example 1100 of an agent interface 416 in accordance with some embodiments of the present disclosure. A computing system, such as the computing system 101, may implement the agent interface 416 to provide improved event handling in an agent-based processing system. To do so, the agent interface 416 may leverage a multi-section overlay layer, comprising a transparent control region 1106 and opaque control region 1104, and an event handler to detect user input event 1004 and selectively intercept the user input event 1004 based on a location of the user input event 1004 relative to the sections of the overlay layer. In this regard, the overlay layer may employ an overlay architecture in which a transparent rendering layer may be positioned above the environment content but separate from it, with rendering independence ensuring that overlay updates do not trigger environment reflows or repaints, and event isolation enabling the overlay layer to handle events selectively by allowing some events to pass through to the underlying environment while intercepting others. This architecture addresses the technical problem that agents executing long-running tasks may require real-time intervention when task direction changes are desired. The overlay layer of the agent interface 416 improves computer functionality by providing a mechanism for users to intervene during agent execution through the opaque control region 1104, while the transparent control region 1106 enables continued agent interaction with the underlying execution environment, with the overlay layer detecting user input, gracefully cancelling in-progress operations as needed, preserving state enabling meaningful continuation, and incorporating user direction without disrupting the underlying environment.

In some embodiments, the computing system 101 renders, within the agent interface 416, the overlay layer to the execution environment representation 1102 for the agent session 410. The overlay layer may comprise a plurality of event regions. The plurality of event regions may comprise a transparent control region 1106 and/or an opaque control region 1104. In some examples, the dimensions of the transparent control region 1106 and/or the opaque control region 1104 may be configurable.

An execution environment representation 1102 may comprise a visual and/or data-based depiction of an execution environment in which an agent performs actions, rendered within an agent interface 416 to enable user observation and interaction with agent operations. The execution environment representation 1102, for example, may display the current state of the computing context in which the agent operates, which may comprise web browsers showing web page content, sandboxed code execution containers displaying code and output, desktop applications presenting application interfaces, mobile applications showing mobile interface states, external service interfaces displaying API interactions and responses, and/or the like. In some examples, the execution environment representation 1102 may be implemented using screen capture and/or streaming technologies that capture and/or transmit visual state from the execution environment, embedded browser and/or application views that render environment content directly within the agent interface 416, remote desktop protocols that transmit graphical output from remote execution contexts, DOM serialization and/or rendering that reconstructs web page state for display, and/or the like.

In some examples, the execution environment representation 1102 may be rendered beneath the overlay layer, which maintains rendering independence from the underlying execution environment and implements event isolation that handles events selectively. The overlay layer may be implemented using layered window systems, compositing window managers, HTML/CSS positioned elements with transparency and pointer-events properties, graphics library overlay surfaces, heads-up display rendering in graphics frameworks, and/or the like.

In some examples, rendering independence may be maintained using a double-buffered compositing pipeline in which overlay updates are written to an overlay buffer and then atomically swapped for presentation. In addition, or alternatively, when isolated overlay compositing surfaces are unavailable, the computing system 101 may execute an update-throttled redraw pipeline that confines invalidation regions to overlay bounds while preserving selective event routing semantics.

In some user-interface overlay implementations, overlay interaction may be configured with global pass-through or global interception modes. The disclosed overlay layer partitions interaction into transparent control region 1106 and opaque control region 1104 with selective event routing and rendering independence, preserving continuous agent-environment interaction while supporting targeted user control actions.

In some examples, the opaque control region 1104 may comprise a set of control icons for modifying an action of the agent session. More particularly, the opaque control region 1104 may comprise a portion of an overlay layer that is visually opaque and configured to intercept user input events rather than passing them through to the underlying execution environment. The opaque control region 1104, for example, may comprise a set of control icons and/or user interface elements for modifying agent actions, providing controls for pausing, resuming, and/or terminating agent operations, as well as state indicators that may display agent execution statuses.

By way of example, the control icons may comprise visual representations (e.g., images, symbols, glyphs) communicating functions such as pause, resume, stop, and/or other agent operation modifications. The control icons may be implemented using image assets, vector graphics (e.g., scalable vector graphics (SVG)), icon fonts, programmatically drawn shapes using graphics rendering APIs, and/or the like. The control icons may be interactive elements that respond to user input events (e.g., mouse clicks, touch gestures, keyboard activations), triggering corresponding control instructions when activated. The control icons may comprise visual state indicators reflecting the current state of the associated control function, such as toggled appearance for pause/resume states or disabled appearance when controls are unavailable.

In some examples, the opaque control region 1104 may be implemented using rendering and/or event handling properties that establish both visual opacity and/or event interception behavior, such as CSS pointer-events properties set to capture events, window system opacity attributes combined with hit-test inclusion flags, graphics layer configurations that include regions in input event capture, and/or the like. The opaque control region 1104 may intercept user input events 1004 that occur within its boundaries, processing these events as control instructions that affect agent execution rather than allowing them to propagate to the execution environment representation beneath the overlay layer. In this manner, the opaque control region 1104 may be distinguished from a transparent control region 1106, which allows pointer events to pass through to the underlying execution environment for continued agent interaction.

The transparent control region 1106, for example, may comprise a portion of an overlay layer where the overlay is visually transparent and configured to pass pointer events through to the underlying execution environment. The transparent control region 1106 may enable agents to continue interacting with the execution environment by allowing user input events 1004, such as clicks, movements, and/or other pointer interactions, to propagate through the overlay layer to the execution environment representation 1102 beneath it, rather than being intercepted by the overlay. The transparent control region 1106 may be implemented using rendering and/or event handling properties that establish both visual transparency and event pass-through behavior, such as CSS pointer-events properties set to allow event propagation, window system transparency attributes combined with hit-test exclusion flags, graphics layer configurations that exclude regions from input event capture, and/or the like. The transparent control region 1106 may occupy the portions of the overlay layer that do not contain control interface elements, typically comprising the majority of the overlay surface area to maximize the interactive region available for agent operations within the execution environment.

In some examples, the opaque control region 1104 and/or transparent control region 1106 may be positioned at one or more configurable areas relative to the execution environment representation 1102. For example, the opaque control region 1104 may be, by default, positioned at edges, corners, or designated areas of the overlay layer to minimize obstruction of the execution environment representation 1102 while remaining accessible for user interaction. The transparent control region 1106 may be positioned at portions of the overlay layer that do not contain control interface elements, typically comprising the majority of the overlay surface area to maximize the interactive region available for agent operations within the execution environment. In some examples, the dimensions of the opaque control region 1104 and/or transparent control region 1106 may be reconfigurable to modify the positioning, size, and/or other visual characteristics of the overlay without impacting the underlying execution environment representation 1102.

In some examples, the opaque control region 1104 and/or transparent control region 1106 may comprise one or more state indicators. A state indicator, for example, may comprise a visual element rendered within an opaque control region 1104 and/or transparent control region 1106 of the overlay layer that displays the current execution status of an agent during task processing. The state indicator, for example, may communicate agent operational state to users through graphical representations, such as icons, colors, text labels, progress bars, animated elements, and/or the like, that reflect whether the agent is actively executing, paused, waiting for input, processing a tool invocation, encountering an error, or in other defined states.

In some embodiments, the computing system 101 receives a user input event 1004 to the overlay layer of the execution environment representation 1102 for the agent session 410. The user input event 1004 may be received through one or more input modalities, including keyboard input (e.g., key presses, text entry), mouse input (e.g., clicks, movements, scrolling, drag operations), touch input (e.g., taps, swipes, pinches, multi-touch gestures), voice input (e.g., spoken commands captured through microphones and processed by speech recognition systems), stylus or pen input (e.g., pressure-sensitive drawing on digitizer surfaces), gamepad or controller input, camera input (e.g., gestures captured through computer vision systems), biometric input, and/or the like.

In some embodiments, the computing system 101 determines the event region of the plurality of event regions within the overlay layer corresponding to the user input event 1004. The computing system 101 may route the user input event 1004 based on the event region. For example, in response to a first event region (e.g., transparent control region 1106), the computing system 101 may pass the user input event 1004 through to the execution environment representation 1102 for the agent session. Otherwise, the computing system 101 may intercept the user input event 1004 at the overlay layer.

In some examples, determining the event region may comprise transforming event coordinates from interface space into overlay coordinates, applying a hit-test against boundaries of opaque control region 1104, and classifying the user input event 1004 as pass-through or intercept based on hit-test results. Hit-testing may use rectangular bounds, polygonal masks, z-order metadata, alpha-threshold maps, and/or the like. In some examples, when native per-region input routing is unavailable, selective routing may be emulated by maintaining a region map and forwarding pass-through events to the execution environment representation 1102 through synthesized input propagation while processing intercepted events within the overlay layer.

By way of example, the computing system 101 may optionally update the session state log 426 based on a user input event 1004 received at a transparent control region 1106. In addition, or alternatively, the computing system 101 may generate an intercepted event 1108 based on the user input event 1004 to an opaque control region 1104. In some examples, in response to intercepting the user input event 1004, the computing system 101 (e.g., via the overlay layer) may provide a control instruction 1110 to the agent session 410 based on the intercepted event 1108.

In some examples, an intercepted event 1108 may comprise a user input event 1004 that is captured by the overlay layer within an opaque control region 1104 and processed to execute control functions rather than propagating to the underlying execution environment. The intercepted event 1108 may be implemented through hit-testing algorithms that evaluate event coordinates against region boundaries, event capture phases, and/or event listener configurations.

In some examples, a control instruction 1110 may comprise a command generated in response to the intercepted event 1108, directing modification of agent behavior during execution. The control instruction 1110 may comprise pause instructions, resume instructions, stop or terminate instructions, redirect instructions, step instructions for debugging, and/or the like. The control instruction 1110 may be implemented as a structured data object containing instruction type identifiers and optional parameters, an enumerated command value, a method invocation on an agent control interface, a message published to a control channel subscribed to by agent execution components, and/or the like.

In some examples, the control instruction 1110 may be transmitted from the overlay layer to the orchestration layer or agent session through function calls, message passing, event emission, command queues, and/or the like, enabling real-time user intervention during agent execution without requiring direct manipulation of the underlying execution environment.

In some embodiments, the execution environment representation 1102 may display a domain source representation associated with a first agent-based coordinate system. A domain source representation, for example, may comprise a visual or data-based depiction of a website or other content processed within an agent session, rendered to enable agent perception and interaction with the source material. The domain source representation presents content retrieved from domain data sources in a format that may be processed by agents, including rendered web pages displaying HTML content with styling and layout, document views presenting text, images, structured content from retrieved files, API response displays showing data returned from external service interactions, or database query results presenting tabular or structured data from data repositories.

An agent-based coordinate system may comprise a spatial reference framework used by agents to perceive execution environments and specify actions using coordinates. The agent-based coordinate system may employ absolute pixel coordinates that specify positions as pixel distances from a reference point, such as the top-left corner of a viewport or screen, relative coordinates that specify positions as fractions of viewport dimensions (e.g., 0.5, 0.5 for the center of the viewport), or element references that specify actions by reference to semantic elements rather than numeric coordinates.

In some examples, the agent session 410a may be configured to generate a prompt response based on the domain source representation and the first agent-based coordinate system. In some example, the computing system 101 may determine a second agent-based coordinate system associated with a secondary agent session and modify the prompt response based on the second agent-based coordinate system before providing the prompt response to the secondary agent session.

For example, agent sessions may map between different coordinate representations to transform agent action specifications to environment-appropriate coordinates, accounting for viewport dimensions, scroll offset, scale factors, and element bounding boxes. The coordinate mapping may be implemented through coordinate transformation functions, element lookup services that resolve element references to bounding box coordinates, viewport state tracking that maintains current scroll position, zoom level, and viewport dimensions, and/or the like. The coordinate mapping may enable agents operating with different model architectures to interact with execution environment representations 1102 regardless of the specific coordinate format expected by each.

In some embodiments, the agent interface 416 implements pre-flight query clarification for complex tasks. For example, user queries for complex tasks may be ambiguous, underspecified, or interpretable in multiple ways. Proceeding with resource-intensive operations based on an incorrect interpretation wastes resources and produces unsatisfactory results. The pre-flight query clarification may provide a pre-flight clarification technique that evaluates user queries before initiating expensive operations, determining whether clarification would improve results and gathering additional context when beneficial. To do so, the pre-flight clarification technique may implement a clarification logic that detects ambiguity indicators, where the query admits multiple reasonable interpretations, and different interpretations would lead to substantially different responses, missing critical context indicators, where the query lacks information typically needed for quality responses (time period, geographic scope, expertise level, use case), query breadth indicators, where the query is so broad that focused research quality may degrade without narrowing, conversation state indicators, where for follow-up queries in an established conversation, clarification may be unnecessary—context is already established, and/or the like. In some examples, the clarification logic may be implemented by a language model prompted to analyze query clarity, by rule-based heuristics, or by a combination.

More particularly, the clarification logic may be computed through a multi-factor analysis that produces a query completeness score. The query completeness score may determine whether clarification is warranted before proceeding with task execution. For example, the query completeness score may be based on at least one of an NLP-Based Ambiguity Detection, where the clarification logic may employ natural language processing technique to detect ambiguity in the query, or a Named Entity Resolution Confidence, where the clarification logic may tokenize the query and identify named entities (persons, organizations, products, locations, temporal expressions). For example, for each entity detected via the Named Entity Resolution Confidence techniques, a resolution confidence score may be computed based on (a) uniqueness of the entity reference (e.g., “Apple” may refer to the company or the fruit), (b) presence of disambiguating context, (c) correlation with conversation history, and/or the like. In some examples, the entity resolution confidence may range from 0.0 (completely ambiguous) to 1.0 (unambiguous).

In addition, or alternatively, the query completeness score may be based on at least one of an Semantic Role Labeling, where the clarification logic performs semantic role labeling to identify the action requested, the target of the action, and/or relevant modifiers and missing semantic roles indicate under specification (e.g., “research this topic” lacks specification of output format, depth, and scope), and/or Coreference Resolution, where the clarification logic identifies pronouns and/or anaphoric references (e.g., “it,” “this,” “that”) and attempts to resolve them against the conversation context. Unresolved coreferences contribute to ambiguity.

In some examples, the query completeness score may be based on at least one of a weighted combination of the above scoring function. By way of example, the query completeness score may be generated based on Q=wₑ*E+wₚ*P+wₛ*S+w_{c}*C, where: E=average entity resolution confidence (0.0 to 1.0), P=parameter completeness ratio (0.0 to 1.0), S=semantic role completeness (0.0 to 1.0), C=coreference resolution ratio (0.0 to 1.0) and the default weights may comprise: wₑ=0.25, wₚ=0.35, wₛ=0.25, w_{c}=0.15.

In some examples, the clarification logic evaluates the query completeness score against a task schema, such as a task type classification, where the query is classified into one or more task types (research, analysis, creation, comparison, explanation, etc.) using a trained classifier, schema retrieval, where, for each identified task type, the clarification logic retrieves a parameter schema defining (a) required parameters, (b) optional parameters with defaults, (c) constraints on parameter values, and/or the like, parameter extraction, where the clarification logic extracts parameter values from the query using named entity recognition and slot filling (e.g., a research task schema may require: topic (required), scope (optional, default=comprehensive), time_period (optional, default=all_time), output_format (optional, default=summary)), a completeness computation, where parameter completeness is computed as the ratio of specified required parameters to total required parameters, weighted by parameter importance (e.g., parameters with high variance in interpretation receive higher importance weights).

In some examples, the clarification logic may detect a needed clarification based on a query completeness threshold. By way of example, the clarification logic may define the following thresholds (1) Q>=0.85 (high completeness): Clarification is NOT triggered. The query is sufficiently specified; (2) If Q>=0.70 and Q<0.85 (moderate completeness): Clarification is OPTIONAL. The clarification logic may proceed with caveats or seek brief clarification; (3) If Q>=0.50 and Q<0.70 (low completeness): Clarification is RECOMMENDED. One to two targeted questions may be generated; (4) If Q<0.50 (very low completeness): Clarification is REQUIRED. Multiple clarifying questions may be generated before proceeding.

In some examples, the threshold values may be calibrated based on: (a) task criticality (lower thresholds for exploratory tasks, higher thresholds for consequential operations), (b) user preference (some users prefer to proceed with ambiguity), and (c) historical task success rates correlated with completeness scores.

In some examples, the clarification logic may trigger a question generation when a clarification event is detected. For example, when clarification is warranted, the clarification logic may generate targeted clarifying questions defined by a question count (e.g., a limited number of questions (e.g., maximum three) to avoid excessive user burden), question focus (e.g., questions target specific ambiguities or missing information rather than general exploration), question format (e.g., questions are phrased to elicit concise, actionable answers). In some examples, the questions may be provided within the transparent control region 1106 to elicit answers from the user.

In some examples, when the user provides answers to clarifying questions, the original query is enriched through structured inclusion (e.g., clarifications are included in a structured format that the agent may parse and utilize, context integration (e.g., the enriched query provides sufficient context for the agent to proceed without further clarification, transparency (e.g., the enriched query preserves the original query text, making the enrichment visible rather than silently modifying the user's request.

In some examples, a query clarification is bypassed in certain circumstances, such as follow-up queries (e.g., when conversation history exists, context is typically established-clarification is not needed), pre-clarified queries (e.g., when clarifications have already been gathered for this query, additional clarification is not sought, explicit user requests (e.g., users may request to proceed without clarification), clear queries (e.g., when analysis determines the query is sufficiently clear, clarification is skipped), and/or the like.

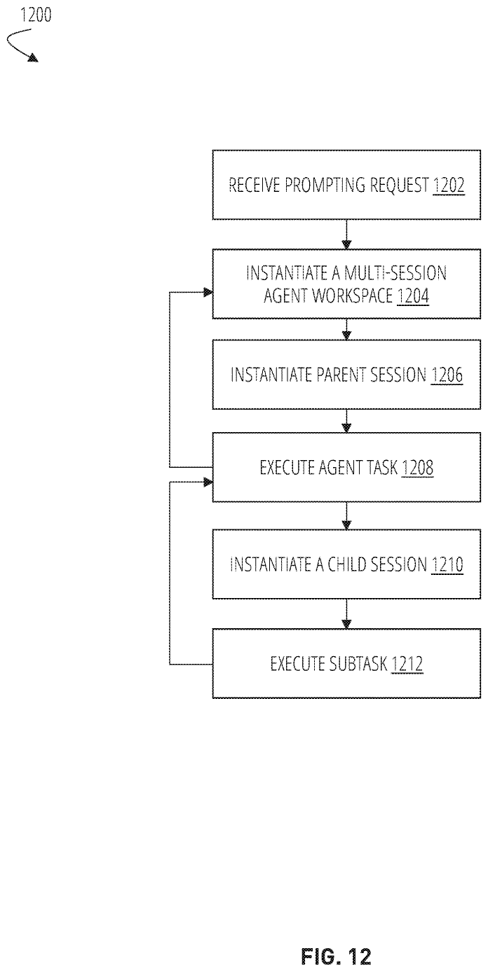

FIG. 12 is a flowchart diagram of an example multi-session orchestration process 1200 in accordance with some embodiments of the present disclosure. The flowchart diagram depicts a hierarchical multi-agent session orchestration technique for hierarchically structuring agent sessions to improve prompt resolution speed, accuracy, and fault tolerance. The process 1200 may be implemented by one or more computing devices, entities, and/or systems described herein. For example, via the various steps/operations of the process 1200, the computing system 101 may iteratively resolve a prompting request through the instantiation of and later execution of tasks within a plurality of agent sessions organized in accordance with a hierarchical session structure. By doing so, the process 1200 may improve computer functionality by improving the processing speed and resource utilization efficiency of digital agents executed within a computing environment.

FIG. 12 illustrates an example process 1200 for explanatory purposes. Although the example process 1200 depicts a particular sequence of steps/operations, the sequence may be altered without departing from the scope of the present disclosure. For example, some of the steps/operations depicted may be performed in parallel or in a different sequence that does not materially impact the function of the process 1200. In other examples, different components of an example device or system that implements the process 1200 may perform functions at substantially the same time or in a specific sequence.

In some embodiments, the process 1200 comprises, at operation 1202, receiving a prompting request. For example, the computing system 101 may receive a prompting request.

In some embodiments, the process 1200 comprises, at operation 1204, instantiating a multi-session agent workspace. For example, the computing system 101 may instantiate the multi-session agent workspace. The multi-session agent workspace may comprise a shared workspace repository and/or a plurality of agent sessions configured in accordance with a hierarchical session structure.

In some examples, the hierarchical session structure may comprise a unidirectional acyclic graph that defines a set of session nodes and a set of directed edges. In some examples, a first session node of the set of session nodes may correspond to a parent session. In some examples, a second session node of the set of session nodes corresponds to a child session. The first session node may be connected to the second session node by a directed edge of the set of directed edges to establish a parent-child relationship between the parent session and the child session.

In some examples, the hierarchical session structure defines a parent limit for the second session node that constrains a number of parent session nodes connected to the second session node to one.

In some examples, the first session node comprises one or more of (i) a first session identifier corresponding to the parent session, (ii) a second session identifier corresponding to the child session, (iii) a third session identifier corresponding to a root session of the multi-session agent workspace, (iv) a session state log, (v) a session metadata log, (vi) a task log, (vii) a creation timestamp, or (viii) an activity timestamp, and/or the like.

In some embodiments, the process 1200 comprises, at operation 1206, instantiating a parent session. For example, the computing system 101 may instantiate the parent session. The parent session may store parent context data for executing an agent task within the parent session. In some examples, the parent session may correspond to a first session identifier, the child session may correspond to a second session identifier, and at least a segment of the second session identifier comprises the first session identifier to represent a parent-child relationship between the parent session and the child session.

In some embodiments, the process 1200 comprises, at operation 1208, execute an agent task within the parent session. Upon completion of the agent task, the parent session may return an output to the multi-session agent workspace. In addition, or alternatively, to complete the agent task, the parent session may instantiate a child session at operation 1210.

For example, the computing system 101 may execute the agent task within the parent session. The agent task, for example, is executed within the parent session based on at least the portion of the parent context data and/or the shared workspace repository.

In some embodiments, the process 1200 comprises, at operation 1210, instantiate a child session. For example, the computing system 101 may instantiate a child session. The child session may store child context data separate from the parent session and for executing an agent subtask within the child session. In some examples, the parent session propagates at least a portion of the parent context data of the parent session to the child session upon creation of the child session.

In some examples, at least a portion of the parent context data of a parent session may be propagated to a child session upon creation of the child session. For example, a parent session may instantiate the child session by providing a session instantiation request. For instance, the computing system 101 may receive a session instantiation request within the parent session that defines a subtask-specific context for the child session. The computing system 101 may generate a session container based on the session instantiation request and propagate, based on the subtask-specific context, at least a portion of a session metadata log associated with the parent session to the session container to generate the child session, where the propagated portion may exclude plaintext credential material and include encrypted credential references and/or delegated authorization artifacts scoped to the child subtask.

In some examples, the session instantiation request may define at least one execution mode for the child session from a synchronous delegation execution mode configured to interrupt the parent session until a response is received from the child session, or an asynchronous background mode configured to independently execute the child session with respect to the parent session. In some examples, during an asynchronous background mode, the parent session and the child session may execute in parallel to increase a resolution speed of the agent task.

In some examples, the session instantiation request may comprise a tool restriction configuration that defines a subset of a set of tools within the multi-session agent workspace 500 available for use by the child session.

In some embodiments, the process 1200 comprises, at operation 1212, execute an agent subtask within the child session. Upon completion of the agent subtask, the child session may return an output to the parent session.

For example, the computing system 101 may execute the agent subtask within the child session. The agent subtask, for example, may be executed within the child session based on at least the portion of the child context data and/or the shared workspace repository.

In some examples, the computing system 101 may detect a context exception for a generative model associated with the child session based on a token count of at least the portion of the child context data and/or the shared workspace repository and an exception threshold associated with a context window of the generative model. The computing system 101 may, in response to detecting the context exception, generate, using a two-stage compression routine, a compressed representation of at least the portion of the child context data and the shared workspace repository.

By way of example, at a first stage of the two-stage compression routine, the computing system 101 may receive a large artifact within at least the portion of the child context data or the shared workspace repository based on a size threshold. The computing system 101 may store the large artifact at a first memory location within a data repository. The computing system 101 may replace the large artifact within at least the portion of the child context data or the shared workspace repository with a location identifier corresponding to the first memory location and an artifact summary of the large artifact,

In addition, or alternatively, at a second stage of the two-stage compression routine, the computing system 101 may receive a session state log from at least the portion of the child context data. The computing system 101 may store the session state log at a second memory location within the data repository. The computing system 101 may extract, based on a text-based extraction ruleset, a set of preserved content tokens within the session state log. The computing system 101 may generate, using the generative model, a state summary of the session state log based on the session state log and the set of preserved content tokens. The computing system 101 may replace the session state log with the state summary.

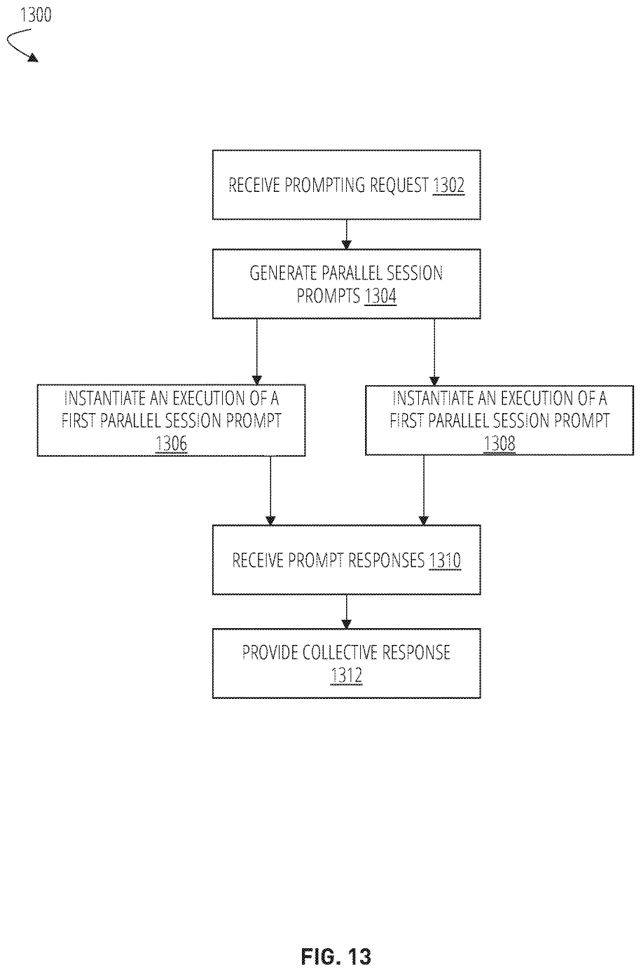

FIG. 13 is a flowchart diagram of an example parallel multi-session orchestration process 1300 in accordance with some embodiments of the present disclosure. The flowchart diagram depicts a parallel multi-agent session orchestration technique for synchronizing parallel prompts across multiple, isolated agent sessions to improve prompt resolution speed, accuracy, and fault tolerance. The process 1300 may be implemented by one or more computing devices, entities, and/or systems described herein. For example, via the various steps/operations of the process 1300, the computing system 101 may resolve a prompting request by synchronizing responses from a plurality of agent sessions executed in parallel. By doing so, the process 1300 may improve computer functionality by improving the processing speed and resource utilization efficiency of digital agents executed within a computing environment.

FIG. 13 illustrates an example process 1300 for explanatory purposes. Although the example process 1300 depicts a particular sequence of steps/operations, the sequence may be altered without departing from the scope of the present disclosure. For example, some of the steps/operations depicted may be performed in parallel or in a different sequence that does not materially impact the function of the process 1300. In other examples, different components of an example device or system that implements the process 1300 may perform functions at substantially the same time or in a specific sequence.

In some embodiments, the process 1300 comprises, at operation 1302, receiving a prompting request. For example, the computing system 101 may receive a prompting request.

In some embodiments, the process 1300 comprises, at operation 1304, generating a plurality of parallel session prompts. For example, the computing system 101 may generate a set of parallel session prompts from the prompting request. A parallel session prompt of the set of parallel session prompts may comprise at least a portion of the prompting request and identify a machine learning agent and/or a generative model.

In some examples, the first parallel session prompt may comprise a first tool restriction configuration that defines a first subset of a set of tools available within the first agent session, and/or the second parallel session prompt may comprise a second tool restriction configuration that defines a second subset of the set of tools available within the second agent session.

For example, a tool of the set of tools may comprise a retrieval tool configured to retrieve or submit information within a restricted environment. In addition, or alternatively, a tool of the set of tools may comprise a messaging tool configured to transfer a message between the first agent session and the second agent session. In some examples, a tool of the set of tools may comprise a hierarchical session instantiation tool configured to instantiate a hierarchical session for the first agent session or the second agent session.

In some embodiments, the process 1300 comprises, at operation 1306, instantiating an execution of a first parallel session prompt. For example, the computing system 101 may initiate a first execution of a first parallel session prompt of the set of parallel session prompts within a first agent session. In some examples, the first agent session may be instantiated based on a first agent configuration that defines an isolated workspace, an access credential to at least one of a set of tools, a model identifier for the generative model, and/or a prompting strategy for the generative model.

In some embodiments, the process 1300 comprises, at operation 1308, instantiating the execution of a second parallel session prompt. For example, the computing system 101 may initiate a second execution (e.g., with respect to the first execution of the first agent session) of a second parallel session prompt of the set of parallel session prompts within a second agent session. In some examples, the second agent session may be instantiated based on a second agent configuration different from the first agent configuration.

In some embodiments, the process 1300 comprises, at operation 1310, receiving prompt responses. For example, the computing system 101 may receive, from the first agent session, a first prompt response comprising a first session identifier corresponding to the first agent session, a first prompt segment, and/or a first source list associated with the first prompt segment. In addition, or alternatively, the computing system 101 may receive, from the second agent session, a second prompt response comprising a second session identifier corresponding to the second agent session, a second prompt segment, and a second source list associated with the second prompt segment.

In some embodiments, the process 1300 comprises, at operation 1312, providing a collective response. For example, the computing system 101 may provide a collective response to the prompting request by aggregating at least one of the first prompt segment or the second prompt segment based on at least one of the first source list or the second source list.

In some examples, the computing system 101 may receive a task status update comprising at least one of a first status update from the first agent session or a second status update from the second agent session. The computing system 101 may detect a synchronization trigger based on the task status update. For example, the computing system 101 may detect that the first status update and/or the second status update identify a synthesis state and/or detect an expiration of a response timer associated with the prompting request. In some examples, in response to detecting the synchronization trigger, the computing system 101 may generate the collective response based on at least one of the first prompt response or the second prompt response.

In some examples, the computing system 101 may generate, using an evidence quality scoring model, a first quality score for the first prompt response based on the first source list. The evidence quality scoring model, for example, may generate the first quality score based on a weighted aggregation of at least one of a source authority metric, a recency metric, a methodological metric, or a source diversity metric associated with the first prompt response. The computing system 101 may generate, using the evidence quality scoring model, a second quality score for the second prompt response based on the second source list. The computing system 101 may generate a collective response based on the first quality score, the second quality score, and at least one of a deviation threshold and/or a conflict resolution ruleset.

In some embodiments, the first prompt response comprises a set of response segments and a response segment of the set of response segments comprises an index reference to a source within the first source list. The computing system 101 may generate a composite source index for the collective response based on the first source list and the second source list. The composite source index, for example, may comprise the first source list and/or the second source list segmented by the first session identifier and/or the second session identifier. The computing system 101 may generate a composite source reference for the response segment based on the index reference and the first session identifier corresponding to the first agent session. The computing system 101 may insert the response segment with the composite source reference within the collective response.

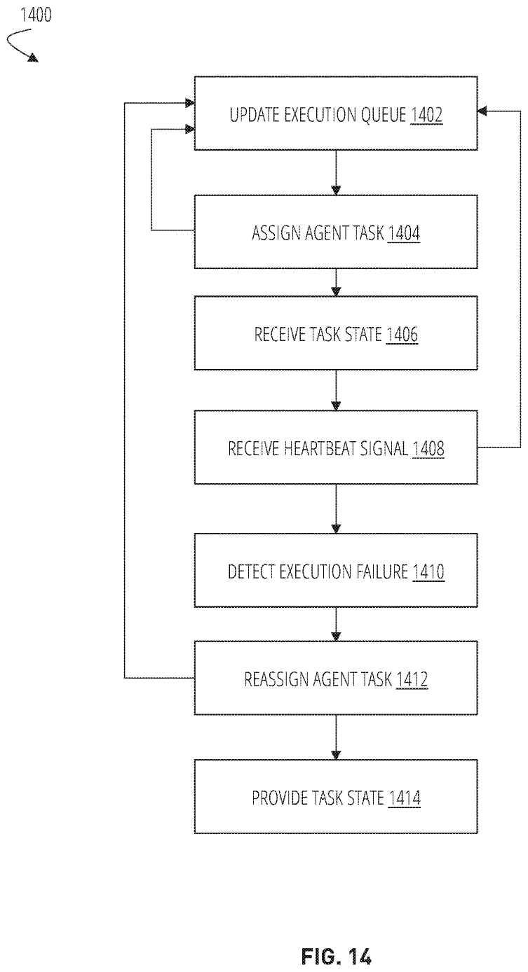

FIG. 14 is a flowchart diagram of another example multi-agent fault recovery process 1400 in accordance with some embodiments of the present disclosure. The flowchart diagram depicts a fault recovery technique for handling processing failures within a multi-agent environment. The process 1400 may be implemented by one or more computing devices, entities, and/or systems described herein. For example, via the various steps/operations of the process 1400, the computing system 101 may leverage an execution queue to systematically route and divert agent tasks across different worker instances based on a temporally managed state associated with the agent tasks. By doing so, the process 1400 may improve computer functionality by increasing the detection and recovery speeds from agent failures within a distributed computing ecosystem.

FIG. 14 illustrates an example process 1400 for explanatory purposes. Although the example process 1400 depicts a particular sequence of steps/operations, the sequence may be altered without departing from the scope of the present disclosure. For example, some of the steps/operations depicted may be performed in parallel or in a different sequence that does not materially impact the function of the process 1400. In other examples, different components of an example device or system that implements the process 1400 may perform functions at substantially the same time or in a specific sequence.

In some embodiments, the process 1400 comprises, at operation 1402, updating an execution queue. For example, the computing system 101 may update an execution queue to modify a relative temporal indicator for one or more agent tasks within the execution queue.

The execution queue, for example, may comprise a priority queue (and/or other data structure) comprising a set of agent task and temporal task statuses. In some examples, up to each temporal task status may comprise a relative temporal indicator corresponding to one of a set of defined operational states. The set of defined operational states, for example, may comprise a ready state, a sleeping state, and/or a running state. In some examples, the relative temporal indicator of the temporal task status may comprise a current timestamp and/or a preceding timestamp preceding the current timestamp for a ready state. In addition, or alternatively, the relative temporal indicator of the temporal task status may comprise a subsequent timestamp subsequent to the current timestamp for a sleeping state. In some examples, the relative temporal indicator of the temporal task status may comprise a heartbeat offset timestamp that is subsequent to the current timestamp by a heartbeat timeout for a running state.

In some examples, an agent task may be positioned within the execution queue based on the relative temporal indicator of the temporal task status.

In some embodiments, the process 1400 comprises, at operation 1404, assigning an agent task. For example, the computing system 101 may assign an agent task from an execution queue to a first worker instance within a multi-worker execution environment based on a temporal task status. In some examples, in response to assigning the agent task, the process 1400 may return to operation 1402 to update the execution queue.

In some examples, upon assigning the agent task to the first worker instance, the computing system 101 may store a worker identifier of the first worker instance within the execution queue in association with the agent task. In some examples, the worker identifier may be associated with a time-to-live interval. The computing system 101 may remove the worker identifier from the execution queue in response to detecting an expiration of the time-to-live interval. In addition, or alternatively, the computing system 101 may replace the worker identifier within the execution queue with a refreshed worker identifier in response to receiving a heartbeat signal from the first worker instance. The refreshed worker identifier may comprise a refreshed time-to-live interval.

In some embodiments, the process 1400 comprises, at operation 1406, receiving a task state. For example, the computing system 101 may receive, at a defined time interval, a task state associated with the agent task from the first worker instance. In some examples, the task state may comprise at least one of a task log, a session metadata log, a session state log, a task status indicator, and/or the like. In some examples, the computing system 101 may store the task state within a registration record corresponding to the agent task.

In some embodiments, the process 1400 comprises, at operation 1408, receiving a heartbeat signal. For example, the computing system 101 may receive the heartbeat signal from the first worker instance. In response to receiving the heartbeat signal, the process may return to operation 1402, where the computing system 101 may update, based on the heartbeat signal and the first worker instance, the relative temporal indicator of the temporal task status by incrementing the current timestamp by the heartbeat timeout.

In some embodiments, the process 1400 comprises, at operation 1410, detecting an execution failure. For example, the computing system 101 may detect an execution failure based on at least one of (i) a heartbeat timeout and the temporal task status, (ii) an error message from the worker instance, or (iii) a user input event. For example, the execution failure is detected based on the heartbeat timeout and the temporal task status based on the current timestamp meeting or exceeding the relative temporal indicator. As another example, the user input event may comprise at least one of a user message, a system event, or a control signal.

In some embodiments, the process 1400 comprises, at operation 1412, reassigning an agent task. For example, the computing system 101 may, in response to detecting the execution failure, reassign the agent task from the execution queue to a second worker instance within the multi-worker execution environment. In some examples, in response to reassigning the agent task, the process 1400 may return to operation 1402 to update the execution queue.

In some embodiments, the process 1400 comprises, at operation 1414, providing the task state for the agent task. For example, the computing system 101 may provide the task state to the second worker instance.

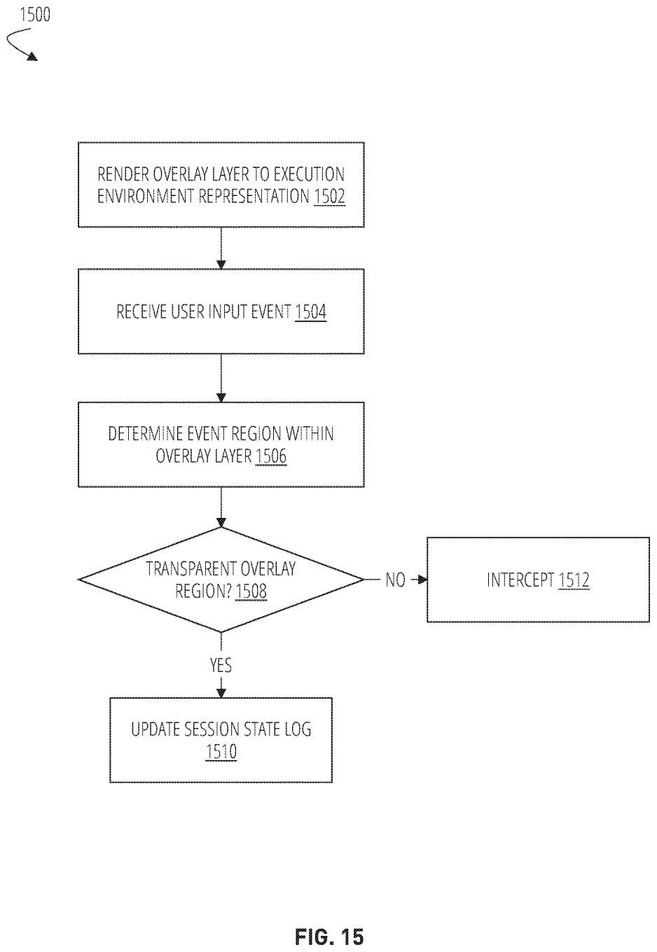

FIG. 15 is a flowchart diagram of an example interaction process 1500 in accordance with some embodiments of the present disclosure. The flowchart diagram depicts an interface event handling technique for dynamically managing input to an agent session. The process 1500 may be implemented by one or more computing devices, entities, and/or systems described herein. For example, via the various steps/operations of the process 1500, the computing system 101 may render an overlay to an execution environment representing an agent session, detect input to different regions of the overlay, and dynamically route input based on the relative position at which the input is detected. By doing so, the process 1500 may facilitate the use of overlays with an agent session to provide a more intuitive interface for providing agent feedback while avoiding agent processing interruptions.

FIG. 15 illustrates an example process 1500 for explanatory purposes. Although the example process 1500 depicts a particular sequence of steps/operations, the sequence may be altered without departing from the scope of the present disclosure. For example, some of the steps/operations depicted may be performed in parallel or in a different sequence that does not materially impact the function of the process 1500. In other examples, different components of an example device or system that implements the process 1500 may perform functions at substantially the same time or in a specific sequence.

In some embodiments, the process 1500 comprises, at operation 1502, rendering an overlay layer to an execution environment representation. For example, the computing system 101 may render, within an agent interface, the overlay layer to the execution environment representation for an agent session.

The overlay layer may comprise a plurality of event regions. The plurality of event regions may comprise a transparent control region and/or an opaque control region. In some examples, the opaque control region may comprise a set of control icons for modifying an action of the agent session. In some examples, the dimensions of the transparent control region and/or the opaque control region may be configurable.

In some embodiments, the process 1500 comprises, at operation 1504, receiving a user input event. For example, the computing system 101 may receive a user input event to the overlay layer of the execution environment representation for the agent session.

In some embodiments, the process 1500 comprises, at operation 1506, determining an event region within the overlay layer. For example, the computing system 101 may determine the event region of the plurality of event regions within the overlay layer corresponding to the user input event.

In some embodiments, the process 1500 comprises, at operation 1508, routing the user input event. For example, the computing system 101 may route the user input event based on the event region. For example, in response to a first event region (e.g., transparent control region), the process 1500 may proceed to operation 1510, where the user input event may be passed through to an execution environment representation associated with the agent session based on the first event region (e.g., transparent control region) of the plurality of event regions. Otherwise, the process 1500 may proceed to operation 1512, where the user input event may be intercepted at the overlay layer based on a second event region of the plurality of event regions. By way of example, the first event region may comprise the transparent control region, and/or the second event region may comprise the opaque control region.

In some embodiments, the process 1500 comprises, at operation 1510, updating a session state log. For example, the computing system 101 may optionally update the session state log based on the user input event.

In some embodiments, the process 1500 comprises, at operation 1512, intercepting the user input event. For example, the computing system 101 may intercept the user input event before it reaches the agent session. In some examples, in response to intercepting the user input event, the computing system 101 (e.g., via the overlay layer) may provide a control instruction to the agent session based on the user input event.

In some examples, the execution environment representation may display a domain source representation associated with a first agent-based coordinate system. In some examples, the agent session may be configured to generate a prompt response based on the domain source representation and the first agent-based coordinate system, determine a second agent-based coordinate system associated with a secondary agent session, and/or modify the prompt response based on the second agent-based coordinate system.

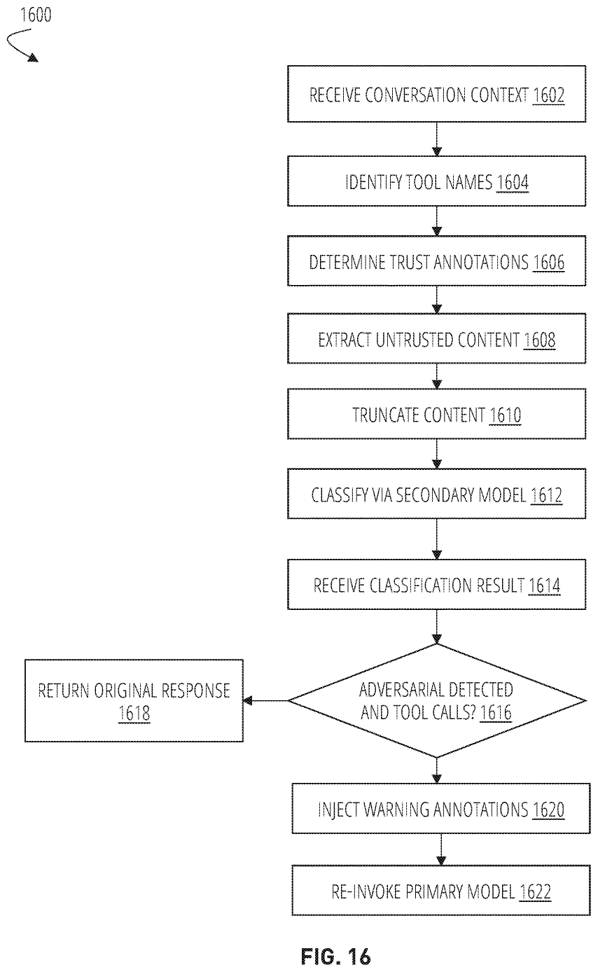

Various additional and/or complementary embodiments of the present disclosure will now be discussed with reference to the below sections A-H and FIGS. 16-20. The methods and systems of the below sections A-H and FIGS. 16-20 may be implemented with any of the foregoing embodiments of the present disclosure, or separately from the foregoing embodiments of the present disclosure.

### A. Connector-Gated External Action Orchestration, Cross-Task Memory Continuity, and Scheduled Task Reliability

In some embodiments, the computing system 101 may implement a staged external action orchestration flow for interactions with external services. For example, the computing system 101 may provide a first tool discovery operation that enumerates external tools available to a session and, for each tool, provides at least a tool name and a source identifier. In some examples, the first tool discovery operation may return summarized tool metadata suitable for broad retrieval while omitting full argument schemas from the initial listing.

In some embodiments, after selecting one or more external tools from the first tool discovery operation, the computing system 101 may execute a schema-description operation that retrieves full input schemas for the selected tools. In some examples, the schema-description operation may receive a mapping from source identifiers to selected tool names and may return argument-level schema data for each selected tool. The computing system 101 may store, in session state, a described-tool authorization record for each described tool, such as a tuple comprising ‘(source_identifier, tool_name)’.

In some embodiments, a subsequent external execution operation may be gated by the described-tool authorization record. For example, prior to executing a selected external tool, the computing system 101 may verify that a matching described-tool authorization record is present in the session state and, in response to determining that no matching record is present, reject execution and return a remediation instruction to perform the schema-description operation first. In some examples, a connection establishment tool may be exempted from the schema-gating requirement to allow authentication bootstrapping while preserving schema-gating for non-connection external actions.

In some embodiments, when an external tool execution indicates that authorization is required, the computing system 101 may generate a structured authorization workflow artifact for presentation in an agent interface. For example, the structured authorization workflow artifact may comprise a provider-specific title, description, display name, image, source identifier, and a connect call-to-action hyperlink that routes a user to an authorization flow. In some examples, the authorization workflow artifact may be generated as a workflow entity object and presented inline in the execution timeline of the corresponding session.

In some embodiments, external tool calls may support multiple authentication modes. For example, a first mode may use user-session authentication data associated with a user session, and a second mode may use a service credential mode for service-side access when user-session credentials are not present or when system-level authenticated access is authorized.

In some embodiments, the computing system 101 may apply adaptive output handling for external tool results based on output size. For example, in response to determining that a returned result exceeds a threshold, the computing system 101 may persist the full result payload in storage and provide a compact presentation payload comprising (i) a preview of at least a portion of the result, (ii) a structure summary, and/or (iii) an inferred compact output schema for downstream programmatic operations. Such output compaction may preserve machine-usable structure while reducing prompt context consumption.

In some embodiments, the external action orchestration flow may be combined with a user confirmation gating flow for high-impact operations. For example, prior to execution of destructive or high-blast-radius external actions (e.g., send, post, purchase, or delete operations), the computing system 101 may require a confirmation operation that presents an action label, confirmation question, and draft content placeholder to a user and may defer execution until receiving an approval response.

In some embodiments, the computing system 101 may apply threshold-based confirmation gating to high-volume batch operations. For example, when a batch research operation exceeds an entity-count threshold, the computing system 101 may require explicit user approval before dispatching the batch operation.

In some embodiments, the computing system 101 may implement cross-task memory continuity using persistent conversation identifiers. For example, the computing system 101 may include, in a memory retrieval request context, a conversation entry identifier and a conversation context identifier and may perform memory retrieval conditioned on one or both of the identifiers.

In some embodiments, memory retrieval may return query-answer artifacts that include context linkage fields and neighborhood context. For example, each retrieved artifact may include one or more of: a primary entry identifier, a context identifier, a query string, an answer string, a timestamp, one or more prior context entries, and one or more following context entries. In some examples, prior context entries and following context entries may include respective entry identifiers to preserve traceable conversational provenance.

In some embodiments, the computing system 101 may construct canonical resource locators for retrieved conversation artifacts using retrieved entry identifiers and may attach such resource locators as citation-ready links in workflow output.

In some embodiments, the computing system 101 may perform post-retrieval conversation slice reconstruction. For example, the computing system 101 may group retrieved query-answer artifacts by context identifier, collect messages from prior context, primary entries, and following context, and deduplicate messages based on entry identifier. In some examples, the deduplicated messages may be ordered by timestamp and packaged as conversation slices for use as citable memory evidence in generated responses.

In some embodiments, the computing system 101 may map reconstructed conversation slices to citation identifiers and may insert such citation identifiers into generated response segments to preserve traceability between generated content and historical conversation evidence.

In some embodiments, cross-task memory continuity may be preserved across parent sessions, child sessions, and scheduled background sessions by threading one or more continuity identifiers through session metadata, follow-up payloads, and/or scheduled trigger payloads.

In some embodiments, the computing system 101 may implement reliability controls for scheduled task execution in a temporal execution queue. For example, for each scheduled trigger, the computing system 101 may compute a trigger timestamp by applying randomized jitter to a nominal next-run time, thereby reducing burst load concentration across workers.

In some embodiments, the computing system 101 may support idempotent scheduled trigger creation. For example, a scheduled trigger insertion operation may include a create-if-not-exists condition to avoid duplicate trigger insertion for equivalent session and schedule identifiers.

In some embodiments, the computing system 101 may claim ready scheduled triggers using a lease-based atomic claim operation. For example, the computing system 101 may execute an atomic script that identifies triggers with score values less than or equal to a current timestamp and, for each claimed trigger, moves the corresponding score forward by a lease interval rather than removing the trigger from the queue. The lease-based approach may reduce duplicate processing and may allow automatic re-surfacing of unprocessed triggers after worker interruption.

In some embodiments, the computing system 101 may implement near-instant task cancellation propagation using a dual-path cancellation mechanism. For example, the computing system 101 may set a cancellation key with time-to-live semantics for a target task and may also publish a cancellation signal over a broadcast channel. Worker-side cancellation subscribers may multiplex cancellation events for multiple tasks and may set task-specific cancellation flags to interrupt active operations.

In some embodiments, in response to receiving a cancellation request for a session, the computing system 101 may perform session-scoped cancellation of future scheduled triggers associated with the session. For example, the computing system 101 may identify scheduled trigger keys matching a session identifier pattern and remove the matching triggers from a scheduled trigger queue.

In some embodiments, the computing system 101 may implement credit-aware queue parking and reactivation. For example, in response to a credit exhaustion condition for a non-cron task, the computing system 101 may atomically remove the task from an active queue and store the task in a credits-blocked set associated with a user identifier. In response to a credit restoration event, the computing system 101 may move one or more tasks from the credits-blocked set back to the active queue.

In some embodiments, when a scheduled cron-triggered operation detects a credit exhaustion condition, the computing system 101 may skip the current run and schedule a subsequent run according to the cron expression, such that the schedule remains active while avoiding execution during credit insufficiency.

In some embodiments, the computing system 101 may encode trigger semantics using typed trigger metadata values, such as a wake trigger type and a cron trigger type, and may propagate trigger type metadata through backend payload conversion and streaming state to preserve lifecycle semantics across asynchronous execution boundaries.

In some embodiments, background scheduled child sessions may include a terminal escalation operation. For example, a background child session may invoke a wake-parent operation that terminates child execution, records an escalation message, and generates an escalation-tagged follow-up payload for a parent session. In some examples, the escalation-tagged follow-up payload may include a flag indicating escalated status and may cause parent wake-up even when a default non-wake routing mode is configured.

In some embodiments, the parent session may receive the escalation-tagged follow-up payload and may inject escalation content into parent session context for subsequent parent processing, thereby enabling explicit background-to-parent exception routing in asynchronous multi-session orchestration.

In some embodiments, lifecycle cleanup of asynchronous sessions may include coordinated cancellation and state deletion across services. For example, in response to a thread deletion operation, the computing system 101 may transmit a cancellation request to an asynchronous task service using a context identifier and may clear accumulated message state, converter state, and temporary follow-up sequencing state from one or more storage systems.

In some embodiments, one or more of the staged connector orchestration, cross-task memory continuity, scheduler reliability controls, terminal background escalation, confirmation gating, typed trigger semantics, and lifecycle cleanup operations may be implemented independently or in any combination, and may be applied to one or more parent sessions, child sessions, and/or background scheduled sessions.

### B. State Models, Process Variants, and Cross-Service Propagation

In some embodiments, the computing system 101 may maintain an execution state model that includes one or more of: session identifiers, parent and root session identifiers, execution status values, pending retry data, tool state, scheduled task state, metadata fields, and citation state. For example, the execution state model may store one or more of: a set of described tool tuples, a map of cron records keyed by cron identifier, a map of subagent records keyed by subagent identifier, a map of pending operations keyed by operation identifier.

In some embodiments, a described tool tuple may comprise at least a source identifier and a tool name, and may additionally include one or more of: a description timestamp, schema hash, schema version, schema source, or authorization scope. In some examples, validating a later external action call may include checking one or more of tuple presence, schema version compatibility, or scope compatibility.

In some embodiments, a connector authorization workflow artifact may include one or more of: provider title, provider description, provider display name, provider image locator, source identifier, action classification, and one or more call-to-action links. In some examples, the call-to-action links may include one or more of connect, retry, refresh, or re-consent actions.

In some embodiments, the computing system 101 may maintain request context metadata for each operation. For example, request context metadata may include one or more of: a subject identifier, tenancy identifier, localization indicator, workflow-entry identifier, context identifier, trigger classification, source-channel classification, and mode identifier. In some examples, direct personal identifiers and raw session-authentication values may be excluded from routine cross-service propagation and replaced with ephemeral handles, one-way derived identifiers, and/or service-local references. In some examples, such request context metadata may be passed between a session service, a connector service, a memory service, and a webhook handler.

In some embodiments, the computing system 101 may maintain a follow-up payload model for asynchronous parent-child coordination. For example, a follow-up payload model may include one or more of: follow-up type, subagent identifier, task name, subagent status, escalation flag, source string, enqueued timestamp, a subject-context reference, and one or more result or error fields.

In some embodiments, the computing system 101 may maintain a scheduled trigger model including one or more of: a subject reference identifier, a session reference identifier, a cron identifier, a cron expression, a next-run timestamp, a jittered score value, a run count, a background execution flag, and a subagent-type indicator. In some examples, the subject reference identifier and session reference identifier may be tokenized and/or pseudonymous values.

In some embodiments, the computing system 101 may maintain a queue score model in which each queue entry has a numeric score representing a temporal indicator. For example, score values may represent one or more of: ready state, sleeping state, running state, or leased state. In some examples, queue processing logic may compare the score to a current timestamp to determine readiness.

In some embodiments, the computing system 101 may maintain a cancellation model in which cancellation status is represented by both a persisted key and a low-latency channel signal. For example, the persisted key may allow late-joining workers to observe cancellation state while the low-latency channel signal may allow active workers to interrupt operations with lower latency.

In some embodiments, the computing system 101 may maintain a credits state model in which active tasks are parked in user-scoped blocked sets during insufficient-credit intervals. In some examples, unblocking may reinsert tasks into active execution queues using original or updated temporal scores.

In some embodiments, the computing system 101 may maintain a memory artifact model in which each query-answer artifact includes one or more of: entry identifier, context identifier, query text, answer text, date, timestamp, prior-context entries, following-context entries, and canonical resource locator fields.

In some embodiments, the computing system 101 may maintain a conversation slice model where slices are grouped by context identifier and each slice contains deduplicated message elements derived from primary entries and surrounding entries. In some examples, deduplication may be based on entry identifier and ordering may be based on timestamp.

In some embodiments, the computing system 101 may maintain streaming metadata for asynchronous operation rendering. For example, streaming metadata may include one or more of: status identifiers, parent status identifiers, sequence indices, workflow snapshot identifiers, and trigger type fields.

In some embodiments, a typed trigger model may encode one or more trigger types, such as wake trigger types and cron trigger types. In some examples, typed trigger values may be persisted in message payloads and context metadata to preserve semantic distinction between scheduled invocations and user- or event-driven wake invocations.

In some embodiments, the computing system 101 may apply state hygiene operations that clear or reset selected state fields during lifecycle events. For example, a context compaction event may clear described-tool tuples, and a finalization event may clear temporary converter state, message accumulation state, and sequence counters for a task.

In some embodiments, the computing system 101 may implement process variants for connector-gated orchestration. For example, a first process variant may include: receiving a request to perform an external action; retrieving a set of candidate external tools from a tool discovery service based on one or more queries; selecting at least one candidate external tool and retrieving a full input schema for the selected candidate external tool; storing a described-tool authorization record for the selected candidate external tool in session state; receiving an external execution call for the selected candidate external tool; validating that a matching described-tool authorization record exists and, in response to validation failure, returning a remediation instruction instead of executing the selected candidate external tool; executing the selected candidate external tool when validation succeeds; and if authorization is required, generating a structured authorization workflow artifact including a connect call-to-action.

In some embodiments, the process variant may further include: receiving a post-authorization follow-up event; and resuming execution of the selected candidate external tool using updated authorization data.

In some embodiments, the described-tool authorization validation may have expected constant-time lookup complexity where described-tool authorization records are represented as hash set entries. In other embodiments, the described-tool authorization validation may be implemented via indexed map structures, bloom-filter fronting plus full-key verification, relational key lookup, or append-only log with compaction. In some embodiments, after tool execution, the computing system 101 may store execution metrics including output-size metrics and status metrics.

In some embodiments, the computing system 101 may implement connector output compaction by: estimating a token count or byte size for a connector result payload; comparing the count or size to a threshold (e.g., between 2,000 and 20,000 tokens, and/or between 32 KB and 2 MB); when the threshold is exceeded, storing the full payload in persisted storage and generating a compact response containing an output locator and a preview payload; inferring a compact output schema from structured content of the payload; and conditionally including the compact output schema when the inferred schema size is below a schema-size threshold (e.g., between 200 and 2,000 tokens). In some examples, preview generation may comprise budget-constrained truncation including list-truncation by element budget, object-truncation by key-value budget, string-truncation by character budget, and passthrough for scalar primitive types.

In some embodiments, the computing system 101 may implement process variants for cross-task memory continuity. For example, a second process variant may include: receiving a memory retrieval query in a session that is associated with at least one continuity identifier; constructing a memory retrieval request that includes one or more of entry identifier and context identifier; receiving query-answer artifacts from a memory service, where each query-answer artifact may include prior context and following context entries; grouping query-answer artifacts by context identifier; deduplicating entries by entry identifier; ordering deduplicated entries by timestamp to generate one or more reconstructed conversation slices; mapping reconstructed conversation slices to citation identifiers; and generating one or more response segments including citation references corresponding to the reconstructed conversation slices.

In some embodiments, the second process variant may include fallback behavior where missing continuity identifiers are generated and logged, thereby preserving continuity of execution while retaining traceability. In some examples, the grouping step may use a map keyed by context identifier and the deduplication step may use a hash set keyed by entry identifier to suppress duplicates during merge. In some examples, the ordering step may include stable ordering with secondary tie-breaking by insertion index when timestamp values are equal or unavailable. In some examples, the response generation step may include generating a canonical locator according to one or more deterministic templates that include at least an entry identifier segment.

In some embodiments, the computing system 101 may implement process variants for scheduled task reliability. For example, a third process variant may include: receiving a schedule expression and generating a nominal next-run timestamp; applying randomized jitter to generate a jittered trigger score; inserting a scheduled trigger into a temporal queue with create-if-not-exists semantics; atomically claiming ready scheduled triggers by advancing their scores by a lease interval; dispatching claimed triggers for execution; in response to a worker interruption before re-scheduling, allowing the leased trigger to re-surface after lease expiration; in response to a cancellation request, writing a cancellation key and broadcasting a cancellation signal; interrupting active operations on workers that observe the cancellation signal; and removing one or more future scheduled triggers for the cancelled session.

In some embodiments, the schedule processing step may enforce a minimum schedule frequency between 15 minutes and 24 hours. In some embodiments, the jitter application step may include first-level schedule expression jitter and second-level queue score jitter (e.g., randomizing queue score by an offset between 0 and 600 seconds). In some embodiments, the atomic claiming step may be executed by an atomic queue script that retrieves entries having score values less than or equal to a current timestamp, sets new score values to current timestamp plus lease interval, and returns claimed keys and prior score values. The lease interval may be between 5 seconds and 300 seconds. In some embodiments, the trigger insertion step may include idempotent insertion for equivalent ‘(user_identifier, session_identifier, schedule_identifier)’ triples. In some embodiments, scheduled queue keys may be represented using concatenated key segments comprising at least user identifier, session identifier, and schedule identifier. In some embodiments, the trigger removal step may be implemented by iterative cursor scan operations and batched removals. In some embodiments, the cancellation key may use a TTL in a range from 5 minutes to 24 hours.

In some embodiments, the third process variant may include credit-aware logic comprising: in response to insufficient credits for a non-cron task, atomically moving the task from an active queue to a credits-blocked set; in response to credit restoration, moving one or more tasks from the credits-blocked set back to the active queue; and for a cron-triggered task, skipping the current run and scheduling a subsequent run rather than terminating the schedule.

In some embodiments, the credits-blocked set may use an expiration period between 1 day and 180 days.

In some embodiments, the computing system 101 may implement process variants for parent-child escalation semantics. For example, a fourth process variant may include: executing a background child session in response to a typed trigger; receiving a wake-parent terminal call from the background child session; marking the child execution as an escalated completion and storing an escalation message; enqueueing an escalation-tagged follow-up payload for a parent session; and waking or otherwise resuming the parent session to process the escalation-tagged follow-up payload.

In some embodiments, the fourth process variant may include preserving typed trigger metadata in parent and child state to distinguish background cron escalation from non-cron escalation. In some embodiments, escalation-tagged follow-up payload injection may be represented in parent context as a distinguishable structured annotation, such as one or more bracketed labels that distinguish escalated background results from non-escalated subagent completion results.

In some embodiments, the computing system 101 may implement process variants for lifecycle cleanup and state deletion. For example, a fifth process variant may include: receiving a thread or context deletion instruction; transmitting a cancellation request for an associated asynchronous task; clearing one or more persisted task states including message accumulation state, converter state, follow-up state, and sequence state; and finalizing deletion while permitting best-effort cleanup retries to complete asynchronously.

In some embodiments, cleanup operations may be implemented as non-blocking, fault-tolerant operations that do not prevent completion of the primary deletion operation if one or more cleanup sub-operations fail. In some embodiments, one or more components may apply lock or lease coordination to prevent concurrent execution conflicts. For example, a session lock may be obtained using an atomic set-if-not-exists operation with expiration, extended by heartbeat, and released on completion.

In some embodiments, the computing system 101 may perform authorization, schema-gating, memory continuity retrieval, scheduler reliability logic, escalation routing, and cleanup operations in different service layers. For example, one or more operations may be performed by a connector service, one or more operations may be performed by a memory service, one or more operations may be performed by a worker orchestration service, and one or more operations may be performed by a webhook or streaming state service.

In some embodiments, one or more process variants may include explicit error typing and remediation signaling. For example, tool execution errors may include one or more of invalid connector source, missing schema description precondition, authentication rejection, permission denial, credit insufficiency, queue lock contention, or stale session data.

In some embodiments, one or more process variants may include explicit session-status state transitions. For example, state transitions may include one or more of pending, running, sleeping, idle, failed, blocked, and cancelled states, where transitions are triggered by user events, system events, trigger events, terminal tools, or credit conditions.

In some embodiments, one or more process variants may include metrics and instrumentation operations associated with one or more of: queue wait times, trigger jitter distributions, cancellation propagation latency, memory retrieval latency, connector call latency, tool output size, and escalation frequency.

In some embodiments, one or more process variants may include storage layout variants in which one or more state elements are stored in object storage and one or more state elements are stored in key-value stores. For example, conversation and session-state artifacts may be persisted in object storage while queue state, cancellation keys, and follow-up queues are managed in a key-value store.

In some embodiments, one or more process variants may include cross-session workspace sharing for parent and child sessions while preserving session-specific metadata and tool-state isolation.

In some embodiments, one or more operations described in the two preceding supplemental sections may be performed by one or more processors in a single computing entity or by one or more processors distributed across multiple computing entities.

In some embodiments, one or more operations described in the preceding supplemental sections may be configured to improve operation of distributed agent-computing systems by reducing invalid external tool execution attempts, reducing duplicate scheduled task execution, reducing cancellation latency, reducing context-window resource consumption, and improving deterministic cross-session traceability for conversation memory retrieval and citation generation. The technical improvements may be measured by one or more machine-observable metrics, such as: reduction in connector execution error rates attributable to schema mismatch; reduction in duplicate cron trigger processing after worker interruption; reduction in cancellation propagation latency; lower queue wait-time variance during scheduled bursts; reduction in prompt token consumption per connector call due to output compaction; and increase in deterministic reproducibility of reconstructed conversation slices.

In some embodiments, one or more network interfaces may include: at least one connector list interface configured to return connector metadata and summary tool descriptors; at least one connector describe interface configured to return full input schemas for selected tools; at least one connector execute interface configured to perform external tool actions with typed response status values including success, auth-required, or error; at least one memory search interface configured to receive continuity metadata and return query-answer artifacts with surrounding context fields; and at least one asynchronous event interface configured to carry typed trigger metadata and incremental execution state.

In some embodiments, one or more deterministic error classes may be emitted for machine handling, including one or more of: missing schema precondition, invalid source identifier, missing tool identifier, authentication required, authorization rejection, insufficient credits, session lock contention, missing cron record, malformed queue key, stale session metadata, or context deleted. In some embodiments, one or more remediation actions may be directly mapped to one or more error classes, including one or more of: requiring schema-description prior to tool call; invoking connector authentication flow; retrying execution after credential refresh; generating replacement continuity identifiers; rescheduling on lock contention; parking tasks on credit failure; and cancelling residual queues on context deletion.

In some embodiments, one or more embodiments may include explicit machine-resource interactions that are not performable as practical mental steps, including at least one of: atomic queue mutation scripts over shared networked data stores; asynchronous publish-subscribe cancellation distribution; cross-service schema retrieval and enforcement; low-latency stream-state propagation; persisted state checkpointing and recovery; or distributed worker lock coordination.

In some embodiments, one or more embodiments may be implemented on one or more heterogeneous machine deployments, including single-node deployment, multi-process deployment, containerized distributed deployment, and cloud multi-region deployment, while preserving one or more protocol-level requirements described herein. In some embodiments, one or more parameters described herein may be tunable at runtime and may be stored in configuration storage, and parameter ranges described herein may be independently selected and combined.

In some embodiments, one or more operations in the supplemental sections may be omitted, reordered, parallelized, or replaced by equivalent computational operations while preserving one or more technical effects of: connector precondition enforcement, continuity-preserving memory retrieval, queue reliability under distributed concurrency, deterministic asynchronous state propagation, adversarial content detection and mitigation in tool outputs, multi-layer inference resource management with content-type-aware trimming and hybrid token checkpointing, distributed execution environment recovery with coordinated lock-based remediation, workload-class-based queue isolation with atomic follow-up-aware task completion, multi-model sequential retry with fallback chains, hook-based dynamic context injection, and compound cross-system integration behaviors described in the cross-system integration section.

### C. Connector Output Compaction and Hook-Based Dynamic Context Injection

In some embodiments, the computing system 101 may infer a compact output schema from a connector result payload by applying an automatic schema inference operation to one or more sample data elements within the payload. The automatic schema inference operation may accept one or more structured data values as input and may produce a typed structural schema that captures the data types, nesting relationships, required and optional field designations, and union-type alternatives present in the sample data. The inferred schema may be used to provide a machine-usable structural description of the connector output while consuming substantially fewer context-window resources than the full payload content.

In some embodiments, the automatic schema inference operation may comprise a schema builder component that incrementally constructs a typed schema by observing one or more data objects. The schema builder component may accept an arbitrary structured data value and may merge observed type information into an evolving schema representation. In some examples, the schema builder component may support incremental schema refinement, wherein additional data objects may be provided to the schema builder to widen or narrow inferred type constraints. In other examples, the schema builder may operate on a single representative data object.

In some embodiments, the computing system 101 may apply a recursive compaction operation to the inferred typed schema. The recursive compaction operation may traverse the schema in a depth-first manner and may produce a compact string representation wherein each schema node is represented using an abbreviated notation. The compact string representation may use substantially fewer characters than the original schema representation while preserving the structural and type information necessary for downstream interpretation.

In some embodiments, the recursive compaction operation may apply type abbreviation mappings that replace primitive type identifiers (e.g., string, integer, numeric, boolean, null) with shortened forms of two-to-four characters each. For union-type schema nodes, the compaction operation may filter null-type alternatives; when exactly one non-null type remains, the node may be treated as having that single type, and when two or more non-null types remain, the node may be represented as a union using a delimiter notation. The same null-filtering and recursive compaction may be applied to alternative union types expressed as union-of-alternatives schema constructs.

In some embodiments, for object-type schema nodes, the recursive compaction operation may distinguish between required and optional properties by consulting a required property set, annotating optional properties with an optional-field marker (e.g., a question mark character appended to the property name). Nested object-type nodes may be recursively compacted and enclosed within brace delimiters, and nested array-type nodes may be recursively compacted with an array-type notation (e.g., array bracket delimiters for object items or an array bracket suffix for non-object items). For object-type nodes having no defined properties, the compaction operation may produce an empty object marker. The compaction operation may use indentation depth tracking to produce human-readable hierarchical formatting.

In some embodiments, the computing system 101 may apply a dual-descriptor approach to connector output characterization. The dual-descriptor approach may produce two complementary descriptors for a given connector result payload: a human-readable structure description and a machine-usable compact typed schema. The human-readable structure description may provide a lightweight natural-language summary of the top-level data structure, including one or more of: a data type classification, an element count, a key listing, or a character count. The machine-usable compact typed schema may provide the full recursive type structure in abbreviated notation.

In some embodiments, the human-readable structure description may be generated by a structure description operation that classifies the top-level data value according to data-type patterns, producing type-appropriate summaries (e.g., key count and key names for dictionaries, element count for arrays, character length for strings, or type indicators for booleans, numerics, and nulls). For dictionary-type data, the structure description operation may apply a key display threshold (e.g., between 5 and 20 keys) and may append a truncation indicator when the key count exceeds the threshold. The dual-descriptor approach may include the human-readable structure description as a top-level metadata field and the compact typed schema as a separate field within the same compacted output representation, enabling an agent language model to use the structure description for general understanding and the typed schema for precise field-level reasoning.

In some embodiments, connector output schema inference may be implemented as a process comprising: receiving a connector result payload comprising one or more structured data values; providing at least one structured data value from the connector result payload to a schema builder component; generating a typed structural schema from the schema builder component, the typed structural schema comprising type annotations, property definitions, required property sets, and union type constructs; traversing the typed structural schema recursively, applying type abbreviation mappings to primitive types, filtering null alternatives from union constructs, annotating optional properties with optional-field markers, and producing a compact string representation; generating a human-readable structure description from the top-level data value of the connector result payload; and including the compact string representation and the human-readable structure description in a compacted connector output representation associated with the connector result payload.

In some embodiments, the schema traversal step may produce the compact string representation in a single recursive pass through the typed structural schema without requiring an intermediate representation. In other embodiments, the schema traversal step may produce an intermediate tree representation that is subsequently serialized to the compact string.

In some embodiments, the structure description generation step may be performed independently of and concurrently with the schema generation steps, as the structure description and the compact typed schema are derived from different input sources. In other embodiments, the foregoing steps may be performed sequentially.

In some embodiments, the computing system 101 may implement a hook-based dynamic context injection framework that enables extensible injection of dynamic contextual information into an agent's language model context at designated lifecycle points during agent execution. The hook-based framework may allow one or more hook components to be registered with an agent instance, where each hook component may independently generate contextual reminder content that is incorporated into the agent's conversational context at runtime.

In some embodiments, each hook component may implement an abstract interface comprising a context generation method that accepts lifecycle arguments and returns either a contextual reminder string or a null value. Each hook component may be initialized with a hook state object for maintaining persistent or semi-persistent state across lifecycle invocations and a reference to the current agent session for accessing session-scoped context.

In some embodiments, the hook-based framework may support at least two lifecycle points: an initial lifecycle point triggered at the start of an agent execution turn (before the agent language model generates a response), and a post-tool-execution lifecycle point triggered after each tool execution completes. The initial lifecycle point may be represented by lifecycle arguments comprising a phase identifier, while the post-tool-execution lifecycle point may additionally include a tool name, tool input representation, and tool output representation. At the post-tool-execution lifecycle point, a hook component may inspect these tool-specific fields to generate tool-type-dependent reminder content or return null for irrelevant tool types.

In some embodiments, the computing system 101 may execute multiple hook components concurrently at each lifecycle point, bounding total injection latency by the slowest individual hook rather than the sum of all hook latencies. The computing system 101 may apply error isolation such that an exception in one hook component is caught and logged without propagating to other concurrently running hooks. The computing system 101 may aggregate results by filtering null values, wrapping each non-null contextual reminder string in a structured markup tag (e.g., an opening and closing tag pair using a reserved system-level tag name), joining the wrapped reminders with delimiter separators, and injecting the combined contextual reminder into the agent's conversational context. For the initial lifecycle point, injection may append to the last message; for the post-tool-execution lifecycle point, injection may attach to the tool result content block as supplemental context. The language model may treat injected reminders as system-level instructions.

In some embodiments, hook-based dynamic context injection may be implemented as a process comprising: receiving a lifecycle event at a designated lifecycle point during agent execution, the lifecycle event comprising lifecycle arguments identifying the lifecycle point and, for post-tool-execution lifecycle points, tool execution metadata; for each registered hook component, invoking the context generation method with the lifecycle arguments, wherein the invocations are performed concurrently; for each hook component invocation, applying error isolation such that an exception in one hook component does not affect other hook component invocations; collecting the results of all hook component invocations, filtering null results to retain only non-null contextual reminder strings; wrapping each non-null contextual reminder string in a structured markup tag; and joining the wrapped contextual reminder strings into a combined contextual reminder and injecting the combined contextual reminder into the agent's conversational context at a position associated with the lifecycle point.

In some embodiments, the hook invocation step may complete in bounded time by applying a timeout to each individual hook component invocation. When a hook component exceeds the timeout, the invocation may be cancelled and a null value may be substituted. In some examples, the timeout may be between 1 second and 30 seconds.

In some embodiments, the joining step may include a size threshold check for the combined contextual reminder. When the combined contextual reminder exceeds a size threshold, the computing system 101 may truncate or summarize the combined contextual reminder to fit within the size threshold. In some examples, the size threshold may be expressed in tokens or characters.

In some embodiments, the hook-based framework may support dynamic registration and deregistration of hook components during agent execution (e.g., in response to configuration changes, user preference updates, or capability activation). Hook components may maintain serializable state across lifecycle invocations via the hook state object, enabling persistence across session interruptions with schema-evolution support.

In some embodiments, the operations described in this section may improve operation of the computing system 101 through complementary technical effects: the connector output schema inference and dual-descriptor approach may reduce context-window token consumption by one or more orders of magnitude for large connector outputs while preserving machine-usable structural information for precise field-level reasoning; and the hook-based dynamic context injection may enable modular and extensible context injection without modifying the core agent execution loop, with concurrent hook execution bounding total injection latency by the single longest-running hook and error isolation ensuring that a malfunctioning hook does not disrupt agent execution.

In some embodiments, the automatic schema inference operation may be implemented using one or more of: a sampling-based schema builder, a grammar-based schema parser, a statistical type inference engine, or a machine-learning-based schema classifier, and different approaches may be combined. The compact schema representation may use abbreviated type tokens with delimiter-separated property lists, indentation-based or bracket-based hierarchical notation, schema-specific serialization formats, or custom domain-specific languages, selected to balance human readability, machine parsability, and character efficiency. The recursive compaction operation may apply depth limiting (e.g., between 3 and 10 levels) to prevent excessive schema sizes for deeply nested structures. The structure description operation may use pattern matching, runtime type inspection, schema-based classification, or heuristic analysis, and may include additional metadata such as estimated byte size or token count.

In some embodiments, the hook-based framework may be implemented using an abstract class-based interface with inheritance, a protocol-based interface with structural typing, a function-based hook registration with callable objects, or an event-driven publish-subscribe pattern. Concurrent hook execution may use cooperative multitasking with an asynchronous event loop, thread-based parallelism, process-based parallelism, or distributed execution across multiple computing nodes. The structured markup tags may be implemented using custom angle-bracket delimiters, namespace-prefixed tags, attribute-annotated tags, or delimiter-based markers, and may include attributes identifying the originating hook component or lifecycle point.

### D. Tool Output Security Classification and Adversarial Content Mitigation

In some embodiments, the computing system 101 may implement a tool output security classification system that evaluates content returned by one or more tools for the presence of adversarial instructions before such content is processed by a primary language model agent. The tool output security classification system may use a secondary language model, distinct from the primary agent language model, to perform semantic classification of tool output content. By employing a secondary language model for classification, the computing system 101 may achieve context-aware detection of adversarial content that accounts for the semantic meaning and intent of content rather than relying on surface-level pattern matching. The secondary language model may be trained or prompted to distinguish between legitimate application content (e.g., user interface elements, navigation instructions, business communications, technical documentation) and genuinely adversarial content (e.g., behavioral override commands, false authority claims, role manipulation attempts, and deceptive social engineering). As used herein, “tool output” refers to data returned by a tool in response to a tool invocation by the language model agent, including text, structured data, images, or other content types. As used herein, “adversarial content” refers to content embedded in external data sources that is designed to manipulate, override, or alter the intended behavior of a language model agent, including prompt injection attacks, behavioral override commands, false authority claims, role manipulation directives, and social engineering attempts. As used herein, “secondary language model” refers to a language model used for content classification, distinct from the “primary agent language model” used to generate agent responses and tool invocations.

In some embodiments, the computing system 101 may execute the secondary model classification concurrently with the primary agent language model inference. For example, the computing system 101 may dispatch both the primary agent inference request and the secondary classification request in parallel, such that when the secondary classification completes no later than the primary inference, the classification contributes no incremental end-to-end latency relative to the primary inference path. The computing system 101 may await completion of both the primary inference and the secondary classification and may conditionally take remedial action based on the classification result. In some examples, when the secondary classification completes after the primary inference, the incremental latency attributable to classification may correspond to the latency differential. As used herein, “latency differential” refers to the amount by which completion of a secondary classification operation trails completion of a primary inference operation executed concurrently for a common agent step.

In some embodiments, the remedial action may comprise injecting one or more warning annotations into the tool output content within the conversation context and re-invoking the primary agent language model with the annotated conversation. The warning annotations may inform the primary agent language model that the tool output may contain adversarial instructions and may instruct the primary agent language model to disregard any instructions embedded in the annotated tool output. In some examples, the warning annotations may include a classification reasoning summary generated by the secondary model to provide the primary agent language model with context regarding the nature of the detected adversarial content. As used herein, “warning annotation” refers to a text element inserted into a tool result block within the conversation context to inform the primary agent language model that the tool result may contain adversarial content.

In some embodiments, the remedial action may alternatively or additionally comprise one or more of: blocking execution of one or more tool calls requested by the primary agent language model in response to the adversarial content, replacing the tool output content with a sanitized version, truncating the tool output content, terminating the agent session, generating a user-facing notification indicating detected adversarial content, or logging the detection event for security auditing.

In some embodiments, the computing system 101 may maintain a trust classification for each tool available to the agent. Each tool definition may include a trust annotation indicating whether the tool returns content from external, potentially untrusted sources. For example, tools that retrieve content from wide area network resources, fetch content from user-specified URLs, interact with browser-rendered web pages, execute searches against external services, or invoke third-party connectors may be annotated as untrusted-content tools. Tools that perform internal computations, access controlled internal data stores, or execute sandboxed operations may not carry the untrusted-content annotation. As used herein, “trust annotation” refers to a metadata property associated with a tool definition that indicates whether the tool produces content originating from external, potentially untrusted sources.

In some embodiments, the trust annotation may be a Boolean property stored in a centralized tool registry alongside tool names, input schemas, output schemas, and concurrency properties. The trust annotation may be assigned at tool registration time, configurable at runtime based on deployment context or administrative policy, or inferred automatically based on tool properties (e.g., whether the tool makes outbound network requests).

In some embodiments, the computing system 101 may selectively extract content for security classification based on trust annotations. For each tool result block in the most recent conversation message, the computing system 101 may identify the corresponding tool name from a preceding assistant message and consult the tool registry to determine the trust annotation. The computing system 101 may extract text content only from tool result blocks associated with untrusted-content tools (concatenating with delimiter sequences to preserve boundaries), excluding trusted-tool results and error-indication results from classification to reduce computational overhead and false-positive detections.

In some embodiments, the secondary language model may generate classification output conforming to a structured classification schema. The structured classification schema may define one or more fields including at least a detection indicator and a reasoning field. The detection indicator may be a Boolean value indicating whether adversarial content was detected in the analyzed tool output. The reasoning field may be a textual explanation of the classification decision, describing why the content was or was not classified as adversarial.

In some embodiments, the structured classification schema may be enforced by providing the secondary language model with structured output parameters as a response format constraint. The schema may additionally include a confidence score, a classification category (e.g., behavioral override, authority impersonation, social engineering, data exfiltration), affected content regions, a severity level, or a list of specific adversarial patterns detected.

In some embodiments, the secondary language model may be provided with a classification prompt that defines the classification task, specifies criteria for distinguishing adversarial content from legitimate content, and provides exemplar instances of both adversarial and benign content. The classification prompt may include a core principle definition, one or more positive classification criteria, one or more negative classification criteria, a decision process, and one or more exemplar pairs. As used herein, “classification prompt” refers to a prompt provided to the secondary language model that defines the classification task, criteria, and exemplars.

In some embodiments, the classification prompt may include one or more exemplar instances of both adversarial and benign content, each accompanied by an explanation of why the exemplar is classified as such. The exemplars may provide the secondary language model with concrete reference points for calibrating classification decisions.

In some embodiments, the computing system 101 may apply a content truncation operation to the extracted untrusted content prior to classification. For example, the computing system 101 may truncate the combined extracted content to a predefined character limit (e.g., a truncation threshold). The truncation operation may reduce the computational cost of classification for large tool outputs while preserving the initial portion of content, which may be more likely to contain adversarial instructions targeting the beginning of tool output processing.

In some embodiments, the truncation threshold may be configurable based on the secondary model's context capacity, computational budget, or session risk level, and may be adjusted dynamically based on measured classification latency or content characteristics.

In some embodiments, when the secondary model classifies tool output as containing adversarial content, the computing system 101 may inject warning annotations into tool result blocks associated with untrusted-content tools that do not carry an error indication. Each warning text block may comprise an adversarial content indication, a directive to the primary agent language model to disregard embedded instructions, and the classification reasoning from the secondary model, inserted at the beginning of the tool result content. The computing system 101 may then re-invoke the primary agent language model with the modified conversation to generate a replacement response that accounts for the warnings. This warning injection approach may preserve the agent's ability to extract legitimate information from tool outputs that contain adversarial content alongside useful data.

In some embodiments, the concurrent classification pipeline may include conditional re-invocation logic: upon a non-detection result, the computing system 101 may return the primary inference result directly; upon a detection result where the primary inference includes tool invocation requests, warning annotations may be injected and the primary model re-invoked; and upon a detection result where the primary inference comprises only text output, the result may be returned without re-invocation. The computing system 101 may monitor relative completion times and emit performance metrics when classification trails inference, informing decisions regarding model selection and truncation thresholds.

In some embodiments, untrusted-content tools may include web search tools, URL fetch tools, browser interaction tools, external connector tools, research orchestration tools, and any other tools whose output includes externally-authored content. Trusted tools (e.g., sandboxed code execution tools, file system tools, internal computation tools, session management tools, and memory retrieval tools) may be excluded from classification.

In some embodiments, the tool output security classification system may improve computer functionality by: improving detection accuracy through semantic classification rather than keyword matching; preserving responsiveness through concurrent classification bounded by the latency differential; reducing false positives through trust-annotation-based selective classification; preserving access to legitimate information through warning injection rather than blocking.

FIG. 16 is a flowchart diagram of an example tool output security classification process 1600 in accordance with some embodiments of the present disclosure.

At operation 1602, the computing system 101 may receive, from a primary agent language model, a conversation context comprising one or more tool result blocks, each tool result block corresponding to an invocation of a respective tool from a plurality of available tools.

At operation 1604, the computing system 101 may identify, for each tool result block, a corresponding tool name based on a tool invocation request in a preceding assistant message within the conversation context.

At operation 1606, the computing system 101 may determine, for each identified tool name, whether the corresponding tool is associated with an untrusted-content annotation in a tool registry. The tool registry may store, for each available tool, at least a tool name and a trust annotation indicating whether the tool produces content from external sources.

At operation 1608, the computing system 101 may extract text content from one or more tool result blocks that are associated with tools having the untrusted-content annotation and that do not carry an error indication. The computing system 101 may aggregate the extracted text content into a combined content representation.

At operation 1610, the computing system 101 may optionally truncate the combined content representation to a predefined truncation threshold.

At operation 1612, the computing system 101 may provide the combined content representation to a secondary language model along with a classification prompt. The classification prompt may define criteria for distinguishing adversarial content from legitimate content and may include one or more exemplar instances.

At operation 1614, the computing system 101 may receive, from the secondary language model, a structured classification result conforming to a classification schema. The structured classification result may include at least a detection indicator and a reasoning description.

At operation 1616, the computing system 101 may determine whether the detection indicator indicates that adversarial content was detected.

At operation 1618, in response to a negative detection, a classification failure, or a determination that the primary agent language model response does not include tool invocation requests, the computing system 101 may return the original primary agent language model response without modification.

At operation 1620, in response to a positive detection and a determination that the primary agent language model response includes one or more tool invocation requests, the computing system 101 may inject a warning annotation into each tool result block associated with an untrusted-content tool. The warning annotation may include at least an adversarial content alert and the reasoning description from the classification result.

At operation 1622, the computing system 101 may re-invoke the primary agent language model with the modified conversation context including the injected warning annotations to generate a replacement response.

In some embodiments, one or more of operations 1602 through 1622 may be performed in a different order, may be performed concurrently, or may be omitted. For example, operations 1602 and 1612 through 1614 may be performed concurrently such that the primary agent inference and the secondary classification execute in parallel. In some embodiments, the process 1600 may additionally include, prior to operation 1610, a determination of whether to apply a multi-stage classification pipeline, as described herein, in which a lightweight first stage filters clearly benign content before invoking the secondary language model.

In some embodiments, the computing system 101 may implement a multi-stage classification pipeline in which a first classification stage applies a lightweight heuristic or rule-based filter and a second classification stage invokes the secondary language model only for content that passes the first stage. This multi-stage approach may reduce secondary model invocations for clearly benign content while maintaining semantic classification for ambiguous cases.

In some embodiments, the computing system 101 may maintain a classification cache indexed by content hash with time-to-live values, may implement adaptive classification thresholds based on session context (e.g., stricter for high-value operations, more permissive for read-only retrieval), and may aggregate classification telemetry to identify adversarial targeting patterns and adjust sensitivity accordingly.

In some embodiments, the classification system may be extended to evaluate content at multiple pipeline points (e.g., tool input, intermediate processing, and output), and may implement a feedback mechanism wherein the primary model reports undetected adversarial content to refine the classification prompt or exemplar corpus. The warning annotation may include structured metadata (e.g., content category, confidence score, affected boundaries, recommended mitigations). The trust annotation system may support hierarchical trust levels (e.g., fully trusted, partially trusted, untrusted) with different classification policies at each level. The secondary classification model may be selected based on available resources, latency requirements, content complexity, or session risk level.

In some embodiments, one or more of the tool output security classification, trust annotation, selective content extraction, warning injection, concurrent classification pipeline, classification prompt architecture, content truncation, and classification scope features may be implemented independently or in any combination, and may be applied across one or more agent sessions, sub-agent sessions, and/or background scheduled sessions.

### E. Multi-Layer Inference Resource Management

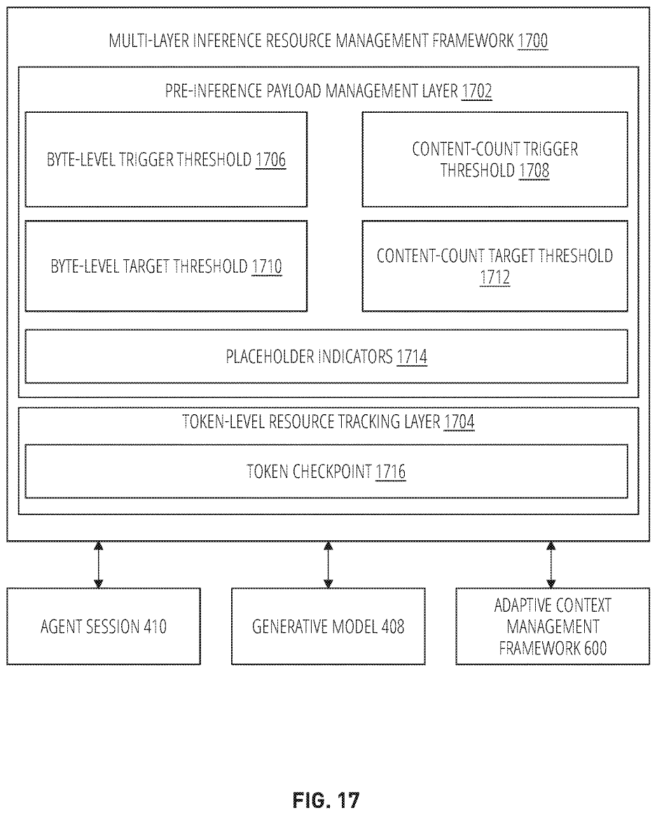

FIG. 17 is a block diagram of a multi-layer inference resource management framework 1700 in accordance with some embodiments of the present disclosure. The multi-layer inference resource management framework 1700 may be implemented by the computing system 101 in conjunction with the agent session 410, the generative model 408, and/or the adaptive context management framework 600 described herein.

The multi-layer inference resource management framework 1700 of the present disclosure may apply complementary resource management operations across multiple resource dimensions, each targeting a distinct resource constraint of the inference pipeline. In some embodiments, the computing system 101 may manage inference resources across at least two complementary layers: a pre-inference payload management layer 1702 that operates on byte-level and content-count dimensions of an inference request payload, and a token-level resource tracking layer 1704 that monitors and manages token consumption within the generative model's context window 602. By separating resource management into distinct layers that address different resource constraints, the multi-layer inference resource management framework 1700 may improve computer functionality by reducing the incidence of inference failures attributable to payload size violations and context window overflows, while preserving higher-value textual context and task-critical information that would otherwise be discarded by a single-layer compression approach. As used herein, an inference request payload may comprise the complete set of data transmitted from the computing system 101 to an inference endpoint of the generative model 408 for a single inference operation, including the serialized conversation data structure, system instructions, tool definitions, model configuration parameters, and other data required by the inference endpoint, subject to size constraints imposed by the inference endpoint, network transport layer, and intermediary services.

In some embodiments, the computing system 101 may implement the multi-layer inference resource management framework 1700 to manage inference resources for an agent session 410 across a plurality of resource dimensions. The plurality of resource dimensions may include one or more of: a byte-level dimension representing the total size of an inference request payload in bytes, a content-count dimension representing the number of content items of a particular type (e.g., images, audio segments, video frames) within the inference request payload, and a token-level dimension representing the number of tokens consumed within a context window 602 of the generative model 408. Each resource dimension may be associated with a corresponding resource constraint, such as a maximum request payload size, a maximum content item count, and/or a maximum context window size.

The multi-layer inference resource management framework 1700 may operate at a pre-inference stage of the inference pipeline, prior to submitting an inference request to the generative model 408, to ensure that the inference request satisfies all applicable resource constraints. In some embodiments, the multi-layer inference resource management framework 1700 may operate complementarily with the adaptive context management framework 600 described elsewhere in the present disclosure, with the context management framework 600 addressing token-level compression through artifact offloading and semantic summarization, and the multi-layer inference resource management framework 1700 addressing byte-level and content-count management through content-type-specific trimming operations.

In some embodiments, the computing system 101 may implement a pre-inference payload management layer 1702 that manages the byte-level size and content-item count of inference request payloads prior to submission to the generative model 408. The pre-inference payload management layer 1702 may operate on a conversation data structure representing the current state of an agent session 410, where the conversation data structure comprises a sequence of messages, each message comprising one or more content blocks of heterogeneous types, such as text content blocks, image content blocks, tool invocation content blocks, tool result content blocks, and/or the like. As used herein, a content block may comprise a discrete unit of content within a message of the conversation data structure, where each content block has an associated content type that determines its structure, encoding, and resource characteristics, including text content blocks, image content blocks, tool invocation content blocks, tool result content blocks, and other content types supported by the generative model 408.

In some embodiments, the pre-inference payload management layer 1702 may monitor the inference request payload against one or more resource thresholds, where each resource threshold corresponds to a resource dimension of the inference pipeline. The one or more resource thresholds may include a byte-level trigger threshold 1706 representing a byte-level size at which payload management operations are initiated, and/or a content-count trigger threshold 1708 representing a count of content items of a particular type at which payload management operations are initiated.

In some embodiments, the byte-level trigger threshold 1706 may be defined as a fraction of a maximum request payload size. For example, the byte-level trigger threshold 1706 may be set at 80%, 85%, 90%, 95%, or any other suitable percentage of the maximum request payload size, establishing a buffer zone that provides capacity for payload management operations to complete before the hard payload size limit is reached. The content-count trigger threshold 1708 may be defined as a maximum number of content items of a particular type that may be included in a single inference request. For example, the content-count trigger threshold 1708 may specify a maximum number of images, a maximum number of audio segments, a maximum number of embedded media items, and/or the like. In some examples, both the byte-level trigger threshold 1706 and the content-count trigger threshold 1708 may be stored as configurable parameters within system configuration, session configuration, or model-specific configuration data structures.

The pre-inference payload management layer 1702 may evaluate whether the inference request payload satisfies the one or more resource thresholds by computing a payload size estimate and a content-item count for the conversation data structure. The payload size estimate may represent an approximation of the total byte size of the inference request payload, computed by aggregating byte-level size estimates across all content blocks within all messages of the conversation data structure. The content-item count may represent a total count of content items of a particular type across all messages of the conversation data structure, including content items nested within compound content blocks.

In some embodiments, computing the payload size estimate may comprise traversing each content block within each message and computing a type-specific byte-level size estimate based on the content type: character length for text content blocks, encoded data length (e.g., base64 length) for image content blocks, serialized parameter length for tool invocation content blocks, and recursive aggregation for compound content blocks such as tool result content blocks containing nested sub-blocks. The payload size estimation may further employ heuristics or correction factors to account for serialization overhead, encoding padding, and message framing.

In some embodiments, computing the content-item count may comprise traversing each content block within each message and counting content items of the target type, including content items nested within compound content blocks at any nesting depth (e.g., image sub-blocks within tool result content blocks).

In some embodiments, the pre-inference payload management layer 1702 may implement a trigger-target hysteresis approach for resource management, wherein payload management operations are initiated when a resource metric meets or exceeds a trigger threshold and continue until the resource metric is reduced to or below a target threshold that is lower than the trigger threshold. The trigger-target hysteresis approach may prevent oscillation between triggering and not triggering payload management operations across successive inference requests by establishing a gap between the trigger threshold and the target threshold, such that once payload management operations are initiated, they reduce resource consumption sufficiently to avoid re-triggering on the immediately subsequent inference request.

In some embodiments, the pre-inference payload management layer 1702 may define a byte-level target threshold 1710 that is lower than the byte-level trigger threshold 1706, and/or a content-count target threshold 1712 that is lower than the content-count trigger threshold 1708. For example, if the byte-level trigger threshold 1706 is set at 90% of the maximum request payload size, the byte-level target threshold 1710 may be set at 40%, 50%, 60%, or any other suitable percentage that is lower than the trigger threshold. Similarly, if the content-count trigger threshold 1708 is set at a first count of content items, the content-count target threshold 1712 may be set at a second count that is lower than the first count. The gap between the trigger threshold and the target threshold may be configurable based on the expected rate of content accumulation within the agent session 410, the typical size of content items, and/or other operational characteristics of the inference pipeline.

When a payload management operation is triggered, the pre-inference payload management layer 1702 may continue removing or replacing content items until both the byte-level and content-count resource metrics are at or below their respective target thresholds 1710 and 1712, consistent with the trigger-target hysteresis approach described above.

In some embodiments, the pre-inference payload management layer 1702 may perform content-type-specific trimming operations that selectively remove or replace content items based on the content type and the resource dimension being managed. The content-type-specific trimming operations may target content types that consume disproportionate resources relative to their contribution to ongoing agent reasoning, while preserving content types that are critical for maintaining task continuity and instruction comprehension.

In some embodiments, the content-type-specific trimming operations may target image content blocks for removal or replacement, as image data may consume substantially more bytes per content block than textual content while contributing less to the ongoing conversational state of the agent session 410. For example, an image content block containing a screenshot captured during a prior step of a multi-step task may consume hundreds of thousands or millions of bytes, whereas the textual description of the observations made from that screenshot may consume only a few hundred bytes. By selectively trimming image content blocks while preserving textual content blocks, the pre-inference payload management layer 1702 may reclaim substantial payload capacity without discarding the textual reasoning and observations that the agent derived from those images.

In some embodiments, the computing system 101 may implement additional or alternative content-type-specific trimming operations targeting other resource-intensive content types, such as audio content blocks, video content blocks, large binary data blocks, and/or the like. The selection of which content types to target for trimming may be configurable based on the content modalities supported by the generative model 408, the relative resource consumption of each content type, and/or the relative importance of each content type to the agent's ongoing task execution.

In some embodiments, the content-type-specific trimming operations may process content items in a chronological order, beginning with the oldest content items in the conversation data structure and proceeding toward the most recent content items. The chronological trimming order may be based on the observation that older content items are generally less relevant to the agent's current reasoning state than more recent content items, as the agent may have already extracted and recorded relevant observations from older content items in subsequent textual messages. By trimming older content items first, the pre-inference payload management layer 1702 may preserve the most recently acquired information, which is more likely to be relevant to the agent's current task step.

In some embodiments, the trimming operations may implement an early termination condition, wherein the trimming operations cease as soon as all applicable resource metrics are at or below their respective target thresholds. The early termination condition may preserve content items that would otherwise be trimmed, retaining as much original content as possible while satisfying the target thresholds. Combined with the chronological trimming order, the early termination condition ensures that the most recent content items are preserved while the minimum number of older content items is trimmed to satisfy resource constraints.

In some embodiments, the trimming operations may traverse the conversation data structure message by message, starting from the earliest message in the conversation and proceeding chronologically. For each message, the trimming operations may evaluate each content block within the message to identify content blocks of the target type (e.g., image content blocks). When a content block of the target type is identified and the resource metrics have not yet reached their respective target thresholds, the content block may be replaced with a placeholder indicator 1714 that indicates the content has been removed. In some examples, the placeholder indicator 1714 may comprise a text content block containing a descriptive label (e.g., “[image removed]”, “[media trimmed]”, or similar textual indicators) that informs the generative model 408 that content was previously present at that position but has been removed for resource management purposes. As used herein, a placeholder indicator may comprise a content block that replaces a trimmed content item within the conversation data structure, providing a textual indication that content was previously present at that position but has been removed during payload management operations, and may include metadata about the removed content such as the content type, an approximate size, a timestamp, and a brief description.

In some embodiments, the content-type-specific trimming operations may handle content items that are nested within compound content blocks. For example, tool result content blocks may contain a heterogeneous sequence of sub-blocks, including text sub-blocks and image sub-blocks. When a tool result content block contains one or more image sub-blocks, the trimming operations may selectively replace the image sub-blocks within the tool result content block with placeholder indicators 1714 while preserving the text sub-blocks and the structural integrity of the tool result content block.

In some embodiments, handling nested content structures may comprise reconstructing compound content blocks with modified sub-block sequences. When one or more sub-blocks within a compound content block are replaced with placeholder indicators 1714, the computing system 101 may construct a new compound content block that preserves all metadata of the original compound content block (e.g., tool invocation identifiers, error status indicators, caching directives) while replacing the content sequence with the modified sub-block sequence. In this manner, the trimming operations may modify the content of compound content blocks without disrupting the structural relationships between tool invocations and tool results within the conversation data structure.

In some embodiments, the pre-inference payload management layer 1702 may implement an immutable conversation update pattern, wherein trimming operations produce a new conversation data structure rather than modifying the existing conversation data structure in place. Messages that are not modified by the trimming operations may be included in the new conversation data structure by reference, while messages that contain trimmed content blocks may be replaced with newly constructed message objects containing the modified content block sequences. System-level content of the conversation data structure (e.g., system prompts, system instructions) may be preserved unchanged in the new conversation data structure.

The immutable conversation update pattern may provide several technical advantages. By producing a new conversation data structure rather than modifying the existing one, the immutable conversation update pattern may enable the computing system 101 to maintain a reference to the original, untrimmed conversation data structure for purposes such as logging, debugging, audit trail maintenance, and/or recovery in the event that the trimming operations produce an undesirable result. In addition, the immutable conversation update pattern may prevent concurrent modification issues in multi-threaded execution environments where multiple components may access the conversation data structure simultaneously.

In some embodiments, the pre-inference payload management layer 1702 may return a result indicator based on the outcome of the payload management evaluation. When the resource metrics are below all trigger thresholds and no trimming is required, the pre-inference payload management layer 1702 may return a null or empty result indicator, signaling to the calling component that the original conversation data structure may be used without modification. When trimming is performed, the pre-inference payload management layer 1702 may return the newly constructed conversation data structure, signaling to the calling component that the trimmed conversation data structure should be used for the inference request in place of the original.

In some embodiments, the computing system 101 may implement a token-level resource tracking layer 1704 that monitors and manages token consumption within the context window 602 of the generative model 408. The token-level resource tracking layer 1704 may operate complementarily with the pre-inference payload management layer 1702, with the pre-inference payload management layer 1702 managing byte-level and content-count constraints of the inference request transport layer, and the token-level resource tracking layer 1704 managing token-level constraints of the generative model's context window 602.

Token counting for generative model inference may be computationally expensive, particularly when exact token counts require invoking a tokenization algorithm or an external tokenization service for the full conversation data structure. Depending on implementation, token-counting strategies may include exact counting before inference or heuristic estimation with lower computational overhead. The token-level resource tracking layer 1704 of the present disclosure implements a hybrid token tracking approach that combines model-reported token counts from inference responses with periodic exact validation, thereby providing accurate token tracking with reduced computational overhead.

In some embodiments, the token-level resource tracking layer 1704 may maintain a token checkpoint data structure 1716 that records the most recently validated token count for the agent session 410, along with metadata indicating the validation method and any accumulated approximation since the last exact validation. The token checkpoint data structure 1716 may comprise a numeric token count value, an exactness indicator indicating whether the token count was obtained through exact computation or model-reported values, and an approximate delta value representing the estimated number of tokens added since the last exact validation. As used herein, a token checkpoint may comprise a data structure that records the measured or estimated token consumption of an agent session at a particular point in time, along with metadata characterizing the accuracy and provenance of the recorded token count, enabling the token-level resource tracking layer 1704 to maintain a running estimate of token consumption without full tokenization before each inference request, and may be persisted within agent session data for recovery across session interruptions.

In some embodiments, the token-level resource tracking layer 1704 may create token checkpoints at defined intervals during agent session execution, such as after each inference call to the generative model 408. When the generative model 408 returns an inference response, the inference response may include a usage report indicating the number of input tokens consumed during the inference operation. The token-level resource tracking layer 1704 may use this model-reported token count as the basis for the token checkpoint, as the model-reported count reflects the actual tokenization performed by the generative model 408 during inference.

In some embodiments, the token-level resource tracking layer 1704 may compute an approximate token delta representing the estimated number of tokens in messages added to the conversation data structure since the last checkpoint. The approximate token delta may be computed by applying a character-to-token conversion ratio to the total character count of the new messages. The character-to-token conversion ratio may be based on empirical observations of the relationship between character count and token count for the tokenization algorithm used by the generative model 408, such as approximately one token per two characters, one token per four characters, or any other suitable ratio.

In some embodiments, the approximate token delta may be computed using type-specific estimation heuristics for different content block types. For text content blocks, the approximate token delta may be based on the character length of the text content divided by the character-to-token conversion ratio. For tool invocation content blocks, the approximate token delta may be based on the serialized length of the tool input parameters divided by the character-to-token conversion ratio. For compound content blocks, such as tool result content blocks, the approximate token delta may be computed recursively by aggregating the approximate token deltas of the nested sub-blocks. For image content blocks, which are not character-based and whose token consumption depends on model-specific image processing, the approximate token delta may be based on a fixed token estimate (e.g., 4,000 tokens, 6,000 tokens, 8,000 tokens, or any other suitable estimate) derived from empirical observation of the generative model's image token consumption.

In some embodiments, the token-level resource tracking layer 1704 may trigger exact token validation when the approximate token delta exceeds an approximation threshold. The approximation threshold may represent a maximum permissible divergence between the approximate token count and the actual token count before exact validation is required to correct potential accumulation of approximation errors. The approximation threshold may be defined in character units (e.g., 20,000 characters, 30,000 characters, 50,000 characters), token units, or other suitable units, and may be stored as a configurable parameter within system configuration or session configuration data structures.

When the approximate token delta exceeds the approximation threshold, the token-level resource tracking layer 1704 may invoke an exact token counting operation. The exact token counting operation may comprise submitting the current conversation data structure to a tokenization service or tokenization algorithm associated with the generative model 408 and obtaining a precise token count. In some embodiments, the exact token counting operation may comprise an API call to a token counting endpoint provided by the model inference service, which applies the model-specific tokenizer to the full conversation data structure and returns the resulting token count. The token checkpoint data structure 1716 may then be updated with the exact token count and the exactness indicator may be set to indicate that the checkpoint is based on exact validation.

In some embodiments, exact token validation may also be triggered when no model-reported token count is available from the inference response, such as when the inference call fails, when the model-reported usage report is absent or incomplete, or when the agent session is being initialized prior to the first inference call. In such cases, the token-level resource tracking layer 1704 may fall back to exact token counting to establish an accurate baseline for subsequent approximate tracking.

In some embodiments, the multi-layer inference resource management framework 1700 may coordinate operations between the pre-inference payload management layer 1702 and the token-level resource tracking layer 1704 to provide comprehensive resource management across multiple resource dimensions. The pre-inference payload management layer 1702 may be invoked prior to each inference request to ensure that the payload satisfies byte-level and content-count constraints, while the token-level resource tracking layer 1704 may be invoked after each inference response to update the token checkpoint with the latest resource consumption data.

In some embodiments, the multi-layer inference resource management framework 1700 may also coordinate with the adaptive context management framework 600 described elsewhere in the present disclosure. When the token checkpoint data structure 1716 indicates that token consumption is approaching the exception threshold 616 of the context window 602, the adaptive context management framework 600 may initiate token-level compression operations, such as artifact offloading and semantic summarization. Concurrently, the pre-inference payload management layer 1702 may manage byte-level and content-count constraints independently, ensuring that the inference request remains within payload size limits even when the token-level context has been compressed. In this manner, the multi-layer inference resource management framework 1700 may provide defense-in-depth resource management that addresses distinct resource constraints at their respective layers of the inference pipeline, reducing the overall incidence of resource-related inference failures.

In some embodiments, the pre-inference payload management layer 1702 may reduce the workload of the token-level compression operations by removing high-byte-count content items (e.g., images) that also consume tokens within the context window 602. By removing such content items at the byte level before token-level compression is triggered, the pre-inference payload management layer 1702 may defer or reduce the scope of token-level compression operations, thereby preserving additional textual context that would otherwise be subject to summarization or offloading.

In some embodiments, the multi-layer inference resource management framework 1700 may provide one or more technical effects that improve the functioning of a computer. By separating resource management into distinct layers that address byte-level, content-count, and token-level constraints independently, the framework 1700 may reduce the incidence of inference failures caused by payload size violations, content count limit violations, and/or context window overflows, thereby decreasing the computational cost of retry operations and improving the reliability of long-running agent sessions. Furthermore, by implementing content-type-specific trimming operations that selectively remove resource-intensive content items (e.g., images) while preserving textual content, the framework 1700 may optimize the allocation of limited inference resources to content types that contribute most to the agent's ongoing reasoning and task continuity, deferring the onset of token-level compression operations.

By implementing a hybrid token tracking approach that combines model-reported token counts with approximate delta tracking and periodic exact validation, the token-level resource tracking layer 1704 may provide accurate token consumption monitoring with reduced computational overhead compared to exact tokenization before every inference request, with savings that are particularly significant for long-running agent sessions with high-frequency inference requests. The trigger-target hysteresis approach described above may further reduce the cumulative computational overhead of payload management operations by deferring re-triggering across multiple subsequent inference requests.

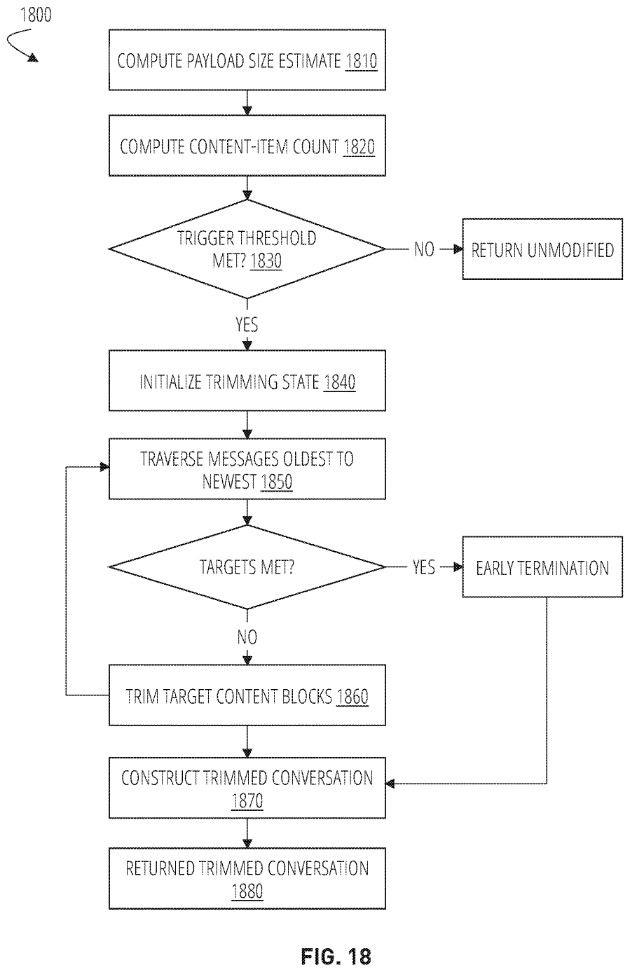

FIG. 18 is a flowchart diagram of an example pre-inference payload management process 1800 in accordance with some embodiments of the present disclosure. The process 1800 may be performed by the computing system 101 in conjunction with the pre-inference payload management layer 1702 of the multi-layer inference resource management framework 1700.

FIG. 18 illustrates an example process 1800 for explanatory purposes. Other implementations of FIG. 18 may comprise additional, fewer, or different operations than those depicted in the illustrated example process 1800. Similarly, in some implementations, one or more of the operations depicted in the illustrated example process 1800 may be performed in a different order or in parallel.

At operation 1810, the computing system 101 may compute a payload size estimate for a conversation data structure associated with an agent session 410. Computing the payload size estimate may comprise traversing each message within the conversation data structure, traversing each content block within each message, computing a type-specific byte-level size estimate for each content block based on the content type of the content block, and aggregating the type-specific byte-level size estimates to produce the payload size estimate. In some embodiments, the type-specific byte-level size estimate for a text content block may be based on the character length of the text content, the type-specific byte-level size estimate for an image content block may be based on the length of the encoded image data, the type-specific byte-level size estimate for a tool invocation content block may be based on the serialized length of the tool input parameters, and the type-specific byte-level size estimate for a tool result content block may be computed recursively by aggregating the byte-level size estimates of the nested sub-blocks within the tool result content block.

At operation 1820, the computing system 101 may compute a content-item count for the conversation data structure. Computing the content-item count may comprise traversing each message within the conversation data structure, traversing each content block within each message, identifying content blocks of a target content type (e.g., image content blocks), counting identified content blocks, and recursively counting content blocks of the target content type within compound content blocks (e.g., image sub-blocks within tool result content blocks). In some embodiments, operations 1810 and 1820 may be performed concurrently or in a single traversal of the conversation data structure.

At operation 1830, the computing system 101 may determine whether the payload size estimate meets or exceeds a byte-level trigger threshold 1706 and/or whether the content-item count meets or exceeds a content-count trigger threshold 1708. If neither trigger threshold is met, the process 1800 may terminate without modifying the conversation data structure, and the computing system 101 may proceed with submitting the original conversation data structure as the inference request payload. If at least one trigger threshold is met, the process 1800 may proceed to operation 1840.

At operation 1840, the computing system 101 may initialize a trimming state data structure that tracks the current payload size estimate, the current content-item count, and target thresholds for each resource dimension. The target thresholds may include a byte-level target threshold 1710 and a content-count target threshold 1712, each of which is lower than the corresponding trigger threshold. In some embodiments, the byte-level target threshold 1710 may be defined as a fraction (e.g., 40%, 50%, 60%) of the maximum request payload size, and the content-count target threshold 1712 may be defined as a fixed count (e.g., half of the content-count trigger threshold 1708).

At operation 1850, the computing system 101 may traverse the conversation data structure in chronological order, beginning with the earliest message and proceeding toward the most recent message. For each message, the computing system 101 may evaluate whether the current resource metrics (payload size estimate and content-item count) are at or below their respective target thresholds. If all target thresholds are satisfied, the computing system 101 may include the remaining messages in the trimmed conversation data structure without modification and proceed to operation 1870 (early termination). If one or more target thresholds are not satisfied, the computing system 101 may proceed to operation 1860 for the current message.

At operation 1860, the computing system 101 may traverse the content blocks within the current message and perform content-type-specific trimming operations. For each content block of the target content type (e.g., an image content block), the computing system 101 may replace the content block with a placeholder indicator 1714, update the trimming state data structure to reflect the reduction in payload size and content-item count, and check whether the target thresholds are now satisfied. For compound content blocks (e.g., tool result content blocks) containing sub-blocks of the target content type, the computing system 101 may selectively replace the target sub-blocks with placeholder indicators 1714 while preserving other sub-blocks, and may construct a new compound content block with the modified sub-block sequence. Content blocks that are not of the target content type may be preserved without modification.

At operation 1870, the computing system 101 may construct a new conversation data structure comprising the trimmed messages. Messages that were not modified during the trimming operations may be included by reference from the original conversation data structure. Messages that were modified may be included as newly constructed message objects containing the modified content block sequences. System-level content (e.g., system prompts) may be preserved from the original conversation data structure.

At operation 1880, the computing system 101 may return the new conversation data structure to the calling component for use as the inference request payload. In some embodiments, the computing system 101 may log metadata about the trimming operations, such as the original and resulting payload size estimates, the original and resulting content-item counts, and/or the number of content items trimmed, for monitoring and diagnostic purposes.

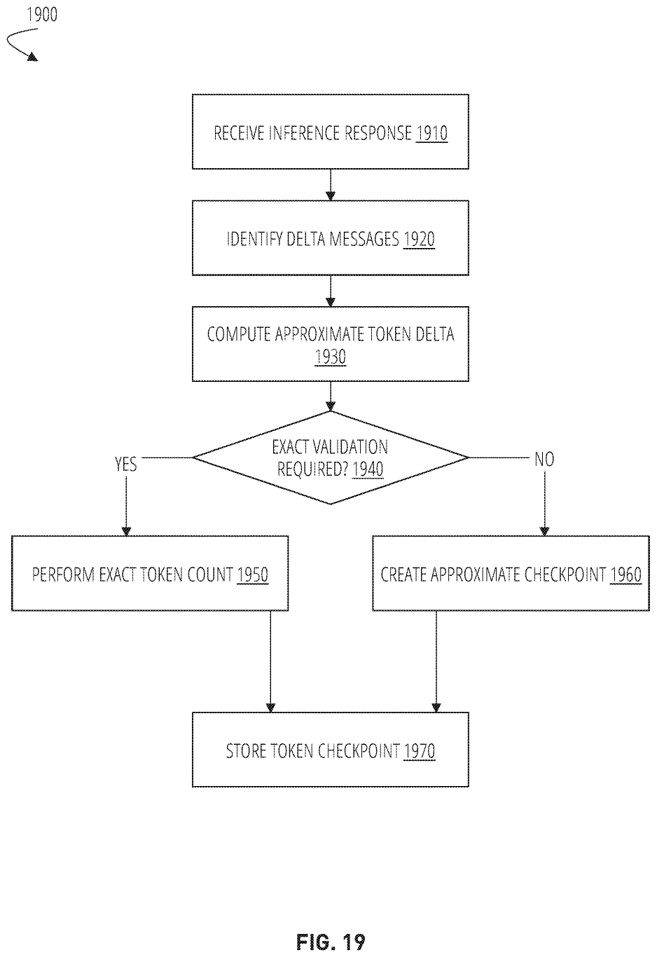

FIG. 19 is a flowchart diagram of an example token checkpoint management process 1900 in accordance with some embodiments of the present disclosure. The process 1900 may be performed by the computing system 101 in conjunction with the token-level resource tracking layer 1704 of the multi-layer inference resource management framework 1700.

FIG. 19 illustrates an example process 1900 for explanatory purposes. Other implementations of FIG. 19 may comprise additional, fewer, or different operations than those depicted in the illustrated example process 1900. Similarly, in some implementations, one or more of the operations depicted in the illustrated example process 1900 may be performed in a different order or in parallel.

At operation 1910, the computing system 101 may receive an inference response from the generative model 408 in response to an inference request submitted on behalf of an agent session 410. The inference response may include one or more generated content blocks (e.g., text content, tool invocations) and a usage report indicating the number of input tokens consumed during the inference operation.

At operation 1920, the computing system 101 may identify a set of delta messages comprising messages added to the conversation data structure since the last token checkpoint. The delta messages may include the model-generated response message and any tool result messages added as a result of tool execution.

At operation 1930, the computing system 101 may compute an approximate token delta for the set of delta messages. Computing the approximate token delta may comprise traversing each content block within each delta message, computing a type-specific character count for each content block, aggregating the type-specific character counts, and dividing the aggregated character count by a character-to-token conversion ratio to produce the approximate token delta. For text content blocks, the type-specific character count may be the character length of the text content. For tool invocation content blocks, the type-specific character count may be the serialized length of the tool input parameters. For compound content blocks, the type-specific character count may be computed recursively. For image content blocks, the type-specific character count may be a fixed token estimate multiplied by the character-to-token conversion ratio to produce a character-equivalent count, or the approximate token delta may directly incorporate the fixed token estimate for image content blocks.

At operation 1940, the computing system 101 may determine whether exact token validation is required. Exact token validation may be required when one or more of the following conditions are satisfied: (i) the approximate token delta exceeds an approximation threshold (e.g., 20,000 characters, 30,000 characters, or any other suitable threshold), (ii) the usage report from the inference response is absent or incomplete, and/or (iii) one or more additional triggering conditions are met (e.g., a configurable number of inference cycles have elapsed since the last exact validation, the cumulative approximate delta since the last exact validation exceeds a cumulative threshold, and/or the like). If exact token validation is required, the process 1900 may proceed to operation 1950. If exact token validation is not required, the process 1900 may proceed to operation 1960.

At operation 1950, the computing system 101 may perform exact token validation by submitting the current conversation data structure to a tokenization service or tokenization algorithm associated with the generative model 408. The tokenization service may apply the model-specific tokenizer to the full conversation data structure, including all messages, content blocks, system instructions, and tool definitions, and may return a precise token count. In some embodiments, performing exact token validation may comprise invoking an API endpoint of the inference service that accepts a conversation data structure and returns a token count without performing inference. Upon receiving the exact token count, the computing system 101 may create a token checkpoint data structure 1716 with the exact token count and an exactness indicator set to indicate exact validation, and the process 1900 may proceed to operation 1970.

At operation 1960, the computing system 101 may create a token checkpoint data structure 1716 based on the model-reported token count from the usage report and the approximate token delta. In some embodiments, the token checkpoint may record the model-reported token count as the checkpoint token count and may record the approximate token delta for use in determining whether exact validation will be required at the next checkpoint. The exactness indicator may be set to indicate that the checkpoint is based on a model-reported value rather than exact validation.

At operation 1970, the computing system 101 may store the token checkpoint data structure 1716 within the agent session 410 data, replacing any previously stored token checkpoint. In some embodiments, the token checkpoint data structure 1716 may be persisted to durable storage (e.g., the data repository 414) to enable recovery of token tracking state in the event of session interruption or system failure. The stored token checkpoint may be used by the adaptive context management framework 600 to determine whether the agent session 410 is approaching the exception threshold 616 of the context window 602, and may trigger context compression operations when the token checkpoint indicates that token consumption meets or exceeds the exception threshold 616.

In some embodiments, the multi-layer inference resource management framework 1700 may be extended to manage additional resource dimensions, such as estimated inference latency, memory consumption, and/or inference cost, each with its own trigger and target thresholds following the same multi-layer pattern described herein.

In some embodiments, the content-type-specific trimming operations may employ content-aware trimming strategies that consider the semantic relevance of content items in addition to their chronological position. For example, the trimming operations may assign a retention score to each content item based on factors such as recency of reference in subsequent messages, similarity to other retained content items, and/or explicit relevance annotations, and may trim content items with the lowest retention scores first while giving chronologically newer items higher baseline scores.

In some embodiments, the pre-inference payload management layer 1702 may implement alternative replacement strategies beyond placeholder text indicators, such as replacing an image content block with a low-resolution thumbnail or a textual description generated by a vision model, preserving semantic content while reducing byte consumption. The selection of replacement strategy may be configurable on a per-content-type basis.

In some embodiments, the token-level resource tracking layer 1704 may maintain a history of token checkpoints across multiple inference cycles, enabling trend analysis of token consumption and prediction of when the agent session 410 will approach the context window 602 limit. The projected time-to-threshold may be provided to the adaptive context management framework 600 for anticipatory triggering of context compression operations.

In some embodiments, the multi-layer inference resource management framework 1700 may operate across heterogeneous generative models 408 within a multi-model agent architecture by maintaining model-specific resource thresholds and estimation parameters for each generative model. The framework 1700 may select resource management parameters dynamically based on the generative model associated with the current inference request, enabling a single agent session 410 to satisfy the distinct resource constraints of each model.

In some embodiments, the multi-layer inference resource management framework 1700 may provide resource management telemetry to monitoring and alerting systems, including metrics such as trigger threshold activation frequency, content items trimmed per activation, byte-level and token-level savings, exact validation frequency, and approximate-to-exact token count divergence, enabling operators to tune thresholds and diagnose resource management issues across a fleet of agent sessions.

F. Execution Environment Recovery with Distributed Coordination

In some embodiments, the computing system 101 may implement an execution environment recovery framework that extends the fault recovery framework 1000 to address failures occurring within shared execution environments that are utilized concurrently by a plurality of worker instances 1002a-b. The execution environment recovery framework may coordinate the detection, classification, and remediation of execution environment failures across distributed worker instances 1002a-b that share access to a common sandboxed execution environment, ensuring that recovery operations are performed exactly once while all affected worker instances 1002a-b are restored to operational status following recovery completion. In this regard, the execution environment recovery framework may improve computer functionality by reducing the frequency and duration of execution environment failures in multi-worker distributed systems, minimizing redundant recovery attempts, and preserving execution progress across environment recovery cycles. As used herein, “sandboxed execution environment” refers to an isolated computing environment that provides computing resources to one or more agent sessions while maintaining isolation from other execution environments and system processes, implemented using containerization technologies, virtualization technologies, cloud-hosted sandbox services, remote development environment platforms, or other isolation mechanisms.

In some embodiments, the execution environment recovery framework may address a class of failures that are distinct from the worker-level failures handled by the fault recovery framework 1000. While the fault recovery framework 1000 may address failures in which a worker instance 1002a-b itself becomes unresponsive (e.g., due to crashes, network partitions, or resource exhaustion), the execution environment recovery framework may address failures in which the underlying execution environment becomes degraded or unresponsive while the worker instances 1002a-b themselves remain operational. In such scenarios, multiple concurrently operating worker instances 1002a-b may simultaneously detect the same environmental failure, necessitating a coordination mechanism that prevents conflicting recovery attempts from interfering with one another.

In some embodiments, the execution environment recovery framework may coordinate recovery operations across all affected worker instances 1002a-b through a distributed locking mechanism that ensures exactly one worker instance performs the recovery operation while other worker instances wait for recovery completion before re-establishing their connections to the recovered environment.

In some embodiments, a sandboxed execution environment may be shared across a plurality of worker instances 1002a-b that are executing concurrently within a multi-worker execution environment. The sandboxed execution environment, for example, may comprise an isolated computing environment that provides file system access, command execution capabilities, network connectivity, and/or other computing resources to agent sessions 410 executing within the multi-worker execution environment. In some examples, the sandboxed execution environment may be provisioned for a parent agent session and subsequently made accessible to one or more child agent sessions that are spawned to perform subtasks on behalf of the parent agent session, such that the parent agent session and the child agent sessions share access to the same sandboxed execution environment.

In some examples, the sandboxed execution environment may comprise at least one of a containerized computing environment, a virtual machine instance, a cloud-hosted execution sandbox, a remote development environment, and/or the like. The sandboxed execution environment may provide resource isolation from other execution environments, ensuring that the agent sessions 410 operating within the environment do not interfere with other agent sessions 410 or system processes operating outside the environment. In some examples, the sandboxed execution environment may expose one or more network-accessible interfaces through which agent sessions 410 may issue commands, access files, and interact with system services within the environment.

In some embodiments, the computing system 101 may maintain an environment identifier that uniquely identifies a sandboxed execution environment across the distributed system. The environment identifier, for example, may be propagated from a parent agent session to child agent sessions during session spawning, enabling each child agent session to connect to the same sandboxed execution environment as the parent agent session. In this manner, a plurality of worker instances 1002a-b executing on different computing nodes (e.g., different physical or virtual servers, different container instances, and/or different pods within a container orchestration platform) may concurrently access the same sandboxed execution environment through network-accessible interfaces identified by the environment identifier.

In some examples, the sandboxed execution environment may comprise a daemon process that manages access to the environment's resources. The daemon process, for example, may listen on one or more network ports and respond to requests from connected worker instances 1002a-b. The daemon process may maintain working directory state, file system state, running process state, and/or other environmental state that persists across individual requests from worker instances 1002a-b.

In some embodiments, the computing system 101 may classify failures occurring within or in connection with the sandboxed execution environment into one or more failure categories to determine appropriate recovery actions. The failure categories, for example, may comprise at least one of a non-retryable failure category, a recoverable failure category, an environment degradation failure category, and/or a transient failure category. As used herein, “environment degradation failure” refers to a failure condition in which a sandboxed execution environment's daemon process or management service has become unresponsive, has crashed and restarted, or has otherwise entered a state that prevents normal operation, while the worker instances that access the environment remain operational, distinguished from transient network errors and worker-level failures.

In some embodiments, a non-retryable failure may comprise a permanent error condition (e.g., resource-not-found errors, invalid-argument errors, insufficient-space errors, and/or command-exit errors) that cannot be resolved through retry or recovery operations, and in response to which the computing system 101 may propagate the failure to the invoking agent session 410 without attempting recovery. A recoverable failure may comprise a transient error condition (e.g., execution environment exceptions, transport-layer errors, network errors, protocol errors, and/or timeout exceptions) that may be resolved through retry operations, and in response to which the computing system 101 may retry the failed operation using an exponential backoff strategy, as described herein.

In some embodiments, an environment degradation failure may comprise a failure that indicates the sandboxed execution environment's daemon process has become unresponsive or has entered a degraded state that requires environment-level recovery rather than operation-level retry. The environment degradation failure, for example, may be distinguished from a simple timeout or transient network error by one or more diagnostic signals that indicate the daemon process is no longer functioning correctly.

In some examples, the environment degradation failure may be detected based on at least one of: (i) a connectivity check failure indicating that one or more expected network ports of the sandboxed execution environment are not responding to connection attempts, (ii) a working directory absence indicating that the expected working directory within the sandboxed execution environment no longer exists or is inaccessible, (iii) a process health check failure indicating that the daemon process is not responding to health check requests, (iv) a file system inconsistency indicating that expected file system structures within the execution environment are missing or corrupted, and/or (v) other signals indicating environmental degradation beyond a simple transient failure.

In some examples, the environment degradation failure may be detected by examining the content of error messages returned by failed operations. For instance, a timeout error whose message indicates that a network port is not open may be classified as an environment degradation failure rather than a simple timeout, because the port closure suggests that the daemon process has crashed or restarted rather than merely being slow to respond. Similarly, an argument validation error whose message indicates that the expected working directory does not exist may be classified as an environment degradation failure because the absence of the working directory suggests that the execution environment has been reset or corrupted.

In some embodiments, the computing system 101 may implement a hierarchical failure classification that evaluates failure conditions in a defined order. The hierarchical classification, for example, may first determine whether the failure is a non-retryable failure, then determine whether the failure is an environment degradation failure, and then determine whether the failure is a recoverable failure. In some examples, the hierarchical classification may ensure that environment degradation failures are detected and handled through environment-level recovery even when they manifest as exception types (e.g., timeout exceptions or argument validation exceptions) that would otherwise be classified as retryable or non-retryable failures.

In some embodiments, the computing system 101 may implement a distributed recovery coordination mechanism to ensure that recovery operations for a shared sandboxed execution environment are performed exactly once when multiple worker instances 1002a-b simultaneously detect an environment degradation failure. The distributed recovery coordination mechanism, for example, may leverage a distributed locking primitive to designate a single worker instance as the recovery coordinator while other affected worker instances wait for recovery completion.

In some embodiments, the distributed locking primitive may comprise an atomic conditional-write operation on a distributed key-value store. The atomic conditional-write operation, for example, may comprise a set-if-not-exists operation that atomically writes a lock value to a specified key only if the key does not already exist, returning a success indication to the worker instance that successfully wrote the value (the lock holder) and a failure indication to all other worker instances that attempted the operation concurrently. The lock key, for example, may be derived from the environment identifier of the sandboxed execution environment, ensuring that the lock is scoped to the specific environment undergoing recovery. As used herein, “atomic conditional-write operation” refers to an operation on a distributed data store that writes a value to a specified key only if the key does not already exist, with the existence check and write performed as a single atomic operation, implementable using set-if-not-exists primitives, compare-and-swap operations, conditional-insert operations, or other atomic primitives providing mutual exclusion guarantees.

In some embodiments, the distributed lock may be associated with a time-to-live interval that specifies a maximum duration for which the lock remains valid. The time-to-live interval, for example, may ensure that the lock is automatically released if the lock holder fails during the recovery operation, preventing indefinite blocking of other worker instances 1002a-b that are waiting for recovery completion. In some examples, the time-to-live interval for the recovery lock may be configured independently from the time-to-live interval for task assignment locks described in connection with the fault recovery framework 1000, enabling the recovery lock duration to be tuned to the expected duration of execution environment recovery operations.

In some embodiments, upon successful acquisition of the distributed lock, the lock-holding worker instance may perform an environment recovery operation comprising a pause-resume cycle on the sandboxed execution environment. The pause-resume cycle, for example, may comprise: (i) issuing a pause command to the sandboxed execution environment to suspend execution of the environment's processes and preserve the environment's state, (ii) waiting for a configurable quiescence interval to allow the environment to fully quiesce and release any resources that may be in a degraded state, and (iii) allowing the environment to resume from its preserved state, thereby restoring the daemon process and associated resources to an operational condition. As used herein, “pause-resume cycle” refers to a recovery operation in which a sandboxed execution environment is suspended to persist its current state and then restored from the persisted state to re-establish operational functionality, preserving file system contents, running processes, environment configurations, and other state across the recovery event.

In some examples, the pause command may cause the sandboxed execution environment to persist its current state, including file system contents, running process state, environment variable configurations, and/or network configurations, to durable storage before suspending execution. The resume operation may then restore the environment from the persisted state, enabling the environment to continue from its prior state rather than being reinitialized from a clean state. In this manner, the pause-resume cycle may preserve work products, intermediate computation results, installed software packages, and/or other environmental state that was established during prior agent session operations within the environment.

In some embodiments, upon completion of the pause-resume cycle, the lock-holding worker instance may release the distributed lock by deleting the lock key from the distributed key-value store. The lock release may signal to waiting worker instances 1002a-b that the recovery operation has completed and that the sandboxed execution environment is ready to accept new connections.

In some embodiments, worker instances 1002a-b that fail to acquire the distributed lock (i.e., non-lock-holding worker instances) may enter a wait state in which they periodically poll the distributed key-value store to determine whether the lock has been released. In some examples, the polling may be performed at a configurable interval (e.g., one second) until either the lock is released (indicating successful recovery completion) or the lock's time-to-live interval expires (indicating that the lock holder may have failed during recovery). In some examples, the maximum wait duration for non-lock-holding worker instances may be bounded by the time-to-live interval of the recovery lock, preventing indefinite waiting in the event that the lock holder fails.

In some examples, upon detecting that the distributed lock has been released, the non-lock-holding worker instances may proceed to reconnect to the recovered sandboxed execution environment using the same reconnection procedure as the lock-holding worker instance. In this manner, all affected worker instances 1002a-b may be restored to operational status following a single coordinated recovery operation, rather than each worker instance independently attempting recovery.

In some embodiments, following completion of the environment recovery operation (whether performed by the lock-holding worker instance or detected through lock release by a non-lock-holding worker instance), each affected worker instance 1002a-b may re-establish its connection to the sandboxed execution environment through a reconnection operation. The reconnection operation, for example, may comprise establishing a new network connection to the sandboxed execution environment using the environment identifier and re-authenticating with any required credentials.

In some embodiments, the reconnection operation may be performed with a configurable retry policy comprising an exponential backoff strategy. The exponential backoff strategy, for example, may comprise retrying the reconnection operation a configurable maximum number of times (e.g., five attempts), with a wait interval between successive retry attempts that increases exponentially from a configurable minimum interval (e.g., one second) up to a configurable maximum interval (e.g., fifteen seconds). In some examples, the exponential backoff strategy may reduce contention on the sandboxed execution environment during the period immediately following recovery, when the environment may be handling reconnection attempts from multiple worker instances 1002a-b simultaneously.

In some examples, the retry policy may further comprise a retry eligibility determination that evaluates whether a failed reconnection attempt should be retried based on the failure classification of the error. For example, the retry policy may retry reconnection attempts that fail with recoverable errors (e.g., transport-layer errors, network errors, protocol errors, and execution environment exceptions) while not retrying reconnection attempts that fail with non-retryable errors (e.g., resource-not-found errors, invalid-argument errors, and insufficient-space errors). In this manner, the retry policy may avoid wasting computational resources on reconnection attempts that cannot succeed due to permanent error conditions.

In some embodiments, the computing system 101 may implement a transparent recovery mechanism that intercepts failures occurring during agent session operations on the sandboxed execution environment and automatically initiates recovery without requiring explicit failure handling by the agent session 410. The transparent recovery mechanism, for example, may comprise a wrapper that is applied to one or more methods of an execution environment interface used by agent sessions 410 to interact with the sandboxed execution environment.

In some embodiments, the wrapper may intercept exceptions raised by the underlying execution environment interface method and evaluate whether the exception indicates an environment degradation failure or a timeout failure that warrants environment-level recovery. In response to detecting such a failure, the wrapper may invoke the distributed recovery coordination mechanism to perform or await environment recovery, and then re-invoke the original method on the recovered execution environment. In this manner, the agent session 410 may transparently recover from execution environment failures without requiring the agent session 410 to implement explicit recovery logic, and the recovery may be performed while preserving the state of the agent session's conversation history, pending operations, and/or workspace contents.

In some examples, the transparent recovery mechanism may emit observability signals comprising at least one of metric increments, structured log entries, and/or trace annotations that indicate the occurrence of a recovery operation, whether the recovery was successful or failed, whether the failure involved environment degradation, and/or the identity of the recovered execution environment. The observability signals may enable monitoring systems to track the frequency and success rate of execution environment recovery operations across the distributed system.

In some embodiments, in response to a successful recovery, the wrapper may re-invoke the original method that triggered the failure, enabling the agent session 410 to continue its operation from the point of failure rather than requiring the entire operation to be restarted. In response to a failed recovery (e.g., when the recovery operation itself raises an exception), the wrapper may propagate the recovery failure to the agent session 410, enabling the agent session 410 or the fault recovery framework 1000 to escalate to task-level recovery mechanisms such as task reassignment to a different worker instance 1002b.

In some embodiments, the execution environment recovery framework may integrate with the registration record 1016 and pending operation recovery mechanisms described in connection with the fault recovery framework 1000. For example, when an agent session 410 is performing an operation that is registered as a pending operation in the registration record 1016, and an environment degradation failure occurs during the operation, the execution environment recovery framework may first recover the sandboxed execution environment and re-establish execution environment connectivity, and then the pending operation recovery mechanism may resume the operation using the recovery data stored in the registration record 1016.

In some embodiments, the execution environment recovery framework may provide one or more technical effects that improve the functioning of a computer or other computing device. For example, the execution environment recovery framework may reduce the number of failed agent task executions by automatically recovering shared execution environments from degradation failures that would otherwise require manual intervention or complete task restart. The distributed coordination mechanism may prevent redundant recovery operations by ensuring that only one worker instance performs the pause-resume cycle while other worker instances wait, with the reduction in redundant operations proportional to the number of worker instances sharing the environment.

In some embodiments, the execution environment recovery framework may reduce the latency of task completion by enabling recovery at the execution environment level rather than the task level, allowing the worker instance to retain its task assignment, conversation history, pending operation state, and/or workspace state throughout the recovery process and avoiding the overhead of task reassignment, state transfer, and context reconstruction. The recovery framework may further reduce computational waste by preserving execution environment state across recovery events, reducing the need to recreate execution context, reinitialize operation-specific resources, and reconstruct prior interaction context.

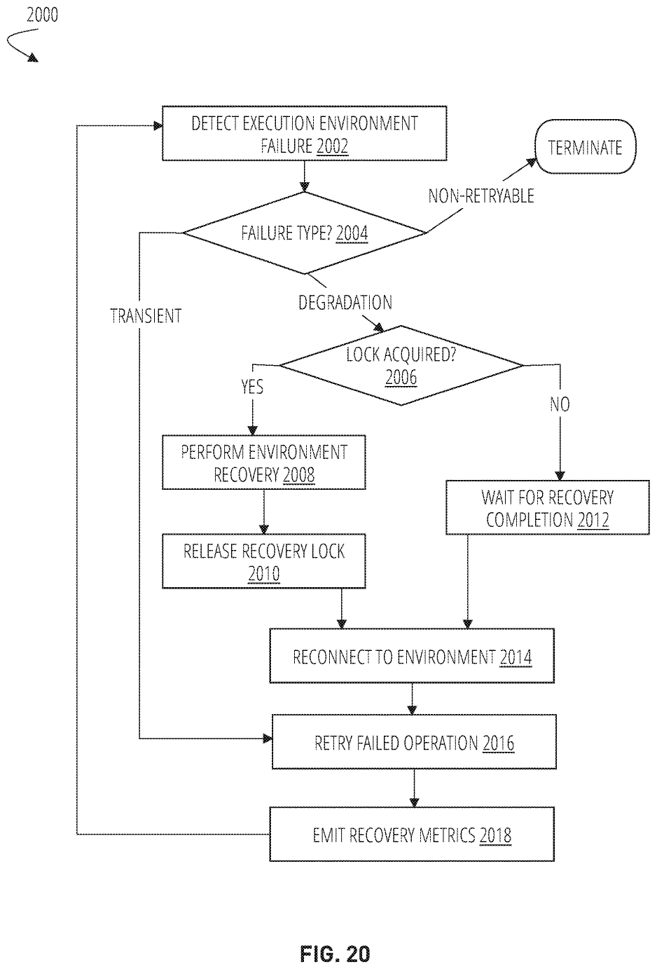

FIG. 20 is a flowchart diagram of an example execution environment recovery process 2000 in accordance with some embodiments of the present disclosure. The flowchart diagram depicts a coordinated recovery technique for restoring shared sandboxed execution environments and associated execution-environment connectivity following environment degradation failures. The process 2000 may be implemented by one or more computing devices, entities, and/or systems described herein. For example, via the various steps/operations of the process 2000, the computing system 101 may detect an environment degradation failure in a shared sandboxed execution environment, coordinate recovery across distributed worker instances through a distributed locking mechanism, and re-establish execution-environment connectivity following recovery. By doing so, the process 2000 may improve computer functionality by enabling coordinated recovery from execution environment failures with minimal disruption to ongoing agent task execution.

FIG. 20 illustrates an example process 2000 for explanatory purposes. Although the example process 2000 depicts a particular sequence of steps/operations, the sequence may be altered without departing from the scope of the present disclosure. For example, some of the steps/operations depicted may be performed in parallel or in a different sequence that does not materially impact the function of the process 2000. In other examples, different components of an example device or system that implements the process 2000 may perform functions at substantially the same time or in a specific sequence.

In some embodiments, the process 2000 comprises, at operation 2002, detecting an execution environment failure. For example, a worker instance 1002a executing an agent task 1010 within a sandboxed execution environment may receive an error response from the sandboxed execution environment in connection with an operation attempted by the agent session 410. The worker instance 1002a may evaluate the error response to determine a failure classification, as described herein.

In some examples, the evaluation may comprise examining the error type and the error message content to distinguish among non-retryable failures, environment degradation failures, and recoverable transient failures. In some examples, the worker instance 1002a may determine that the error response indicates an environment degradation failure based on one or more of: a port connectivity failure signal within a timeout error, a working directory absence signal within an argument validation error, a process health check failure, and/or other diagnostic signals as described herein.

In some embodiments, the process 2000 comprises, at operation 2004, classifying the failure. For example, the computing system 101 may classify the detected failure into one of the failure categories described herein. In some examples, if the failure is classified as a non-retryable failure, the process 2000 may terminate and propagate the failure to the agent session 410. In some examples, if the failure is classified as a recoverable transient failure (but not an environment degradation failure), the process 2000 may proceed to operation 2016 to retry the operation with exponential backoff without performing environment-level recovery. In some examples, if the failure is classified as an environment degradation failure, the process 2000 may proceed to operation 2006 to initiate coordinated recovery.

In some embodiments, the process 2000 comprises, at operation 2006, attempting to acquire a distributed recovery lock. For example, the worker instance 1002a may perform an atomic conditional-write operation on a distributed key-value store to write a lock value to a lock key derived from the environment identifier of the sandboxed execution environment. The atomic conditional-write operation may be associated with a time-to-live interval, as described herein. If the atomic conditional-write operation succeeds (i.e., the lock was acquired), the process 2000 may proceed to operation 2008. If the atomic conditional-write operation fails (i.e., the lock was already held by another worker instance), the process 2000 may proceed to operation 2012.

In some embodiments, the process 2000 comprises, at operation 2008, performing an environment recovery operation. For example, the lock-holding worker instance may issue a pause command to the sandboxed execution environment to suspend the environment and preserve its current state. Following the pause command, the lock-holding worker instance may wait for a configurable quiescence interval (e.g., five seconds) to allow the environment to fully quiesce before allowing the environment to resume from its preserved state. In some examples, the pause and resume operations may be performed with the retry policy described herein, enabling recovery from transient failures during the recovery operation itself.

In some embodiments, the process 2000 comprises, at operation 2010, releasing the distributed recovery lock. For example, the lock-holding worker instance may delete the lock key from the distributed key-value store, signaling to any waiting worker instances that the recovery operation has completed. In some examples, the lock release may be performed within a guaranteed execution block (e.g., a finally clause or equivalent construct) that ensures the lock is released even if the recovery operation raises an exception, preventing indefinite blocking of other worker instances.

In some embodiments, the process 2000 comprises, at operation 2012, waiting for recovery completion. For example, a non-lock-holding worker instance may periodically poll the distributed key-value store at a configurable interval (e.g., one second) to determine whether the lock key has been removed. In some examples, the polling may continue until either the lock key is absent (indicating that the recovery operation has completed) or a maximum wait duration (e.g., corresponding to the time-to-live interval of the recovery lock) has elapsed.

In some embodiments, the process 2000 comprises, at operation 2014, reconnecting to the execution environment. For example, upon completion of the environment recovery operation (whether performed by the current worker instance at operation 2008 or detected through lock release at operation 2012), the worker instance may establish a new connection to the sandboxed execution environment. In some examples, the reconnection may be performed with the retry policy and exponential backoff strategy described herein.

In some embodiments, the process 2000 comprises, at operation 2016, retrying the failed operation. For example, the worker instance may re-invoke the operation that originally triggered the failure at operation 2002. In some examples, if the operation succeeds, the process 2000 may complete and return the operation result to the agent session 410. In some examples, if the operation fails again, the process 2000 may return to operation 2002 to re-evaluate the failure and determine whether additional recovery attempts are warranted, subject to the configurable maximum retry count described herein.

In some embodiments, the process 2000 comprises, at operation 2018, emitting recovery observability signals. For example, the worker instance may emit one or more metric increments, structured log entries, and/or trace annotations indicating the occurrence and outcome of the recovery operation. In some examples, the observability signals may include indicators of whether the recovery was successful, whether the failure involved environment degradation, the identity of the recovered execution environment, and/or the duration of the recovery operation.

In some embodiments, the execution environment recovery framework may be combined with the fault recovery framework 1000 in a layered recovery architecture, wherein the execution environment recovery framework serves as a first-level recovery mechanism and, if first-level recovery fails, the fault recovery framework 1000 serves as a second-level mechanism that reassigns the task to a different worker instance 1002b with access to a different sandboxed execution environment.

In some embodiments, the execution environment recovery framework may maintain recovery statistics tracking the frequency, duration, and success rate of recovery operations for each sandboxed execution environment, enabling the computing system 101 to proactively migrate agent tasks 1010 to healthier execution environments or provision replacement environments before failures occur.

In some embodiments, the configurable parameters of the execution environment recovery framework (e.g., recovery lock time-to-live interval, quiescence interval, retry policy parameters, and polling interval) may be specified as system-level configuration parameters adjustable without code modification and tunable based on characteristics of the sandboxed execution environment.

In some embodiments, the execution environment recovery framework may support recovery of multiple execution environment types within a single agent session 410 (e.g., a sandboxed code execution environment and an additional sandboxed execution environment), recovering each independently through environment-specific lock keys derived from each environment's unique identifier.

In some embodiments, the execution environment recovery framework may implement a recovery cooldown mechanism that records a recovery timestamp following each recovery operation and suppresses additional recovery attempts for a configurable cooldown interval, preventing thrashing scenarios in which an environment repeatedly enters a degraded state and triggers rapid successive recovery operations.

### G. Scheduler Queue Isolation, Atomic Task Completion, and Multi-Model Sequential Retry

In some embodiments, the computing system 101 may implement workload-class-based queue isolation to prevent resource contention between heterogeneous task categories in a distributed task scheduling system. The computing system 101 may maintain a plurality of logically distinct task queues, where each queue is associated with a respective workload class, and may route incoming tasks to a target queue based on a classification of the task's workload class. By segregating tasks into class-specific queues, the computing system 101 may enable independent resource allocation, admission control, and scheduling policies for each workload class. As used herein, “workload class” refers to a classification category that groups tasks according to one or more of their origin, priority level, scheduling characteristics, or resource consumption profile, where tasks within the same workload class share common scheduling policies, claim limits, and worker allocation preferences. As used herein, “task queue” refers to an ordered task store that holds task identifiers eligible for processing, where ordering is determined by readiness values (e.g., timestamps) indicating when corresponding tasks become ready for execution and where claim/update operations may be performed atomically. In some examples, the ordered task store may be maintained in a distributed data store.

In some embodiments, the computing system 101 may maintain at least a first task queue associated with a first workload class and a second task queue associated with a second workload class. For example, the first workload class may correspond to interactive, user-initiated tasks that are expected to be processed with low latency, and the second workload class may correspond to background, time-triggered tasks (such as those initiated by periodic schedule triggers) for which latency constraints are relaxed relative to the first workload class.

In some embodiments, each of the plurality of task queues may be implemented using an ordered task store that supports readiness-ordered retrieval and atomic claim updates. In some examples, a given implementation may use a sorted set data structure in a distributed key-value store, where each entry in the sorted set corresponds to a task identifier and the associated score value represents a timestamp at which the task becomes eligible for processing. This structure may enable efficient retrieval of ready tasks by score range and may support atomic claim operations using server-side scripts.

In some embodiments, the computing system 101 may determine the target queue for a task based on a task type attribute associated with the task. For example, when a parent agent spawns a sub-agent task, the computing system 101 may inspect a sub-agent type indicator associated with the spawned task and may route the task to the second task queue (the background task queue) when the sub-agent type indicator corresponds to one or more scheduled-execution types (e.g., types designated for periodic or cron-triggered execution). Otherwise, the computing system 101 may route the task to the first task queue (the interactive task queue). In some examples, the sub-agent type indicator may be one of a plurality of enumerated type values, and the computing system 101 may maintain a mapping that associates a subset of the enumerated type values with the background task queue and the remaining enumerated type values with the interactive task queue.

In some embodiments, the computing system 101 may enforce independent claim limits for each task queue. For example, the computing system 101 may configure a first maximum claim count for the first task queue and a second maximum claim count for the second task queue, such that the number of tasks claimed from each queue in a single polling cycle does not exceed the respective claim limit. This independent limiting may prevent a burst of background tasks from consuming all available worker capacity and may preserve a guaranteed minimum capacity allocation for interactive tasks.

In some embodiments, the computing system 101 may assign each worker process a role designation that specifies which subset of task queues the worker polls: an interactive role (first queue only), a background role (second queue only), or a combined role (both queues). This role-based partitioning may allow an operator to dedicate hardware resources to specific workload classes.

In some embodiments, each worker process may maintain a concurrency budget representing a maximum number of concurrently active tasks. The worker process may compute a remaining capacity value by subtracting the number of currently active tasks from the concurrency budget, and may use the remaining capacity value as the claim limit when polling each task queue. In some examples, the remaining capacity may be applied as a ceiling on the number of tasks claimed from each queue independently, such that both queues share the same pool of concurrent execution slots but are polled independently.

In some embodiments, the computing system 101 may collect per-queue telemetry metrics, including queue wait time distributions and claim counts per queue type. The computing system 101 may emit a queue wait metric for each claimed task, computed as the difference between the current time and the score value associated with the claimed task identifier. Queue type labels attached to the telemetry data may enable differential monitoring and alerting for interactive versus background workload performance.

In some embodiments, the computing system 101 may extend the workload-class-based queue isolation pattern to support more than two workload classes. For example, the computing system 101 may introduce additional task queues for priority classes such as real-time, best-effort, or batch, and may route tasks to the appropriate queue based on a priority indicator, a service-level objective, or a combination of task attributes.

In some embodiments, the computing system 101 may implement an atomic task completion operation that prevents orphaned follow-up messages in an asynchronous, multi-agent task execution environment. When a task completes execution, the computing system 101 may atomically verify whether any follow-up messages have been enqueued for the completing task and may conditionally either remove the task from the execution queue or re-queue the task for additional processing based on the verification result.

In some embodiments, the atomic task completion operation may be implemented as a server-side atomic script executing within a distributed key-value store. The atomic script may receive as inputs a reference to the task execution queue, a reference to a per-task follow-up message queue, a task identifier, a current timestamp, and a discard indicator, and may perform a single indivisible operation that: (a) determines the follow-up message queue length; (b) removes the task and deletes the follow-up queue when the discard indicator is set or the queue is empty; or (c) updates the task's score to the current timestamp to make it immediately re-claimable when follow-up messages are pending. As used herein, “atomic script” refers to one example implementation of an atomic operation, comprising a sequence of instructions executed as a single indivisible unit of work within a data store, such that no other operation may observe or modify the data structures accessed by the script during its execution. As used herein, “follow-up message queue” refers to a per-task ordered list data structure that holds messages submitted for a task during or after its execution, including user continuation messages, sub-agent completion results, user-provided answers to questions, and action confirmation responses.

In some embodiments, the atomic script may return the number of follow-up messages present at evaluation time, enabling the calling worker to determine whether the task was re-queued or removed and to emit metrics accordingly.

In some embodiments, the computing system 101 may implement a complementary atomic follow-up enqueue operation that atomically appends a follow-up message to the per-task follow-up message queue and updates the task's score in the execution queue to the current timestamp. This indivisible dual update may prevent orphaned follow-up messages that would otherwise go unprocessed if a failure occurred between the two steps.

In some embodiments, the per-task follow-up message queue may be implemented as a first-in-first-out list structure in the distributed key-value store, preserving the temporal ordering of follow-up events.

In some embodiments, the computing system 101 may provide a discard mode for task completion. When a task completes in an error state, the discard indicator causes the atomic script to remove the task and delete all pending follow-up messages regardless of queue length, preventing an infinite re-queue loop in which arriving follow-ups repeatedly re-surface a fatally errored task.

In some embodiments, the computing system 101 may coordinate the atomic task completion operation with a heartbeat mechanism. A worker process may periodically extend the task's processing lease by updating its score to a future timestamp, and may stop the heartbeat before invoking the completion operation to prevent score overwrites. The heartbeat extension may use conditional update semantics (e.g., update only if the new score exceeds the existing score and the entry still exists) to avoid re-inserting a task already removed by the completion operation.

In some embodiments, the per-task follow-up message queue may accept heterogeneous follow-up message types. For example, follow-up messages may include one or more of: a user-initiated continuation message, a sub-agent completion result (including a sub-agent identifier, task name, status indicator, and optional result or error payload), an answer to a previously posed question, or a confirmation of a previously requested action. Each follow-up message may include a type discriminator that enables the consuming agent to process the follow-up according to its type-specific semantics.

In some embodiments, the computing system 101 may support selective follow-up deletion. Before a follow-up message is consumed by the agent, an external system (such as a user interface or an administrative controller) may request deletion of a specific follow-up by its unique identifier. The computing system 101 may scan the follow-up message queue for the specified identifier and remove the matching entry, enabling cancellation or retraction of queued inputs before they affect agent behavior.

In some embodiments, the computing system 101 may implement an atomic batch claim operation for retrieving ready tasks from the task execution queue. The batch claim operation may be implemented as an atomic script that identifies all task entries with score values less than or equal to a current timestamp (indicating readiness), updates the score values of the identified entries to a future timestamp (establishing a lease), and returns the claimed entries, all as a single indivisible operation. The atomic nature of the batch claim may prevent multiple workers from claiming the same task entry. In some examples, the lease duration may be configurable, and a task whose lease expires without being extended or completed may become eligible for re-claiming by another worker, providing automatic recovery from worker failures.

In some embodiments, the computing system 101 may implement a multi-model sequential retry policy for fault-tolerant inference in a heterogeneous model ecosystem. Rather than retrying a failed inference request against the same model, the computing system 101 may employ a retry policy that specifies an ordered sequence of model-specific retry configurations, where each configuration identifies a model and an associated per-model retry policy. The computing system 101 may attempt inference using the models in sequence, exhausting the per-model retry budget for each model before advancing to the next model in the sequence. As used herein, “multi-model retry policy” refers to a declarative specification of how inference failures should be handled across a plurality of machine learning models, defining an ordered sequence of model-specific retry policies and a composition strategy governing how the model-specific policies are applied in relation to one another.

In some embodiments, the multi-model sequential retry policy may be expressed as a declarative data structure comprising an ordered list of model-policy pairs and a strategy indicator. Each model-policy pair may specify a model identifier and an associated retry policy, and the strategy indicator may govern composition order; for example, a sequential strategy indicates that each model-policy pair's retry budget is fully exhausted before advancing to the next pair. As used herein, “sequential strategy” refers to a composition strategy for a multi-model retry policy in which the retry budget of each model-specific policy is fully exhausted before advancing to the next model in the sequence.

In some embodiments, the per-model retry policy within each model-policy pair may be a round-robin retry policy specifying independently configurable retry rounds. For example, a first model-policy pair may specify N retry rounds and a second may specify M retry rounds; under the sequential strategy, the computing system 101 may attempt inference using the first model up to N times and, upon exhaustion, may attempt the second model up to M times, allowing an operator to allocate more retries to a preferred model and fewer to a fallback model.

In some embodiments, the computing system 101 may associate model-specific configuration parameters with each model in the fallback chain. For example, the computing system 101 may maintain a mapping from model identifiers to reasoning effort levels that control the amount of intermediate reasoning computation performed during inference. A first model in the chain may be invoked with extended reasoning enabled, while a fallback model may be invoked with reasoning disabled or reduced, reflecting different capability profiles.

In some embodiments, the multi-model sequential retry policy may be defined on a per-model basis in a global retry policy mapping. The computing system 101 may maintain a mapping from primary model identifiers to their associated multi-model retry policies, such that when an inference request specifies a primary model, the computing system 101 may look up the corresponding multi-model retry policy and apply it to govern retry behavior for that inference request. Models that do not have an entry in the mapping may use a default retry policy (e.g., a simple retry policy without model fallback).

In some embodiments, the multi-model sequential retry policy may support strategy indicators other than sequential. For example, a parallel strategy may indicate that the computing system 101 should dispatch inference requests to multiple models concurrently and use the first successful response, or a weighted strategy may indicate that retry attempts should be distributed across models according to specified weights. The sequential strategy may be preferred when minimizing resource consumption is a priority, as it avoids redundant parallel inference invocations.

In some embodiments, the computing system 101 may implement transport-level retry logic independently of the model-level retry policy. A transport retry layer may handle transient communication failures (e.g., connection errors) with exponential backoff and jitter, while the model-level retry policy may handle inference errors, rate limits, or quality degradation at a higher layer. This layered architecture may provide composable fault tolerance where network and model failures are addressed by distinct mechanisms.

In some embodiments, the computing system 101 may select the initial model for an inference request through a use-case mapping chain: a first mapping from sub-agent type indicators to model use-case identifiers, and a second mapping from use-case identifiers to model identifiers. This indirection may allow different task categories to use different model configurations and associated multi-model retry policies without modifying the retry infrastructure.

The computing system 101 may receive a task for execution in a distributed task processing environment. The task may be associated with a task identifier, a task type attribute, and task payload data. The computing system 101 may determine a workload class for the received task based on the task type attribute. In some examples, the computing system 101 may evaluate whether the task type attribute corresponds to a scheduled-execution type by comparing the task type attribute against a set of scheduled-execution type indicators. If the task type attribute matches one of the scheduled-execution type indicators, the computing system 101 may assign the task to a background workload class. Otherwise, the computing system 101 may assign the task to an interactive workload class. The computing system 101 may enqueue the task in a task queue corresponding to the determined workload class. The computing system 101 may store the task payload data in a data store entry keyed by the task identifier, and may insert the task identifier into the appropriate task queue with a score value corresponding to a timestamp at which the task should become eligible for processing. In some examples, for immediately executable tasks, the score value may be set to the current time; for deferred tasks, the score value may be set to a future time. A worker process may claim the task from the task queue by executing an atomic batch claim operation. The atomic batch claim operation may identify one or more task entries with score values less than or equal to the current time, may update the score values of the identified entries to a future timestamp (establishing a processing lease), and may return the claimed task identifiers to the worker process. As used herein, “processing lease” refers to a time-bounded claim on a task in the task queue, established by updating the task's score to a future timestamp, preventing other workers from claiming the task during the lease period while allowing automatic re-surfacing if the lease expires without renewal. The worker process may execute the task. During execution, the worker process may periodically extend the task's processing lease by updating the task's score value in the task queue to a future timestamp using conditional update semantics, such that the update succeeds only if the task entry still exists in the queue and the new score is greater than the existing score. Upon completion of task execution, the worker process may stop the periodic lease extension and may invoke an atomic task completion operation. The atomic task completion operation may atomically inspect a per-task follow-up message queue associated with the task identifier. If the follow-up message queue is empty (or if a discard indicator is active), the atomic task completion operation may remove the task identifier from the task queue and delete the follow-up message queue. If the follow-up message queue is non-empty and the discard indicator is not active, the atomic task completion operation may update the task's score to the current time, making the task immediately eligible for re-claiming by a worker so that the pending follow-up messages may be processed. If the task was re-queued during the completion step due to pending follow-up messages, a worker process (which may be the same or a different worker process) may claim the task, consume the pending follow-up messages from the head of the follow-up message queue, and resume execution of the task with the follow-up messages incorporated into the task's execution context. The computing system 101 may receive a request to perform an inference operation using a specified primary model. The computing system 101 may look up a multi-model retry policy associated with the specified primary model in a retry policy mapping. The computing system 101 may identify the first model-policy pair in the ordered sequence defined by the multi-model retry policy. The first model-policy pair may specify a first model identifier and a first per-model retry policy with a first retry budget (e.g., N rounds). The computing system 101 may attempt the inference operation using the first model, applying any model-specific configuration parameters (such as reasoning effort level) associated with the first model identifier. If the inference operation succeeds, the computing system 101 may return the inference result and the method may terminate. If the inference operation fails, the computing system 101 may decrement the first retry budget. If the first retry budget has not been exhausted, the computing system 101 may return to the inference attempt step to retry the inference operation using the first model. If the first retry budget has been exhausted without a successful inference result, the computing system 101 may advance to the next model-policy pair in the ordered sequence. The next model-policy pair may specify a second model identifier and a second per-model retry policy with a second retry budget (e.g., M rounds). The computing system 101 may attempt the inference operation using the second model, applying any model-specific configuration parameters associated with the second model identifier. The computing system 101 may repeat the retry logic of the foregoing retry operations using the second model and the second retry budget. If the second retry budget is also exhausted without a successful inference result, the computing system 101 may either advance to a further model-policy pair if one exists, or may propagate a failure indication to the calling process if all model-policy pairs have been exhausted.

In some embodiments, the combination of workload-class-based queue isolation, atomic task completion, and multi-model retry policies may provide one or more technical effects, including isolating background tasks from interactive workloads, guaranteeing atomicity of task completion with respect to concurrently arriving follow-up messages, and routing inference failures through structured model fallback chains, yielding a fault-tolerant task execution infrastructure for autonomous agent systems.

### H. Cross-System Integration and Compound Inventive Combinations

In some embodiments, the computing system 101 may implement an ordered pre-inference processing pipeline that executes a plurality of processing stages in a defined sequence prior to each inference request submitted on behalf of an agent session 410. By composing the processing stages into a deterministic pipeline, the computing system 101 may ensure that the conversation data structure satisfies all applicable constraints before the inference request is submitted, thereby reducing inference failures, context inconsistencies, and security vulnerabilities that would arise from uncoordinated or omitted processing.

In some embodiments, the ordered pre-inference processing pipeline may comprise at least three processing stages executed in the following order: (i) a first stage comprising a follow-up message draining operation, as described herein, in which the computing system 101 retrieves and incorporates pending follow-up messages (e.g., user continuation messages, sub-agent completion results, confirmation responses) into the conversation data structure so that the conversation reflects the most current state of external interactions before resource management operations are applied; (ii) a second stage comprising a token-level context management operation, as described herein, in which the computing system 101 evaluates whether the conversation data structure exceeds a token-level utilization threshold and, if so, applies context compression operations and clears dependent session-state records such as described-tool authorization records and stale source references; and (iii) a third stage comprising a payload-level resource management operation, as described herein, in which the computing system 101 evaluates whether the conversation data structure exceeds payload-level resource thresholds and, if so, applies content-type-specific trimming operations and creates a new token checkpoint reflecting the post-trimming state.

In some embodiments, the ordering of the processing stages may be significant: the follow-up message draining operation may be performed first so that newly incorporated messages are subject to compression if necessary, and the token-level context management operation may be performed before the payload-level resource management operation so that token-level compression reduces conversation size before payload-level trimming is evaluated. One or more of the processing stages may be independently omittable when the corresponding threshold is not exceeded. The computing system 101 may instrument each processing stage with latency metrics for monitoring per-stage processing overhead.

In some embodiments, the computing system 101 may execute the tool output security classification operation, as described herein, concurrently with the primary agent inference operation. The computing system 101 may dispatch both operations as parallel asynchronous tasks, await completion of both, and log or emit telemetry when the classification operation trails the primary inference operation, indicating classification-induced latency overhead.

In some embodiments, in response to a negative detection result (i.e., no adversarial content detected), the computing system 101 may return the primary inference result without modification, adding no incremental latency when classification completes no later than primary inference. In response to a positive detection result where the primary inference result includes tool invocation requests, the computing system 101 may inject warning annotations into untrusted tool-result content and re-invoke the primary language model with the modified conversation context. Where the primary inference result does not include tool invocation requests, the computing system 101 may return the primary inference result without modification.

In some embodiments, the computing system 101 may implement a layered safety architecture that applies distinct safety mechanisms at multiple stages of a tool invocation lifecycle comprising at least: (i) a pre-invocation stage, (ii) a tool execution stage, (iii) a post-execution stage, and (iv) a pre-action stage. At the pre-invocation stage, the computing system 101 may apply the schema-gated authorization check described herein. At the post-execution stage, the computing system 101 may apply the tool output security classification operation described herein. At the pre-action stage, the computing system 101 may apply a user confirmation gating operation, as described herein, that requires explicit user approval before executing tool invocations with irreversible external effects, triggered by tool-level destructive capability annotations, entity-count thresholds for batch operations, and/or system prompt policies.

In some embodiments, the three safety mechanisms may operate independently and may each prevent a distinct category of safety violation: schema-gated authorization may prevent invocation of unknown or undescribed tools, security classification may prevent the agent from following adversarial instructions in tool results, and confirmation gating may prevent unintended execution of irreversible actions. By applying complementary safety mechanisms at distinct lifecycle stages, the computing system 101 may achieve defense-in-depth protection. The layered safety architecture may be combined with the tool trust annotation system described herein, such that the trust annotation determines which tools are subject to post-execution security classification, all external tools are subject to pre-invocation schema-gated authorization, and tools with destructive capability annotations are subject to pre-action confirmation gating.

In some embodiments, after tool execution within an agent step, the computing system 101 may perform a coordinated post-execution sequence comprising: (a) creating a token checkpoint reflecting current token consumption including the tool results, as described herein; and (b) persisting the updated session state including the new token checkpoint and any session-state modifications resulting from tool execution. By performing these operations as a coordinated sequence after tool execution and before the next inference request, the computing system 101 may maintain accurate resource tracking across multi-step agent execution.

In some embodiments, the computing system 101 may perform coordinated state maintenance during context compression, as described herein. After applying a context compression operation, the computing system 101 may additionally: (a) clear described-tool authorization records, because the tool descriptions that supported those records may no longer be present in the compressed context; (b) create a new token checkpoint reflecting the post-compression token count; and (c) persist the updated session state. This coordinated maintenance may ensure that session state remains consistent with the active conversation context after compression, reducing stale-state-induced errors such as invoking a tool whose schema is no longer in context.

In some embodiments, the computing system 101 may implement credit-aware cascading lifecycle control that applies differentiated responses to credit exhaustion across different task types and lifecycle contexts. The differentiated responses may include:
(a) for interactive tasks: atomically parking the task in a credits-blocked set and removing it from the active execution queue, as described elsewhere in the present disclosure, with automatic reinsertion into the active queue upon credit restoration;
(b) for scheduled cron-triggered tasks: skipping the current scheduled execution while preserving the schedule by scheduling the next run according to the cron expression, as described elsewhere in the present disclosure;
(c) for actively running sub-agent tasks: propagating a credit exhaustion signal that causes the sub-agent to terminate gracefully and report a credit exhaustion status to the parent session; and
(d) for parent sessions with multiple active sub-agents: cascading cancellation of all running sub-agent tasks upon credit exhaustion of the parent, followed by parking the parent task.

In some embodiments, the credit-aware cascading lifecycle control may preserve the user's scheduled automations across transient credit insufficiency periods while immediately halting resource-consuming interactive work, thereby balancing resource conservation with schedule continuity.

In some embodiments, credit-aware cascading lifecycle control may be implemented using an explicit lifecycle-state transition model for each task record. The lifecycle-state transition model may include one or more states selected from: active, credits-blocked, scheduled-skip, cancelled, completed, and awaiting-credit-restoration. In response to a credit exhaustion event, the computing system 101 may atomically transition an interactive task from active to credits-blocked and may persist a transition record including at least a task identifier, a prior state, a new state, a transition reason code, and a transition timestamp. In some examples, the transition reason code may comprise a normalized enumeration that distinguishes user-level credit exhaustion, organization-level credit exhaustion, and policy-level budget exhaustion.

In some embodiments, the computing system 101 may apply an event-driven unparking operation when credit restoration is detected. The event-driven unparking operation may atomically transition tasks from credits-blocked to active and may reinsert corresponding task identifiers into workload-appropriate queues with a score value at or before current time to make the tasks immediately eligible for claiming. In some examples, the unparking operation may preserve task-order fairness by reusing a stored priority field and may include idempotency checks that prevent duplicate reinsertions under repeated credit-restoration events.

In some embodiments, the computing system 101 may execute a unified session initialization pipeline when processing a new task or resuming an existing session. The session initialization pipeline may perform operations including: (a) recovering pending operations from a prior interrupted execution, as described herein; (b) repairing interrupted tool calls by injecting synthetic tool result blocks; (c) injecting results for sub-agent tasks cancelled during interruption; (d) resolving skill commands in the user query; and (e) building initial hook-based context reminders, as described herein. One or more of these operations may be performed concurrently (e.g., pending operation recovery concurrent with skill command resolution), and the pipeline may be fault-tolerant such that failure of an individual operation does not fail the entire initialization.

In some embodiments, the unified session initialization pipeline may commit results using a staged initialization checkpoint record that includes stage-status fields indicating completion, failure, or skip outcomes for each stage. The checkpoint record may be persisted after each stage commit to support deterministic re-entry after interruption, enabling the computing system 101 to resume by executing only stages not marked complete.

In some embodiments, the computing system 101 may maintain a taxonomy of terminal tools that cause the agent execution loop to exit with specific semantics. The terminal tools may include one or more of:
(a) a sleep tool that causes the agent to pause execution and schedule a future wake-up time;
(b) a submit result tool that provides a structured final result and terminates execution;
(c) a user question tool that poses questions to the user and suspends execution until answers are received;
(d) a confirm action tool that requests user approval for a specific action and suspends execution until confirmation is received; and
(e) a wake-parent tool that terminates execution and escalates to a parent session.

In some embodiments, the availability of terminal tools may be gated by session type. For example, the wake-parent tool may be available only to background scheduled sub-agent sessions and may be disabled for interactive main-agent sessions. As another example, the confirm action tool may be available to interactive sessions but not to background sessions that have no active user monitoring. In some examples, each terminal tool definition may include an allowed-session-types set and a disabled-for-main-agent indicator, and the computing system 101 may filter the tool set provided to the language model based on the current session type.

In some embodiments, the agent execution loop may detect terminal tool invocations without executing the tool implementation, because the terminal semantics are determined by the tool identity rather than the tool's computational result. For example, the computing system 101 may inspect tool invocations returned by the language model, identify any tool whose name matches a terminal tool name, extract the tool's input parameters (e.g., wake-up time, escalation message, confirmation question), and return a loop result with an exit reason corresponding to the terminal tool type, without invoking the tool's execution logic.

In some embodiments, the terminal tool taxonomy may be backed by a terminal semantic registry that stores per-terminal-tool metadata comprising at least: terminal type identifier, permitted session types, required parameter schema, exit reason code, and resumption precondition data. The computing system 101 may validate terminal-tool invocation payloads against the required parameter schema prior to producing the loop exit result. In some examples, if validation fails, the computing system 101 may reject the terminal invocation and continue the execution loop with a structured validation error appended to context.

In some embodiments, the described-tool authorization records maintained in session state may have a defined lifecycle that is coordinated with other session lifecycle events. The lifecycle may include:
(a) creation: a described-tool authorization record is created when the schema-description operation successfully retrieves the input schema for an external tool, as described elsewhere in the present disclosure;
(b) validation: prior to external tool execution, the computing system 101 checks for a matching described-tool authorization record, as described elsewhere in the present disclosure;
(c) invalidation: after a context compression operation, the computing system 101 clears all described-tool authorization records, because the tool descriptions that supported those records may no longer be present in the compressed conversation context; and
(d) re-creation: the agent may re-invoke the schema-description operation to retrieve tool schemas and re-create described-tool authorization records as needed for subsequent tool invocations.

In some embodiments, the invalidation-and-re-creation pattern may ensure that the agent operates with tool schemas that are represented in the active conversation context, reducing the risk of schema drift between the agent's cached understanding of a tool's interface and the tool's actual interface. By tying described-tool authorization record validity to context compression events, the computing system 101 may enforce a conservative safety policy in which the agent has recently observed a tool's schema in context before invoking that tool.

In some embodiments, cross-system integration behaviors described in this section may be implemented as a coordinated process comprising: receiving an agent-step trigger associated with a session identifier and loading session state comprising at least a token checkpoint and described-tool authorization records; executing a pre-inference pipeline in ordered stages comprising follow-up draining, token-level context management, and payload-level resource management; dispatching primary inference and tool-output security classification as concurrent asynchronous operations and recording per-operation start and completion timestamps; determining whether classification completed no later than primary inference and, in response to a negative determination, storing a latency-differential metric for observability; in response to a positive adversarial-content classification and tool-invocation-bearing primary inference output, injecting warning annotations into untrusted tool-result blocks and re-invoking primary inference with modified context; after completion of tool execution, performing a post-tool coordination chain comprising token checkpoint update and persistence of modified session state; applying session-type-gated terminal-tool detection and, when a terminal tool is invoked, emitting a terminal exit result with a validated exit reason code and resumption precondition data; detecting credit state for the session and applying credit-aware lifecycle transitions including atomic parking when credits are insufficient and atomic unparking upon credit restoration; persisting an integrated step commit record that includes at least: a pre-inference stage status vector, concurrency timing metrics, safety-event indicators, terminal outcome metadata, and lifecycle transition metadata; and emitting observability telemetry derived from the integrated step commit record for monitoring of latency differentials, safety outcomes, and queue state transitions.

In some embodiments, one or more of the foregoing operations may be omitted, reordered, parallelized, or repeated while preserving one or more technical effects described for this section.

In some embodiments, the integrated operation of the systems described in the preceding supplemental sections may produce compound technical effects that exceed the sum of individual system effects. For example, the ordered pre-inference processing pipeline may reduce the aggregate inference failure rate by addressing multiple failure modes in a single coordinated pass. The concurrent security classification may achieve classification throughput that approaches primary inference throughput, with incremental latency bounded by the latency differential. The layered safety architecture may reduce the total safety violation rate below what any individual mechanism achieves alone. The context compression with session state coherence may reduce stale-state-induced errors such as tool invocation failures attributable to schema mismatch after compression events. The credit-aware cascading lifecycle control may improve resource efficiency during credit insufficiency periods.

In some embodiments, one or more of the integrated system behaviors described in the supplemental sections above may be implemented independently of the others or in any combination. One or more of the integrated system behaviors may be applied to parent sessions, child sessions, sub-agent sessions, and/or background scheduled sessions.

### IV. CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

What is claimed is:

1. A computer-implemented method comprising:
providing, by one or more processors, access to a multi-session agent workspace, wherein:
(i) the multi-session agent workspace comprises a shared workspace repository and a plurality of agent sessions configured in accordance with a hierarchical session structure, the plurality of agent sessions comprising:
(a) a parent session storing parent context data for executing an agent task within the parent session, and
(b) a child session storing child context data separate from the parent session and for executing an agent subtask within the child session,
(ii) at least a portion of the parent context data of the parent session is propagated to the child session upon creation of the child session,
(iii) the agent task is executed within the parent session based on at least a portion of at least one of the parent context data or the shared workspace repository, and
(iv) the agent subtask is executed within the child session based on at least a portion of at least one of the child context data, the parent context data, or the shared workspace repository.

2. The computer-implemented method of claim 1, wherein:
(i) the hierarchical session structure comprises a unidirectional acyclic graph that defines a set of session nodes and a set of directed edges,
(ii) a first session node of the set of session nodes corresponds to the parent session,
(iii) a second session node of the set of session nodes corresponds to the child session, and
(iv) the first session node is connected to the second session node by a directed edge of the set of directed edges to establish a parent-child relationship between the parent session and the child session.

3. The computer-implemented method of claim 2, wherein the second session node comprises one or more of (i) a first session identifier corresponding to the parent session, (ii) a second session identifier corresponding to the child session, (iii) a third session identifier corresponding to a descendant session associated with the child session, (iv) a session state log, (v) a session metadata log, (vi) a task log, (vii) a creation timestamp, or (viii) an activity timestamp.

4. The computer-implemented method of claim 2, wherein the hierarchical session structure defines a parent limit for the second session node that constrains a number of one or more parent session nodes connected to the second session node.

5. The computer-implemented method of claim 4, wherein the parent limit is one.

6. The computer-implemented method of claim 1, wherein the parent session corresponds to a first session identifier, the child session corresponds to a second session identifier, and at least a segment of the second session identifier comprises the first session identifier to represent a parent-child relationship between the parent session and the child session.

7. The computer-implemented method of claim 1, further comprising generating the child session by:
receiving a session instantiation request within the parent session that defines a subtask-specific context for the child session;
generating a session container based on the session instantiation request; and
propagating, based on the subtask-specific context, at least a portion of a session metadata log associated with the parent session to the session container to generate the child session.

8. The computer-implemented method of claim 7, wherein the session instantiation request defines at least one execution mode, of a plurality of execution modes, for the child session, wherein the plurality of execution modes comprise:
(i) a synchronous delegation execution mode configured to interrupt the parent session until a response is received from the child session, or
(ii) an asynchronous background mode configured to independently execute the child session with respect to the parent session.

9. The computer-implemented method of claim 7, wherein the session instantiation request comprises a tool restriction configuration that defines a subset of a set of tools within the multi-session agent workspace that is accessible by the child session.

10. The computer-implemented method of claim 1, wherein executing the agent subtask within the child session comprises:
detecting a context exception for a generative model associated with the child session based on (i) a token count of at least one of the child context data, the parent context data, or the shared workspace repository and (ii) an exception threshold associated with a context window of the generative model, and
in response to detecting the context exception, generating, using a two-stage compression routine, a compressed representation of at least one of the child context data, the parent context data, or the shared workspace repository.

11. The computer-implemented method of claim 10, wherein the two-stage compression routine comprises:
(i) at a first stage of the two-stage compression routine,
(a) receiving a large artifact within at least one of the child context data, the parent context data, or the shared workspace repository,
(b) storing the large artifact at a first memory location within a data repository, and
(c) replacing the large artifact within at least one of the child context data, the parent context data, or the shared workspace repository with a location identifier corresponding to the first memory location and an artifact summary of the large artifact; and
(ii) at a second stage of the two-stage compression routine,
(a) receiving a session state log from at least one of the child context data, the parent context data, or the shared workspace repository,
(b) storing the session state log at a second memory location within the data repository,
(c) extracting, based on a text-based extraction ruleset, a set of preserved content tokens within the session state log,
(d) generating, using the generative model, a state summary of the session state log based on the session state log and the set of preserved content tokens, and
(e) replacing the session state log with the state summary.

12. The computer-implemented method of claim 1, wherein each of the plurality of agent sessions comprises one of a plurality of different isolated execution environments to isolate a fault within a first isolated execution environment of the plurality of different isolated execution environments without impacting a second isolated execution environment of the plurality of different isolated execution environments.

13. The computer-implemented method of claim 12, wherein the parent session instantiates the child session based on a fault propensity associated with the agent subtask to improve a fault tolerance of the multi-session agent workspace.

14. The computer-implemented method of claim 1, wherein the parent session instantiates the child session to distribute a computational load of the agent task between the parent session and the child session.

15. The computer-implemented method of claim 14, wherein the parent session is associated with a first processing capacity and the child session is associated with a second processing capacity, and the parent session instantiates the child session based on an optimized processing schedule configured to distribute the computational load of the agent task based on the first processing capacity and the second processing capacity.

16. The computer-implemented method of claim 1, wherein the parent session and the child session execute in parallel to increase a resolution speed of the agent task.

17. A system comprising:
one or more processors; and
one or more memories storing processor-executable instructions that, when executed by the one or more processors, cause the one or more processors to perform operations comprising:
providing access to a multi-session agent workspace, wherein:
(i) the multi-session agent workspace comprises a shared workspace repository and a plurality of agent sessions configured in accordance with a hierarchical session structure, the plurality of agent sessions comprising:
(a) a parent session storing parent context data for executing an agent task within the parent session, and
(b) a child session storing child context data separate from the parent session and for executing an agent subtask within the child session,
(ii) at least a portion of the parent context data of the parent session is propagated to the child session upon creation of the child session,
(iii) the agent task is executed within the parent session based on at least a portion of at least one of the parent context data or the shared workspace repository, and
(iv) the agent subtask is executed within the child session based on at least a portion of at least one of the child context data, the parent context data, or the shared workspace repository.

18. The system of claim 17, wherein each of the plurality of agent sessions comprises one of a plurality of different isolated execution environments to isolate a fault within a first isolated execution environment of the plurality of different isolated execution environments without impacting a second isolated execution environment of the plurality of different isolated execution environments.

19. The system of claim 18, wherein the parent session instantiates the child session based on a fault propensity associated with the agent subtask to improve a fault tolerance of the multi-session agent workspace.

20. One or more non-transitory computer-readable media storing processor-executable instructions that, when executed by one or more processors, cause the one or more processors to perform operations comprising:
providing access to a multi-session agent workspace, wherein:
(i) the multi-session agent workspace comprises a shared workspace repository and a plurality of agent sessions configured in accordance with a hierarchical session structure, the plurality of agent sessions comprising:
(a) a parent session storing parent context data for executing an agent task within the parent session, and
(b) a child session storing child context data separate from the parent session and for executing an agent subtask within the child session,
(ii) at least a portion of the parent context data of the parent session is propagated to the child session upon creation of the child session,
(iii) the agent task is executed within the parent session based on at least a portion of at least one of the parent context data or the shared workspace repository, and
(iv) the agent subtask is executed within the child session based on at least a portion of at least one of the child context data, the parent context data, or the shared workspace repository.
